(19) United States
(12) Patent Application Publication
(10) Pub. No.: US 2024/0294780 A1
(43) Pub. Date: Sep. 5, 2024

(54) ELECTRODEPOSITABLE COATING COMPOSITIONS

(71) Applicant: PPG Industries Ohio, Inc., Cleveland, OH (US)

(72) Inventors: Brian Carl Okerberg, Gibsonia, PA (US); David Alfred Stone, Allison Park, PA (US); Christopher Joseph Baldy, Murrysville, PA (US); Ross Anthony Moretti, Pittsburgh, PA (US); Derek James Saxon, Appleton, WI (US); Hyun Wook Ro, Gibsonia, PA (US); Reza Michael Rock, Pittsburgh, PA (US); Christophe R.G. Grenier, Pittsburgh, PA (US); Marissa Elizabeth Johnson, Valencia, PA (US); Carolyn A.K. Novak, Gibsonia, PA (US)

(73) Assignee: PPG Industries Ohio, Inc., Cleveland, OH (US)

(21) Appl. No.: 18/571,405

(22) PCT Filed: Jul. 1, 2022
(86) PCT No.: PCT/US2022/073356

§ 371 Date: Dec. 18, 2023

Related U.S. Application Data
(60) Provisional application No. 63/253,344, filed on Oct. 7, 2021.
(60) Provisional application No. 63/217,547, filed on Jul. 1, 2021.
(60) Provisional application No. 63/217,517, filed on Jul. 1, 2021.

(51) Int. Cl. C09D 5/44

(52) U.S. Cl. CPC C09D 5/4453

(57) ABSTRACT

The present disclosure is directed to an electrodepositable coating composition comprising (a) an active hydrogen-containing, ionic salt group-containing film-forming polymer: (b) an at least partially blocked polyisocyanate curing agent: (c) a curing catalyst; and (d) an edge control additive: wherein the electrodepositable coating composition has a gel point of less than 150° C. as measured by the GEL POINT TEST METHOD, an edge coverage of greater than 20%, as measured by the EDGE COVERAGE TEST METHOD, and an Ra of no more than 0.45, as measured by the SURFACE ROUGHNESS TEST METHOD. Also disclosed are methods of coating substrates, coatings, and coated substrates.

### CROSS-REFERENCE TO RELATED APPLICATIONS

This application claims the benefit of U.S. Provisional Patent Application Ser. No. 63/217,547, filed on Jul. 1, 2021, U.S. Provisional Patent Application Ser. No. 63/217,517, filed on Jul. 1, 2021, and U.S. Provisional Patent Application Ser. No. 63/253,344, filed on Oct. 7, 2021, each of which are incorporated herein by reference.

### FIELD

The present disclosure is directed towards an electrodepositable coating composition, coated substrates, and methods of coating substrates.

### BACKGROUND

Electrodeposition as a coating application method involves the deposition of a film-forming composition onto a conductive substrate under the influence of an applied electrical potential. Electrodeposition has gained popularity in the coatings industry because it provides higher paint utilization, outstanding corrosion resistance, and low environmental contamination as compared with non-electrophoretic coating methods. Both cationic and anionic electrodeposition processes are used commercially.

### SUMMARY

The present disclosure provides an electrodepositable coating composition comprising (a) an active hydrogen-containing, ionic salt group-containing film-forming polymer; (b) a blocked polyisocyanate curing agent; (c) a curing catalyst; and (d) an edge control additive; wherein the electrodepositable coating composition has a gel point of less than 150° C., or less than 145° C., or less than 140° C., or less than 135° C., or less than 130° C., or less than 125° C., as measured by the GEL POINT TEST METHOD, an edge coverage of greater than 20%, as measured by the EDGE COVERAGE TEST METHOD, and an Ra of no more than 0.45, as measured by the SURFACE ROUGHNESS TEST METHOD.

The present disclosure also provides an electrodepositable coating composition comprising (a) an active hydrogen-containing, ionic salt group-containing film-forming polymer comprising a reaction product of a reaction mixture comprising (1) a polyepoxide; (2) di-functional chain extender; and (3) a mono-functional reactant; (b) a blocked polyisocyanate curing agent; (c) a curing catalyst; and (d) an edge control additive; wherein the electrodepositable coating composition has a gel point of less than 150° C., or less than 145° C., or less than 140° C., or less than 135° C., or less than 130° C., or less than 125° C., as measured by the GEL POINT TEST METHOD, and a coalescence temperature of less than 90° F., as measured by the COALESCENCE TEMPERATURE TEST METHOD.

The present disclosure further provides a method of coating a substrate comprising electrophoretically applying a coating deposited from an electrodepositable coating composition of the present disclosure to at least a portion of the substrate.

The present disclosure is also directed to an at least partially cured coating formed by at least partially curing a coating deposited from an electrodepositable coating composition of the present disclosure.

The present disclosure is further directed to a coated substrate comprising a coating formed by electrodepositing the electrodepositable coating composition of the present disclosure onto the substrate and at least partially curing the coating.

### DETAILED DESCRIPTION

The present disclosure is directed to an electrodepositable coating composition comprising (a) an active hydrogen-containing, ionic salt group-containing film-forming polymer; (b) an at least partially blocked polyisocyanate curing agent; (c) a curing catalyst; and (d) an edge control additive; wherein the electrodepositable coating composition has a gel point of less than 150° C., as measured by the GEL POINT TEST METHOD, an edge coverage of greater than 20%, as measured by the EDGE COVERAGE TEST METHOD, and an Ra of no more than 0.45, as measured by the SURFACE ROUGHNESS TEST METHOD.

The present disclosure is directed to an electrodepositable coating composition comprising (a) an active hydrogen-containing, ionic salt group-containing film-forming polymer comprising a reaction product of a reaction mixture comprising (1) a polyepoxide; (2) di-functional chain extender; and (3) a mono-functional reactant; (b) blocked polyisocyanate curing agent; (c) a curing catalyst; and (d) an edge control additive; wherein the electrodepositable coating composition has a gel point of less than 150° C., or less than 145° C., or less than 140° C., or less than 135° C., or less than 130° C., or less than 125° C., as measured by the GEL POINT TEST METHOD, and a coalescence temperature of less than 90° F., as measured by the COALESCENCE TEMPERATURE TEST METHOD.

The term “electrodepositable coating composition” refers to a composition that is capable of being deposited onto an electrically conductive substrate under the influence of an applied electrical potential.

The electrodepositable coating composition has a gel point of less than 150° C., as measured by the GEL POINT TEST METHOD. The electrodepositable coating composition may have a gel point of less than 145° C., such as less than 140° C., such as less than 135° C., such as less than 130° C., such as less than 125° C., as measured by the GEL POINT TEST METHOD.

As used herein, the “GEL POINT TEST METHOD” refers to a test method wherein the subject electrodepositable coating composition is coated onto a test panel until reaching a target film of 0.7-0.9 mils (17-23 microns). The applied, uncured coating is then dissolved in THF and deposited on to a platen and placed into a rheometer at a constant shear strain and frequency, ramping the temperature from 40° C. to 175° C. at a ramp of 3.3° C./minute, measuring the complex viscosity (cps, n*), shear strain (%, y), loss factor (G″/G′), loss modulus (Pa, G″), storage modulus (Pa, G′), and shear stress (Pa, t) over the temperature ramp, and determining the gel point as the point at which loss modulus (G″) crosses the storage modulus (G′). A specific method for the GEL POINT TEST METHOD is as follows: The electrodepositable coating composition is coated onto 4″×12″ 0.025″ panel; the applied, uncured coating is then dissolved in THF and deposited on to a type P-PTD200/56 platen and placed into an Anton Paar rheometer (a 302 model) using an Anton Paar PPR 25/23 spindle and settings of constant 5% shear strain and constant 1 Hz frequency. The temperature is held at 40° C. for 30 min then ramped from 40° C. to 175° C. at a rate of 3.3° C./min. The complex viscosity (cps, n*), shear strain (%, y), loss factor (G″/G′), loss modulus (Pa, G″), storage modulus (Pa, G′), and shear stress (Pa, t) are measured over the temperature ramp, and the gel point is determined to be the point at which loss modulus (G″) crosses the storage modulus (G′).

The electrodepositable coating composition has an edge coverage of greater than 20%, as measured by the EDGE COVERAGE TEST METHOD. The electrodepositable coating composition may have an edge coverage of greater than 25%, such as greater than 30%, such as greater than 35%, such as greater than 40%, such as greater than 45%, such as greater than 50%, such as greater than 55%, such as greater than 60%, such as greater than 65%, such as greater than 70%, such as greater than 75%, as measured by the EDGE COVERAGE TEST METHOD.

As used herein, the “EDGE COVERAGE TEST METHOD” is performed as follows: Test panels are specially prepared from cold rolled steel panels, 4×12×0.032 inches, pretreated with CHEMFOS C700/DI and available from ACT Laboratories of Hillside, Michigan. The 4×12×0.31-inch panels are first cut into two 4×5¾-inch panels using a Di-Acro Hand Shear No. 24 (DiAcro, Oak Park Heights, Minnesota). The panels are positioned in the cutter so that the burr edge from the cut along the 4-inch edge ends up on the opposite side from the top surface of the panel. Each 4×5¾ panel is then positioned in the cutter to remove ¼ of an inch from one of the 5¾-inch sides of the panel in such a manner that the burr resulting from the cut faces upward from the top surface of the panel. The electrodepositable coating composition is then electrodeposited onto these specially prepared panels. The coated panels are cured such as by baking at 150° C. for 20 minutes in an electric oven (Despatch Industries, model LFD-series). Each of the panels has a dry film thickness between 0.7 to 0.9 mils (17 to 23 microns) after baking at 150° C. for 20 minutes.

A Di-Acro panel cutter (model number 12 SHEAR) may be used to cut out square pieces, approximately 0.5 in×0.5 in, from the burr edge of the panel. The panel pieces are then secured inside Leco mold cups using Ted Pella plastic multi clips. Leco Epoxy (811-563-101) and Leco Hardener (812-518) are mixed together using a 100:14 ratio and poured into the mold cups, which are allowed to cure overnight at room temperature. The epoxy mounts are then grinded and polished with Leco grit paper using the Leco Spectrum System 1000 grinder/polisher by the following process: 240 grit (twice for a minute each), 320 grit (once or twice for a minute each), 600 grit (twice for 30 s each), 1200 grit (twice for 30 s each). Samples are then either polished for 2 minutes each using a 1-micron diamond paste or with 1200 grit paper. The grinding/polishing process may vary slightly depending on how the surface of the epoxy mount looks. Once polished, the samples were coated for 20 seconds with Au/Pd in an EMS150T ES sputter coater and placed on aluminum mounts with carbon tape. The samples were then imaged in the FEI Quanta FEG 250 SEM at 10 kV. Measurements of film build on the burr are captured. Three measurements are made from tip of the burr and averaged. Three film build measurement are captured on the flat (non-burr) portion of the sample and averaged. The ratio of film build on the burr and flat portion of the sample are calculated to determine the edge coverage percentage.

The electrodepositable coating composition has an Ra of no more than 0.45, as measured by the SURFACE ROUGHNESS TEST METHOD. The electrodepositable coating composition may have an Ra of no more than 0.40, such as no more than 0.35, such as no more than 0.31, such as no more than 0.25, such as no more than 0.20, such as no more than 0.15, as measured by the SURFACE ROUGHNESS TEST METHOD.

As used herein, the “SURFACE ROUGHNESS TEST METHOD” refers to a test method wherein the electrodepositable coating composition is electrodeposited onto a metal panel and cured, and then coating texture is evaluated using a profilometer over a specified length of the panel, filtering the roughness profile according to ISO 4287-1997 3.1.6 using an Lc parameter of 2.5 mm and an Ls parameter of 8 μm before summarizing an Ra metric according to ISO 4287-1997 4.2.1, hereinafter referred to as Ra. A specific test procedure may be performed as follows: The electrodepositable coating composition may be electrodeposited onto a metal panel having a size of 4×6×0.032 inches and the coating may be cured by baking in an electric oven. The coating texture may be evaluated using a Mitutoyo Surftest SJ-402 skidless stylus profilometer equipped with a 4 mN detector and a diamond stylus tip with a 90° C. one and a 5 μm tip radius. The scan length, measuring speed, and data sampling interval may be 48 mm, 1 mm/s, and 5 μm, respectively. The raw data may be first filtered to a roughness profile according to ISO 4287-1997 3.1.6 using an Lc parameter of 2.5 mm and an Ls parameter of 8 μm before summarizing an Ra metric according to ISO 4287-1997 4.2.1.

As used herein, the “COALESCENCE TEMPERATURE TEST METHOD” refers to a test method wherein the electrodepositable coating composition is electrodeposited onto a test panels that are 4×6×0.031 inches at electrodeposition bath temperatures of 70-102° F. at 3° F. bath temperature intervals (up to 102° F.) using a voltage of 190 V and a 3-minute deposition time. The film build is measured using a Fischer Dualscope FMP40 permascope instrument. If a film build minimum is identified in the tested temperature range, the temperature where the lowest film build is measured is referred to as the coalescence temperature.

The electrodepositable coating composition may have a % smoothing of at least 30%, as measured by the SMOOTHING TEST METHOD, such as at least 35%, such as at least 40%, such as at least 45%, such as at least 50%, such as at least 55%, such as at least 60%, such as at least 65%, such as at least 70%, such as at least 75%, such as at least 80%. As used herein, the “% smoothing” refers to the decrease in the panel surface roughness after the electrodepositable coating composition is applied to the substrate surface and baked. For example, a substrate having an Ra of 0.6 prior to electrocoating and an Ra of 0.3 after the electrodepositable coating composition has been applied would mean the electrodepositable coating composition has a % smoothing of 50%. Likewise, a substrate having an Ra of 0.6 prior to electrocoating and an Ra of 0.15 after the electrodepositable coating composition has been applied would mean the electrodepositable coating composition has a % smoothing of 75%.

As used herein, the “SMOOTHING TEST METHOD” refers to a test method wherein a panel texture is evaluated before and after electrocoating. The panel roughness is first evaluated using a profilometer at a specified scan length, measuring speed, and data sampling interval, respectively. The raw sampling data is first filtered to a roughness profile according to ISO 4287-1997 3.1.6 using an Lc parameter of 2.5 mm and an Ls parameter of 8 μm before summarizing an Ra metric according to ISO 4287-1997 4.2.1, hereinafter referred to as Ra. The panel is then electrocoated using the electrodepositable coating composition. The coated substrate is then evaluated in the same manner as the uncoated substrate. The % smoothing is then calculated as 1-(Ra of the coated panel/Ra of the panel before)×100.

### Active Hydrogen-Containing, Ionic Salt Group-Containing Film-Forming Polymer

The electrodepositable coating composition further comprises an active hydrogen-containing, ionic salt group-containing film-forming polymer. The ionic salt group-containing film-forming polymer may comprise a cationic salt group containing film-forming polymer or an anionic salt group containing film-forming polymer.

The ionic salt group-containing film-forming polymer may optionally comprise a reaction product of a reaction mixture comprising (a) a polyepoxide; (b) di-functional chain extender; and (c) a mono-functional reactant.

The polyepoxide may comprise any suitable polyepoxide. For example, the polyepoxide may comprise a di-epoxide. Non-limiting examples of suitable polyepoxide include diglycidyl ethers of bisphenols, such as a diglycidyl ether of bisphenol A or bisphenol F.

The di-functional chain extender may comprise any suitable di-functional chain extender. For example, the di-functional chain extender may comprise a di-hydroxyl functional reactant, a di-carboxylic acid functional reactant, or a primary amine functional reactant. The di-hydroxyl functional reactant may comprise, for example, a bisphenol such as bisphenol A and/or bisphenol F. The di-carboxylic acid functional reactant may comprise, for example, a dimer fatty acid.

The mono-functional reactant may comprise a monophenol, a mono-functional acid, dimethylethanolamine, a monoepoxide such as the glycidyl ether of phenol, the glycidyl ether of nonylphenol, or the glycidyl ether of cresol, or any combination thereof.

The monophenol may comprise any suitable monophenol. For example, the monophenol may comprise phenol, 2-hydroxytoluene, 3-hydroxytoluene, 4-hydroxytoluene, 2-tert-butylphenol, 4-tert-butylphenol, 2-tert-butyl-4-methylphenol, 2-methoxyphenol, 4-methoxyphenol, 2-hydroxybenzyl alcohol, 4-hydroxybenzyl alcohol, nonylphenol, dodecylphenol, 1-hydroxynaphthalene, 2-hydroxynaphthalene, biphenyl-2-ol, biphenyl-4-ol and 2-allylphenol.

The mono-functional acid may comprise any compound or mixture of compounds having one carboxyl group per molecule. In addition to the carboxyl group, the mono-functional acid may comprise other functional groups that are not chemically reactive with epoxide, hydroxyl or carboxyl functional groups, and, therefore, do not interfere with the polymerization reaction. The mono-functional acid may comprise aromatic mono-acids such as benzoic acid or phenylalkanoic acids such as phenylacetic acid, 3-phenylpropanoic acid, and the like, and aliphatic mono-acids, as well as combinations thereof.

The ratio of functional groups from the di-functional chain extender and mono-functional reactant to the epoxide functional groups from the polyepoxide may be at least 0.50:1, such as at least 0.60:1, such as at least 0.65:1, such as at least 0.70:1. The ratio of functional groups from the di-functional chain extender and mono-functional reactant to the epoxide functional groups from the polyepoxide may be no more than 0.85:1, such as no more than such as no more than 0.80:1, such as no more than 0.75:1, such as no more than 0.70:1. The ratio of functional groups from the di-functional chain extender and mono-functional reactant to the epoxide functional groups from the polyepoxide may be 0.50:1 to 0.85:1, such as 0.50:1 to 0.80:1, such as 0.50:1 to 0.75:1, such as 0.50:1 to 0.70:1, such as 0.60:1 to 0.85:1, such as 0.60:1 to 0.80:1, such as 0.60:1 to 0.75:1, such as 0.60:1 to 0.70:1, such as 0.65:1 to 0.85:1, such as 0.65:1 to 0.80:1, such as 0.65:1 to 0.75:1, such as 0.65:1 to 0.70:1, such as 0.70:1 to 0.85:1, such as 0.70:1 to 0.80:1, such as 0.70:1 to 0.75:1.

The di-functional chain extender may comprise a di-hydroxyl functional reactant such as a bisphenol. The ratio of total phenolic hydroxyl groups from the bisphenol di-functional chain extender and functional groups from the mono-functional reactant to epoxide functional groups from the polyepoxide may be at least 0.50:1, such as at least 0.60:1, such as at least 0.65:1, such as at least 0.70:1. The ratio of total phenolic hydroxyl groups from the bisphenol di-functional chain extender and functional groups from the mono-functional reactant to epoxide functional groups from the polyepoxide may be no more than 0.85:1, such as no more than such as no more than 0.80:1, such as no more than 0.75:1, such as no more than 0.70:1. The ratio of total phenolic hydroxyl groups from the bisphenol di-functional chain extender and functional groups from the mono-functional reactant to epoxide functional groups from the polyepoxide may be 0.50:1 to 0.85:1, such as 0.50:1 to 0.80:1, such as 0.50:1 to 0.75:1, such as 0.50:1 to 0.70:1, such as 0.60:1 to 0.85:1, such as 0.60:1 to 0.80:1, such as 0.60:1 to 0.75:1, such as 0.60:1 to 0.70:1, such as 0.65:1 to 0.85:1, such as 0.65:1 to 0.80:1, such as 0.65:1 to 0.75:1, such as 0.65:1 to 0.70:1, such as 0.70:1 to 0.85:1, such as 0.70:1 to 0.80:1, such as 0.70:1 to 0.75:1.

The di-functional chain extender may comprise a di-hydroxyl functional reactant such as a bisphenol. The ratio of total phenolic hydroxyl groups from the bisphenol di-functional chain extender and acid groups from the mono-functional acid to epoxide functional groups from the polyepoxide may be at least 0.50:1, such as at least 0.60:1, such as at least 0.65:1, such as at least 0.70:1. The ratio of total phenolic hydroxyl groups from the bisphenol di-functional chain extender and acid groups from the mono-functional acid to epoxide functional groups from the polyepoxide may be no more than 0.85:1, such as no more than such as no more than 0.80:1, such as no more than 0.75:1, such as no more than 0.70:1. The ratio of total phenolic hydroxyl groups from the bisphenol di-functional chain extender and acid groups from the mono-functional acid to epoxide functional groups from the polyepoxide may be 0.50:1 to 0.85:1, such as 0.50:1 to 0.80:1, such as 0.50:1 to 0.75:1, such as 0.50:1 to 0.70:1, such as 0.60:1 to 0.85:1, such as 0.60:1 to 0.80:1, such as 0.60:1 to 0.75:1, such as 0.60:1 to 0.70:1, such as 0.65:1 to 0.85:1, such as 0.65:1 to 0.80:1, such as 0.65:1 to 0.75:1, such as 0.65:1 to 0.70:1, such as 0.70:1 to 0.85:1, such as 0.70:1 to 0.80:1, such as 0.70:1 to 0.75:1.

The di-functional chain extender may comprise a di-hydroxyl functional reactant such as a bisphenol. The ratio of total phenolic hydroxyl groups from the bisphenol di-functional chain extender and phenolic hydroxyl groups from the monophenol to epoxide functional groups from the polyepoxide may be at least 0.50:1, such as at least 0.60:1, such as at least 0.65:1, such as at least 0.70:1. The ratio of total phenolic hydroxyl groups from the bisphenol di-functional chain extender and phenolic hydroxyl groups from the monophenol to epoxide functional groups from the polyepoxide may be no more than 0.85:1, such as no more than such as no more than 0.80:1, such as no more than 0.75:1, such as no more than 0.70:1. The ratio of total phenolic hydroxyl groups from the bisphenol di-functional chain extender and phenolic hydroxyl groups from the monophenol to epoxide functional groups from the polyepoxide may be 0.50:1 to 0.85:1, such as 0.50:1 to 0.80:1, such as 0.50:1 to 0.75:1, such as 0.50:1 to 0.70:1, such as 0.60:1 to 0.85:1, such as 0.60:1 to 0.80:1, such as 0.60:1 to 0.75:1, such as 0.60:1 to 0.70:1, such as 0.65:1 to 0.85:1, such as 0.65:1 to 0.80:1, such as 0.65:1 to 0.75:1, such as 0.65:1 to 0.70:1, such as 0.70:1 to 0.85:1, such as 0.70:1 to 0.80:1, such as 0.70:1 to 0.75:1.

The di-functional chain extender may comprise a di-hydroxyl functional reactant such as a bisphenol. The ratio of phenolic hydroxyl functional groups from the bisphenol di-functional chain extender to phenolic hydroxyl functional groups from the monophenol and/or acid groups from the mono-functional acid may be at least 0.05:1, such as at least 0.1:1, such as at least 0.2:1, such as at least 0.3:1, such as at least 0.4:1, such as at least 0.5:1, such as at least 0.6:1, such as at least 0.7:1, such as at least 0.8:1. The ratio of phenolic hydroxyl functional groups from the bisphenol di-functional chain extender to phenolic hydroxyl functional groups from the monophenol may be no more than 9:1, such as no more than 4:1, such as no more than 2:1, such as no more than 1:1, such as no more than 0.8:1. The ratio of phenolic hydroxyl functional groups from the bisphenol di-functional chain extender to phenolic hydroxyl functional groups from the monophenol may be 0.05:1 to 9:1, such as 0.05:1 to 4:1, such as 0.05:1 to 2:1, such as 0.05:1 to 1:1, such as 0.05:1 to 0.8:1, such as 0.1:1 to 9:1, such as 0.1:1 to 4:1, such as 0.1:1 to 2:1, such as 0.1:1 to 1:1, such as 0.1:1 to 0.8:1, such as 0.2:1 to 9:1, such as 0.2:1 to 4:1, such as 0.2:1 to 2:1, such as 0.2:1 to 1:1, such as 0.2:1 to 0.8:1, such as 0.3:1 to 9:1, such as 0.3:1 to 4:1, such as 0.3:1 to 2:1, such as 0.3:1 to 1:1, such as 0.3:1 to 0.8:1, such as 0.4:1 to 9:1, such as 0.4:1 to 4:1, such as 0.4:1 to 2:1, such as 0.4:1 to 1:1, such as 0.4:1 to 0.8:1, such as 0.5:1 to 9:1, such as 0.5:1 to 4:1, such as 0.5:1 to 2:1, such as 0.5:1 to 1:1, such as 0.5:1 to 0.8:1, such as 0.6:1 to 9:1, such as 0.6:1 to 4:1, such as 0.6:1 to 2:1, such as 0.6:1 to 1:1, such as 0.6:1 to 0.8:1, such as 0.7:1 to 9:1, such as 0.7:1 to 4:1, such as 0.7:1 to 2:1, such as 0.7:1 to 1:1, such as 0.7:1 to 0.8:1, such as 0.8:1 to 9:1, such as 0.8:1 to 4:1, such as 0.8:1 to 2:1, such as 0.8:1 to 1:1.

The reaction product of a reaction mixture comprising (a) a polyepoxide; (b) di-functional chain extender; and (c) a mono-functional reactant may have an epoxy equivalent weight of at least 700 g/equivalent, such as at least 800 g/equivalent, such as at least 850 g/equivalent. The reaction product of a reaction mixture comprising (a) a polyepoxide; (b) di-functional chain extender; and (c) a mono-functional reactant may have an epoxy equivalent weight of no more than 1,500 g/equivalent, such as no more than 1,400 g/equivalent, such as no more than 1,200 g/equivalent, such as no more than 1,100 g/equivalent. The reaction product of a reaction mixture comprising (a) a polyepoxide; (b) di-functional chain extender; and (c) a mono-functional reactant may have an epoxy equivalent weight of 700 to 1,500 g/equivalent, such as 700 to 1,400 g/equivalent, such as 700 to 1,200 g/equivalent, such as 700 to 1,100 g/equivalent, such as 800 to 1,500 g/equivalent, such as 800 to 1,400 g/equivalent, such as 800 to 1,200 g/equivalent, such as 800 to 1,100 g/equivalent, such as 850 to 1,500 g/equivalent, such as 850 to 1,400 g/equivalent, such as 850 to 1,200 g/equivalent, such as 850 to 1,100 g/equivalent.

The reaction product of a reaction mixture comprising (a) a polyepoxide; (b) di-functional chain extender; and (c) a mono-functional reactant may have a z-average molecular weight (M_{z}) of at least 8,000 g/mol, such as at least 10,000 g/mol, such as at least 12,000 g/mol, such as at least 13,000 g/mol, such as at least 15,000 g/mol, such as at least 20,000 g/mol, as determined by Gel Permeation Chromatography using polystyrene calibration standards. The reaction product of a reaction mixture comprising (a) a polyepoxide; (b) di-functional chain extender; and (c) a mono-functional reactant may have a z-average molecular weight (M_{z}) of no more than 35,000 g/mol, such as no more than 25,000 g/mol, such as no more than 20,000 g/mol, such as no more than 15,000 g/mol, as determined by Gel Permeation Chromatography using polystyrene calibration standards. The reaction product of a reaction mixture comprising (a) a polyepoxide; (b) di-functional chain extender; and (c) a mono-functional reactant may have a z-average molecular weight (M_{z}) of 8,000 g/mol to 35,000 g/mol, such as 8,000 g/mol to 25,000 g/mol, such as 8,000 g/mol to 20,000 g/mol, such as 8,000 to 15,000 g/mol, such as 10,000 g/mol to 35,000 g/mol, such as 10,000 g/mol to 25,000 g/mol, such as 10,000 g/mol to 20,000 g/mol, such as 10,000 to 15,000 g/mol, such as 12,000 g/mol to 35,000 g/mol, such as 12,000 g/mol to 25,000 g/mol, such as 12,000 g/mol to 20,000 g/mol, such as 12,000 to 15,000 g/mol, such as 13,000 g/mol to 35,000 g/mol, such as 13,000 g/mol to 25,000 g/mol, such as 13,000 g/mol to 20,000 g/mol, such as 13,000 to 15,000 g/mol, such as 15,000 g/mol to 35,000 g/mol, such as 15,000 g/mol to 25,000 g/mol, such as 15,000 g/mol to 20,000 g/mol, such as 20,000 to 35,000 g/mol, such as 20,000 g/mol to 25,000 g/mol, as determined by Gel Permeation Chromatography using polystyrene calibration standards.

As used herein, unless otherwise stated, the terms “z-average molecular weight (M_{z})” means the z-average molecular weight (M_{z}) and the z-average molecular weight (M_{z}) as determined by Gel Permeation Chromatography using Waters 2695 separation module with a Waters 410 differential refractometer (RI detector), polystyrene standards having molecular weights of from approximately 500 g/mol to 900,000 g/mol, dimethylformamide (DMF) with 0.05 M lithium bromide (LiBr) as the eluent at a flow rate of 0.5 mL/min, and one Asahipak GF-510 HQ column for separation.

Cationic salt groups may be incorporated into the reaction product of a reaction mixture comprising (a) a polyepoxide; (b) di-functional chain extender; and (c) a mono-functional reactant as follows: The reaction product may be reacted with a cationic salt group former. By “cationic salt group former” is meant a material which is reactive with epoxy groups present and which may be acidified before, during, or after reaction with the epoxy groups on the reaction product to form cationic salt groups. Examples of suitable materials include amines such as primary or secondary amines which can be acidified after reaction with the epoxy groups to form amine salt groups, or tertiary amines which can be acidified prior to reaction with the epoxy groups and which after reaction with the epoxy groups form quaternary ammonium salt groups. Examples of other cationic salt group formers are sulfides which can be mixed with acid prior to reaction with the epoxy groups and form ternary sulfonium salt groups upon subsequent reaction with the epoxy groups.

Anionic salt groups may be incorporated into the reaction product of a reaction mixture comprising (a) a polyepoxide; (b) di-functional chain extender; and (c) a mono-functional reactant by reacting the reaction product with a polyprotic acid. Suitable polyprotic acids include, for example, an oxyacid of phosphorus, such as phosphoric acid and/or phosphonic acid.

The ionic salt group-containing film-forming polymer may comprise a cationic salt group containing film-forming polymer. The cationic salt group-containing film-forming polymer may be used in a cationic electrodepositable coating composition. As used herein, the term “cationic salt group-containing film-forming polymer” refers to polymers that include at least partially neutralized cationic groups, such as sulfonium groups and ammonium groups, that impart a positive charge. As used herein, the term “polymer” encompasses, but is not limited to, oligomers and both homopolymers and copolymers. The cationic salt group-containing film-forming polymer may comprise active hydrogen functional groups. As used herein, the term “active hydrogen functional groups” refers to those groups that are reactive with isocyanates as determined by the Zerewitinoff test as discussed above, and include, for example, hydroxyl groups, primary or secondary amine groups, and thiol groups. Cationic salt group-containing film-forming polymers that comprise active hydrogen functional groups may be referred to as active hydrogen-containing, cationic salt group-containing film-forming polymers.

Examples of polymers that are suitable for use as the cationic salt group-containing film-forming polymer in the present disclosure include, but are not limited to, alkyd polymers, acrylics, polyepoxides, polyamides, polyurethanes, polyureas, polyethers, and polyesters, among others.

More specific examples of suitable active hydrogen-containing, cationic salt group containing film-forming polymers include polyepoxide-amine adducts, such as the adduct of a polyglycidyl ethers of a polyphenol, such as Bisphenol A, and primary and/or secondary amines, such as are described in U.S. Pat. No. 4,031,050 at col. 3, line 27 to col. 5, line 50, U.S. Pat. No. 4,452,963 at col. 5, line 58 to col. 6, line 66, and U.S. Pat. No. 6,017,432 at col. 2, line 66 to col. 6, line 26, these portions of which being incorporated herein by reference. A portion of the amine that is reacted with the polyepoxide may be a ketimine of a polyamine, as is described in U.S. Pat. No. 4,104,147 at col. 6, line 23 to col. 7, line 23, the cited portion of which being incorporated herein by reference. Also suitable are ungelled polyepoxide-polyoxyalkylenepolyamine resins, such as are described in U.S. Pat. No. 4,432,850 at col. 2, line 60 to col. 5, line 58, the cited portion of which being incorporated herein by reference. In addition, cationic acrylic resins, such as those described in U.S. Pat. No. 3,455,806 at col. 2, line 18 to col. 3, line 61 and 3,928,157 at col. 2, line 29 to col. 3, line 21, these portions of both of which are incorporated herein by reference, may be used.

Besides amine salt group-containing resins, quaternary ammonium salt group-containing resins may also be employed as a cationic salt group-containing film-forming polymer in the present disclosure. Examples of these resins are those which are formed from reacting an organic polyepoxide with a tertiary amine acid salt. Such resins are described in U.S. Pat. No. 3,962,165 at col. 2, line 3 to col. 11, line 7; 3,975,346 at col. 1, line 62 to col. 17, line 25 and 4,001,156 at col. 1, line 37 to col. 16, line 7, these portions of which being incorporated herein by reference. Examples of other suitable cationic resins include ternary sulfonium salt group-containing resins, such as those described in U.S. Pat. No. 3,793,278 at col. 1, line 32 to col. 5, line 20, this portion of which being incorporated herein by reference. Also, cationic resins which cure via a transesterification mechanism, such as described in European Pat. Application No. 12463B1 at pg. 2, line 1 to pg. 6, line 25, this portion of which being incorporated herein by reference, may also be employed.

Other suitable cationic salt group-containing film-forming polymers include those that may form photodegradation resistant electrodepositable coating compositions. Such polymers include the polymers comprising cationic amine salt groups which are derived from pendant and/or terminal amino groups that are disclosed in U.S. Pat. Application Publication No. 2003/0054193 A1 at paragraphs to [0088], this portion of which being incorporated herein by reference. Also suitable are the active hydrogen-containing, cationic salt group-containing resins derived from a polyglycidyl ether of a polyhydric phenol that is essentially free of aliphatic carbon atoms to which are bonded more than one aromatic group, which are described in U.S. Pat. Application Publication No. 2003/0054193 A1 at paragraphs to [0123], this portion of which being incorporated herein by reference.

The active hydrogen-containing, cationic salt group-containing film-forming polymer is made cationic and water dispersible by at least partial neutralization with an acid. Suitable acids include organic and inorganic acids. Non-limiting examples of suitable organic acids include formic acid, acetic acid, methanesulfonic acid, and lactic acid. Non-limiting examples of suitable inorganic acids include phosphoric acid and sulfamic acid. By “sulfamic acid” is meant sulfamic acid itself or derivatives thereof such as those having the formula:

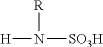

wherein R is hydrogen or an alkyl group having 1 to 4 carbon atoms. Mixtures of the above-mentioned acids also may be used in the present disclosure.

The extent of neutralization of the cationic salt group-containing film-forming polymer may vary with the particular polymer involved. However, sufficient acid should be used to sufficiently neutralize the cationic salt-group containing film-forming polymer such that the cationic salt-group containing film-forming polymer may be dispersed in an aqueous dispersing medium. For example, the amount of acid used may provide at least 20% of all of the total theoretical neutralization. Excess acid may also be used beyond the amount required for 100% total theoretical neutralization. For example, the amount of acid used to neutralize the cationic salt group-containing film-forming polymer may be ≥0.1% based on the total amines in the active hydrogen-containing, cationic salt group-containing film-forming polymer. Alternatively, the amount of acid used to neutralize the active hydrogen-containing, cationic salt group-containing film-forming polymer may be ≤100% based on the total amines in the active hydrogen-containing, cationic salt group-containing film-forming polymer. The total amount of acid used to neutralize the cationic salt group-containing film-forming polymer may range between any combination of values, which were recited in the preceding sentences, inclusive of the recited values. For example, the total amount of acid used to neutralize the active hydrogen-containing, cationic salt group-containing film-forming polymer may be 20%, 35%, 50%, 60%, or 80% based on the total amines in the cationic salt group-containing film-forming polymer.

The cationic salt group-containing film-forming polymer may be present in the cationic electrodepositable coating composition in an amount of at least 40% by weight, such as at least 50% by weight, such as at least 60% by weight, based on the total weight of the resin solids of the electrodepositable coating composition. The cationic salt group-containing film-forming polymer may be present in the cationic electrodepositable coating composition in an amount of no more than 90% by weight, such as no more than 80% by weight, such as no more than 75% by weight, based on the total weight of the resin solids of the electrodepositable coating composition. The cationic salt group-containing film-forming polymer may be present in the cationic electrodepositable coating composition in an amount of 40% to 90% by weight, such as 40% to 80% by weight, such as 40% to 75% by weight, such as 50% to 90% by weight, such as 50% to 80% by weight, such as 50% to 75% by weight, such as 60% to 90% by weight, such as 60% to 80% by weight, such as 60% to 75% by weight, based on the total weight of the resin solids of the electrodepositable coating composition.

As used herein, the “resin solids” include the ionic salt group-containing film-forming polymer, the curing agent, the addition polymer, and any additional water-dispersible non-pigmented component(s) present in the electrodepositable coating composition.

The ionic salt group containing film-forming polymer may comprise an anionic salt group containing film-forming polymer. As used herein, the term “anionic salt group containing film-forming polymer” refers to an anionic polymer comprising at least partially neutralized anionic functional groups, such as carboxylic acid and phosphoric acid groups that impart a negative charge. As used herein, the term “polymer” encompasses, but is not limited to, oligomers and both homopolymers and copolymers. The anionic salt group-containing film-forming polymer may comprise active hydrogen functional groups. As used herein, the term “active hydrogen functional groups” refers to those groups that are reactive with isocyanates as determined by the Zerewitinoff test as discussed above, and include, for example, hydroxyl groups, primary or secondary amine groups, and thiol groups. Anionic salt group-containing film-forming polymers that comprise active hydrogen functional groups may be referred to as active hydrogen-containing, anionic salt group-containing film-forming polymers. The anionic salt group containing film-forming polymer may be used in an anionic electrodepositable coating composition.

The anionic salt group-containing film-forming polymer may comprise base-solubilized, carboxylic acid group-containing film-forming polymers such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with polyol. Also suitable are the at least partially neutralized interpolymers of hydroxy-alkyl esters of unsaturated carboxylic acids, unsaturated carboxylic acid and at least one other ethylenically unsaturated monomer. Still another suitable anionic electrodepositable resin comprises an alkyd-aminoplast vehicle, i.e., a vehicle containing an alkyd resin and an amine-aldehyde resin. Another suitable anionic electrodepositable resin composition comprises mixed esters of a resinous polyol. Other acid functional polymers may also be used such as phosphatized polyepoxide or phosphatized acrylic polymers. Exemplary phosphatized polyepoxides are disclosed in U.S. Pat. Application Publication No. 2009-0045071 at [0004]-[0015] and U.S. patent application Ser. No. 13/232,093 at [0014]-[0040], the cited portions of which being incorporated herein by reference. Also suitable are resins comprising one or more pendent carbamate functional groups, such as those described in U.S. Pat. No. 6,165,338.

The anionic salt group-containing film-forming polymer may be present in the anionic electrodepositable coating composition in an amount of at least 50% by weight, such as at least 55% by weight, such as at least 60% by weight, based on the total weight of the resin solids of the electrodepositable coating composition. The anionic salt group-containing film-forming polymer may be present in the anionic electrodepositable coating composition in an amount of no more than 90% by weight, such as no more than 80% by weight, such as no more than 75% by weight, based on the total weight of the resin solids of the electrodepositable coating composition. The anionic salt group-containing film-forming polymer may be present in the anionic electrodepositable coating composition in an amount 50% to 90%, such as 50% to 80% by weight, such as 50% to 75% by weight, such as 55% to 90% by weight, such as 55% to 80%, such as 55% to 75% by weight, such as 60% to 90% by weight, such as 60% to 80% by weight, such as 60% to 75%, based on the total weight of the resin solids of the electrodepositable coating composition.

The ionic salt group-containing film-forming polymer may be present in the electrodepositable coating composition in an amount of at least 40% by weight, such as at least 50% by weight, such as at least 55% by weight, such as at least 60% by weight, based on the total weight of the resin solids of the electrodepositable coating composition. The ionic salt group-containing film-forming polymer may be present in the electrodepositable coating composition in an amount of no more than 90% by weight, such as no more than 80% by weight, such as no more than 75% by weight, based on the total weight of the resin solids of the electrodepositable coating composition. The ionic salt group-containing film-forming polymer may be present in the electrodepositable coating composition in an amount of 40% to 90% by weight, such as 40% to 80% by weight, such as 40% to 75% by weight, such as 50% to 90% by weight, such as 50% to 80% by weight, such as 50% to 75% by weight, such as 55% to 90% by weight, such as 55% to 80% by weight, such as 55% to 75% by weight, such as 60% to 90% by weight, such as 60% to 80% by weight, such as 60% to 75% by weight, based on the total weight of the resin solids of the electrodepositable coating composition.

### Blocked Polyisocyanate Curing Agent

The electrodepositable coating composition of the present disclosure further comprises a blocked polyisocyanate curing agent.

As used herein, a “blocked polyisocyanate” means a polyisocyanate wherein at least a portion of the isocyanato groups is blocked by a blocking group introduced by the reaction of a free isocyanato group of the polyisocyanate with a blocking agent. By “blocked” is meant that the isocyanato groups have been reacted with a blocking agent such that the resultant blocked isocyanate group is stable to active hydrogens at ambient temperature, e.g., room temperature (about 23° C.), but reactive with active hydrogens in the film-forming polymer at elevated temperatures, such as, for example, between 90° C. and 200° C. Therefore, a blocked polyisocyanate curing agent comprises a polyisocyanate reacted with one or more blocking agent(s). As used herein, a “blocking agent” refers to a compound comprising a functional group reactive with an isocyanato group present on the polyisocyanate resulting in binding a residual moiety of the blocking agent to the isocyanato group so that the isocyanato group is stable to active hydrogen functional groups at room temperature (i.e., 23° C.). The bound residual moiety of a blocking agent to the isocyanato group, which provides stability of the isocyanato group towards active hydrogen functional groups at room temperature, is referred to as a “blocking group” herein. Blocking groups may be identified by reference to the blocking agent from which they are derived by reaction with an isocyanato group. Blocking groups may be removed under suitable conditions, such as at elevated temperatures such that free isocyanato groups may be generated from the blocked isocyanato groups. Thus, the reaction with the blocking agent may be reversed at elevated temperature such that the previously blocked isocyanato group is free to react with active hydrogen functional groups. As used herein, the term “derived from” with respect to the blocking group of the blocked polyisocyanate is intended to refer to the presence of the residue of a blocking agent in the blocking group and is not intended to be limited to a blocking group produced by reaction of an isocyanato group of the polyisocyanate with the blocking agent. Accordingly, a blocking group of the present disclosure resulting from synthetic pathways that do not include direct reaction of the isocyanato group and blocking agent will still be considered to be “derived from” the blocking agent. Accordingly, the term “blocking agent” may also be used to refer to the moiety of the blocked polyisocyanate that leaves a blocking group during cure to produce a free isocyanato group. As used herein, the term “blocked” polyisocyanate curing agent” collectively refers to a fully blocked polyisocyanate curing agent and an at least partially blocked polyisocyanate curing agent. As used herein, a “fully blocked polyisocyanate curing agent” refers to a polyisocyanate wherein each of the isocyanato groups has been blocked with a blocking group. As used herein, an “at least partially blocked polyisocyanate curing agent” refers to a polyisocyanate wherein at least a portion of the isocyanato groups have been blocked with a blocking group while the remaining isocyanato groups have been reacted with a portion of the polymer backbone.

The blocked polyisocyanate curing agent comprises isocyanato groups that are reactive with the reactive groups, such as active hydrogen groups, of the ionic salt group-containing film-forming polymer to effectuate cure of the coating composition to form a coating. As used herein, the term “cure”, “cured” or similar terms, as used in connection with the electrodepositable coating compositions described herein, means that at least a portion of the components that form the electrodepositable coating composition are crosslinked to form a coating. Additionally, curing of the electrodepositable coating composition refers to subjecting said composition to curing conditions (e.g., elevated temperature) leading to the unblocking of the blocked isocyanato groups of the blocked polyisocyanate curing agent to result in reaction of the unblocked isocyanato groups of the polyisocyanate curing agent with active hydrogen functional groups of the film-forming polymer, and resulting in the crosslinking of the components of the electrodepositable coating composition and formation of an at least partially cured coating. Blocking agents removed during cure may be removed from the coating film by volatilization. Alternatively, a portion or all of the blocking agent may remain in the coating film following cure.

The polyisocyanates that may be used in preparing the blocked polyisocyanate curing agent of the present disclosure include any suitable polyisocyanate known in the art. A polyisocyanate is an organic compound comprising at least two, at least three, at least four, or more isocyanato functional groups, such as two, three, four, or more isocyanato functional groups. For example, the polyisocyanate may comprise aliphatic and/or aromatic polyisocyanates. As will be understood, an aromatic polyisocyanate will have a nitrogen atom of an isocyanate group covalently bound to a carbon present in an aromatic group, and an aliphatic polyiscoayante may contain an aromatic group that is indirectly bound to the isocyanato group through a non-aromatic hydrocarbon group. Aliphatic polyisocyanates may include, for example, (i) alkylene isocyanates, such as trimethylene diisocyanate, tetramethylene diisocyanate, pentamethylene diisocyanate, hexamethylene diisocyanate (“HDI”), 1,2-propylene diisocyanate, 1,2-butylene diisocyanate, 2,3-butylene diisocyanate, 1,3-butylene diisocyanate, ethylidene diisocyanate, and butylidene diisocyanate, and (ii) cycloalkylene isocyanates, such as 1,3-cyclopentane diisocyanate, 1,4-cyclohexane diisocyanate, 1,2-cyclohexane diisocyanate, isophorone diisocyanate, methylene bis(4-cyclohexylisocyanate) (“HMDI”), the cyclo-trimer of 1,6-hexamethylene diisocyanate (also known as the isocyanurate trimer of HDI, commercially available as Desmodur N3300 from Convestro AG), and meta-tetramethylxylylene diisocyanate (commercially available as TMXDI® from Allnex SA). Aromatic polyisocyanates may include, for example, (i) arylene isocyanates, such as m-phenylene diisocyanate, p-phenylene diisocyanate, 1,5-naphthalene diisocyanate and 1,4-naphthalene diisocyanate, and (ii) alkarylene isocyanates, such as 4,4′-diphenylene methane diisocyanate (“MDI”), 2,4-tolylene or 2,6-tolylene diisocyanate (“TDI”), or mixtures thereof, 4,4-toluidine diisocyanate and xylylene diisocyanate. Triisocyanates, such as triphenyl methane-4,4′,4″-triisocyanate, 1,3,5-triisocyanato benzene and 2,4,6-triisocyanato toluene, tetraisocyanates, such as 4,4′-diphenyldimethyl methane-2,2′,5,5′-tetraisocyanate, and polymerized polyisocyanates, such as tolylene diisocyanate dimers and trimers and the like, may also be used. The blocked polyisocyanate curing agent may also comprise a polymeric polyisocyanate, such as polymeric HDI, polymeric MDI, polymeric isophorone diisocyanate, and the like. The curing agent may also comprise a blocked trimer of hexamethylene diisocyanate available as Desmodur N3300® from Covestro AG. Mixtures of polyisocyanate curing agents may also be used.

As discussed above, the isocyanato groups of the polyisocyanate are blocked with a blocking agent such that the blocked polyisocyanate curing agent comprises blocking groups. The blocking groups may be formed by reacting the isocyanato groups with a molar ratio of blocking agents. For example, the isocyanato groups may be reacted with a 1:1 molar ratio of isocyanato groups to blocking agents such that the isocyanato groups are theoretically 100% blocked with the blocking agents. Alternatively, the molar ratio of isocyanato groups to blocking agents may be such that the isocyanato groups or blocking agent is in excess. The blocking group itself is a urethane group that contains the residues of the isocyanato group and blocking agent.

The blocking agent may comprise a 1,2-polyol. The 1,2-polyol will react with an isocyanato group of the polyisocyanate to form a blocking group. The 1,2-polyol may comprise at least 30%, such as at least 35%, such as at least 40%, such as at least 45%, such as at least 50%, such as at least 55%, such as at least 60%, such as at least 65%, such as at least 70%, such as at least 75%, such as at least 80%, such as at least 85%, such as at least 90%, such as at least 95%, such as at least 99%, such as 100%, based upon the total number of blocking groups. The 1,2-polyol may comprise no more than 100% of the blocking groups of the blocked polyisocyanate curing agent, such as no more than 99%, such as no more than 95%, such as no more than 90%, such as no more than 85%, such as no more than 80%, such as no more than 75%, such as no more than 70%, such as no more than 65%, such as no more than 60%, such as no more than 55%, such as no more than 50%, such as no more than 45%, such as no more than 40%, such as no more than 35%, such as no more than 30%, based upon the total number of blocking groups. The 1,2-polyol may comprise 30% to 100% of the blocking groups of the blocked polyisocyanate curing agent, such as 30% to 100%, such as 35% to 100%, such as 40% to 100%, such as 45% to 100%, such as 50% to 100%, such as 55% to 100%, such as 60% to 100%, 65% to 100%, such as 70% to 100%, such as 75% to 100%, such as 80% to 100%, 85% to 100%, such as 90% to 100%, such as 95% to 100%, such as 30% to 95%, such as 35% to 95%, such as 40% to 95%, such as 45% to 95%, such as 50% to 95%, such as 55% to 95%, such as 60% to 95%, 65% to 95%, such as 70% to 95%, such as 75% to 95%, such as 80% to 95%, 85% to 95%, such as 90% to 95%, such as 30% to 90%, such as 35% to 90%, such as 40% to 90%, such as 45% to 90%, such as 50% to 90%, such as 55% to 90%, such as 60% to 90%, 65% to 90%, such as 70% to 90%, such as 75% to 90%, such as 80% to 90%, 85% to 90%, such as 30% to 85%, such as 35% to 85%, such as 40% to 85%, such as 45% to 85%, such as 50% to 85%, such as 55% to 85%, such as 60% to 85%, 65% to 85%, such as 70% to 85%, such as 75% to 85%, such as 80% to 85%, such as 30% to 80%, such as 35% to 80%, such as 40% to 80%, such as 45% to 80%, such as 50% to 80%, such as 55% to 80%, such as 60% to 80%, 65% to 80%, such as 70% to 80%, such as 75% to 80%, such as 30% to 75%, such as 35% to 75%, such as 40% to 75%, such as 45% to 75%, such as 50% to 75%, such as 55% to 75%, such as 60% to 75%, 65% to 75%, such as 70% to 75%, such as 30% to 70%, such as 35% to 70%, such as 40% to 70%, such as 45% to 70%, such as 50% to 70%, such as 55% to 70%, such as 60% to 70%, 65% to 70%, such as 30% to 65%, such as 35% to 65%, such as 40% to 65%, such as 45% to 65%, such as 50% to 65%, such as 55% to 65%, such as 60% to 65%, such as 30% to 60%, such as 35% to 60%, such as 40% to 60%, such as 45% to 60%, such as 50% to 60%, such as 55% to 60%, such as 30% to 55%, such as 35% to 55%, such as 40% to 55%, such as 45% to 55%, such as 50% to 55%, such as 30% to 50%, such as 35% to 50%, such as 40% to 50%, such as 45% to 50%, such as 30% to 45%, such as 35% to 45%, such as 40% to 45%, such as 30% to 40%, such as 35% to 40%, such as 30% to 35%, based upon the total number of blocking groups. As used herein, the percentage of blocking groups of the blocked polyisocyanate curing agent with respect to a blocking agent refers to the molar percentage of isocyanato groups blocked by that blocking agent divided by the total number of isocyanato groups actually blocked, i.e., the total number of blocking groups. The percentage of blocking groups may be determined by dividing the total moles of blocking groups blocked with a specific blocking agent by the total moles of blocking groups of the blocked polyisocyanate curing agent and multiplying by 100. It may also be expressed in equivalents of the blocking agent to total equivalents of isocyanato groups from the polyisocyanate, and the percentages and equivalents may be converted and used interchangeably (e.g., 40% of the total blocking groups is the same as 4/10 equivalents). For clarity, when reference is made to blocking groups, blocked with a blocking agent, the blocking group does not need to be derived strictly from reaction of the isocyanato group with the blocking agent and may be made by any synthetic pathway, as discussed below.

The 1,2-polyol may comprise a 1,2-alkane diol. Non-limiting examples of the 1,2-alkane diol include ethylene glycol, propylene glycol, 1,2-butane diol, 1,2-pentane diol, 1,2-hexane diol, 1,2-heptanediol, 1,2-octanediol, glycerol esters or ethers having a 1,2-dihydroxyl-functionality, and the like, and may include combinations thereof.

As discussed above, the isocyanato groups of the polyisocyanate are blocked with a blocking agent such that the blocked polyisocyanate curing agent comprises blocking groups to produce a urethane-containing compound. Accordingly, the blocked polyisocyanate curing agent may be referred to by the resulting structure that occurs after reaction of the isocyanato group and blocking agent, and the blocked polyisocyanate curing agent may comprise the structure:

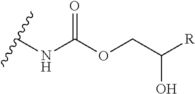

wherein R is hydrogen or a substituted or unsubstituted alkyl group comprising 1 to 8 carbon atoms, such as 1 to 6 carbon atoms, and wherein the substituted alkyl group optionally comprises an ether or ester functional group.

Although the blocked polyisocyanate curing agent is generally disclosed as being produced by reaction of the isocyanato group and blocking agent, it should be understood that any synthetic pathway that would produce the blocked polyisocyante curing agent of the structure above could be used to produce the blocked polyisocyanate curing agent of the present disclosure. For example, as shown in the reaction schematic below, an isocyanato group of a polyisocyanate (with the remainder of the polyisocyanate referred to as “X”) could be reacted with the hydroxyl-group of a hydroxyl- and epoxide-functional compound, with the result epoxide group then reacted with a hydroxyl-containing compound (wherein R is an alkyl group).

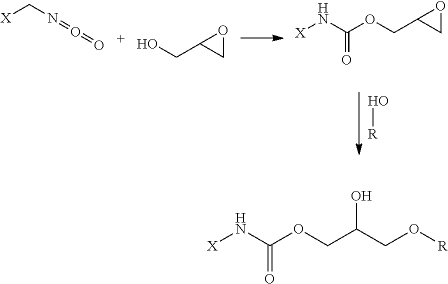

In addition to the 1,2-polyol, the blocked polyisocyanate may optionally further comprise a co-blocking agent. The co-blocking agent may comprise any suitable blocking agent. The co-blocking agent may comprise aliphatic, cycloaliphatic, or aromatic alkyl monoalcohols or phenolic compounds, including, for example, lower aliphatic alcohols, such as methanol, ethanol, and n-butanol; cycloaliphatic alcohols, including cycloaliphatic monoalcohols such as cyclohexanol; hetero-cycloaliphatic monoalcohols, such as solketal (DL-1,2-Isopropylideneglycerol); aromatic-alkyl alcohols, such as phenyl carbinol and methylphenyl carbinol; and phenolic compounds, such as phenol itself and substituted phenols wherein the substituents do not affect coating operations, such as cresol and nitrophenol. Glycol ethers and glycol amines may also be used as blocking agents. Suitable glycol ethers include ethylene glycol butyl ether, diethylene glycol butyl ether, ethylene glycol methyl ether and propylene glycol methyl ether. Other suitable blocking agents include oximes, such as methyl ethyl ketoxime, acetone oxime and cyclohexanone oxime. Other co-blocking agents include a 1,3-alkane diol, such as, for example, 1,3-butanediol; a benzylic alcohol, for example, benzyl alcohol; an allylic alcohol, for example, allyl alcohol; caprolactam; a dialkylamine, for example dibutylamine; other diol, triol, or polyols; and mixtures thereof.

The co-blocking agent may comprise at least 1% of the blocking groups of the blocked polyisocyanate curing agent, such as at least 5%, such as at least 10%, such as at least 15%, such as at least 20%, such as at least 25%, such as at least 30%, such as at least 45%, such as at least 50%, such as at least 55%, such as at least 60%, such as at least 65%, such as 70%, based upon the total number of blocking groups. The co-blocking agent may comprise no more than 70%, such as no more than 65%, such as no more than 60%, such as no more than 55%, such as no more than 50%, such as no more than 45%, such as no more than 40%, such as no more than 35%, such as no more than 30%, such as no more than 25%, such as no more than 20%, such as no more than 15%, such as no more than 10%, such as no more than 5%, such as no more than 1%, based upon the total number of blocking groups. The co-blocking agent may comprise 1% to 70%, such as 5% to 70%, such as 10% to 70%, such as 15% to 70%, such as 20% to 70%, such as 25% to 70%, such as 30% to 70%, such as 35% to 70%, such as 40% to 70%, such as 45% to 70%, such as 50% to 70%, such as 55% to 70%, such as 60% to 70%, such as 65% to 70%, such as 1% to 65%, such as 5% to 65%, such as 10% to 65%, such as 15% to 65%, such as 20% to 65%, such as 25% to 65%, such as 30% to 65%, such as 35% to 65%, such as 40% to 65%, such as 45% to 65%, such as 50% to 65%, such as 55% to 65%, such as 60% to 65%, such as 1% to 60%, such as 5% to 60%, such as 10% to 60%, such as 15% to 60%, such as 20% to 60%, such as 25% to 60%, such as 30% to 60%, such as 35% to 60%, such as 40% to 60%, such as 45% to 60%, such as 50% to 60%, such as 55% to 60%, such as 1% to 55%, such as 5% to 55%, such as 10% to 55%, such as 15% to 55%, such as 20% to 55%, such as 25% to 55%, such as 30% to 55%, such as 35% to 55%, such as 40% to 55%, such as 45% to 55%, such as 50% to 55%, such as 1% to 50%, such as 5% to 50%, such as 10% to 50%, such as 15% to 50%, such as 20% to 50%, such as 25% to 50%, such as 30% to 50%, such as 35% to 50%, such as 40% to 50%, such as 45% to 50%, such as 1% to 45%, such as 5% to 45%, such as 10% to 45%, such as 15% to 45%, such as 20% to 45%, such as 25% to 45%, such as 30% to 45%, such as 35% to 45%, such as 40% to 45%, such as 1% to 40%, such as 5% to 40%, such as 10% to 40%, such as 15% to 40%, such as 20% to 40%, such as 25% to 40%, such as 30% to 40%, such as 35% to 40%, such as 1% to 35%, such as 5% to 35%, such as 10% to 35%, such as 15% to 35%, such as 20% to 35%, such as 25% to 35%, such as 30% to 35%, such as 1% to 30%, such as 5% to 30%, such as 10% to 30%, such as 15% to 30%, such as 20% to 30%, such as 25% to 30%, such as 1% to 25%, such as 5% to 25%, such as 10% to 25%, such as 15% to 25%, such as 20% to 25%, such as 1% to 20%, such as 5% to 20%, such as 10% to 20%, such as 15% to 20%, such as 1% to 15%, such as 5% to 15%, such as 10% to 15%, such as 1% to 10%, such as 5% to 10%, such as 1% to 5%, based upon the total number of blocking groups.

The blocked polyisocyanate curing agent may be substantially free, essentially free, or completely free of blocking groups comprising a polyester diol blocking agent formed from the reaction of ethylene glycol, propylene glycol, or 1,4-butanediol with oxalic acid, succinic acid, adipic acid, suberic acid, or sebacic acid. The blocked polyisocyanate is substantially free of blocking groups comprising a polyester diol if such groups are present in an amount of 3% or less, based upon the total number of blocking groups. The blocked polyisocyanate is essentially free of blocking groups comprising a polyester diol if such groups are present in an amount of 1% or less, based upon the total number of blocking groups. The blocked polyisocyanate is completely free of blocking groups comprising a polyester diol is such groups are not present, i.e., 0%, based upon the total number of blocking groups.

The blocked polyisocyanate curing agent may comprise a blocking group derived from a blocking agent comprising an alpha-hydroxy amide, ester or thioester. As used herein, the term “alpha-hydroxy amide” refers to an organic compound having at least one alpha-hydroxy amide moiety that includes a hydroxyl functional group covalently bonded to an alpha-carbon of an amide group. As used herein, the term “alpha-hydroxy ester” refers to an organic compound having at least one alpha-hydroxy ester moiety that includes a hydroxyl functional group covalently bonded to an alpha-carbon of an ester group. As used herein, the term “alpha-hydroxy thioester” refers to an organic compound having at least one alpha-hydroxy thioester moiety that includes a hydroxyl functional group covalently bonded to an alpha-carbon of a thioester group. The blocking agent comprising an alpha-hydroxy amide, ester or thioester may comprise a compound of structure (I):

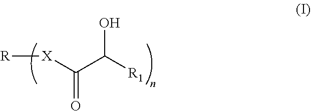

wherein X is N(R₂), O, S; n is 1 to 4; when n=1 and X=N(R₂), R is hydrogen, a C₁ to C₁₀ alkyl group, an aryl group, a polyether, a polyester, a polyurethane, a hydroxy-alkyl group, or a thio-alkyl group; when n=1 and X═O or S, R is a C₁ to C₁₀ alkyl group, an aryl group, a polyether, a polyester, a polyurethane, a hydroxy-alkyl group, or a thio-alkyl group; when n=2 to 4, R is a multi-valent C₁ to C₁₀ alkyl group, a multi-valent aryl group, a multi-valent polyether, a multi-valent polyester, a multi-valent polyurethane; each R₁ is independently hydrogen, a C₁ to C₁₀ alkyl group, an aryl group, or a cycloaliphatic group; each R₂ is independently hydrogen, a C₁ to C₁₀ alkyl group, an aryl group, a cycloaliphatic group, a hydroxy-alkyl group, or a thio-alkyl group; and R and R₂ together can form a cycloaliphatic, heterocyclic structure. The cycloaliphatic, heterocyclic structure may comprise, for example, morpholine, piperidine, or pyrrolidine. It should be noted that R can only be hydrogen if X is N(R₂).

As used herein, “alkyl” refers to a hydrocarbon chain that may be linear or branched and may comprise one or more hydrocarbon rings that are not aromatic. As used herein, “aryl” refers to a hydrocarbon having a delocalized conjugated x-system with alternating double and single bonds between carbon atoms forming one or more coplanar hydrocarbon rings. As used herein, “cycloaliphatic” refers to a hydrocarbon that comprises one or more hydrocarbon rings that are not aromatic. As used herein, the term “polyether” refers to hydrocarbons having more than one ether group and may optionally comprise other functional groups such as hydroxyl or amino groups. As used herein, the term “polyester” refers to hydrocarbon compounds having more than one ester group and may optionally comprise other functional groups such as hydroxyl or amino groups. As used herein, the term “polyurethane” refers to hydrocarbon compounds having more than one urethane group and may optionally comprise other functional groups such as hydroxyl or amino groups. As used herein, the term “hydroxy-alkyl group” refers to an alkyl group having a hydroxyl functional group. As used herein, the term “thio-alkyl group” refers to an alkyl group having a thiol functional group.

The alpha-hydroxy amide blocking agent may comprise a substituted glycolamide. As used herein, the term “substituted glycolamide” refers to a glycolamide compound having at least one of the hydrogen atoms bonded to the nitrogen atom substituted for a substituent such as a monovalent organic group. A substituted glycolamide, with reference to Structure (I), comprises a compound wherein X is N(R₂); R₁ is hydrogen; each R₂ is independently hydrogen, a C₁ to C₁₀ alkyl group, an aryl group, a cycloaliphatic group, a hydroxy-alkyl group, or a thio-alkyl group; and R is a C₁ to C₁₀ alkyl group, an aryl group, a cycloaliphatic group, a polyether, a polyester, a polyurethane, a hydroxy-alkyl group, or a thio-alkyl group. Accordingly, the substituted glycolamide may comprise an alkyl glycolamide, an aryl glycolamide, a polyether glycolamide, a polyester glycolamide, a polyurethane glycolamide, a hydroxy-alkyl glycolamide, or a thio-alkyl glycolamide. Each of these compounds may be mono- or di-substituted, such as, for example, with reference to the alkyl glycolamide, a mono-alkyl glycolamide or di-alkyl glycolamide. Specific non-limiting examples of the mono-alkyl glycolamide include, for example, methyl glycolamide, ethyl glycolamide, propyl glycolamide, isopropyl glycolamide, butyl glycolamide, pentyl glycolamide, hexyl glycolamide, heptyl glycolamide, octyl glycolamide, ethyl-hexyl glycolamide, nonyl glycolamide, decyl glycolamide, and the like, and specific examples of the di-alkyl glycolamide comprise any of the mon-alkyl glycolamide with an additional alkyl substituent, such as dimethyl glycolamide, di-ethyl glycolamide, dibutyl glycolamide, dipentyl glycolamide, and the like.

Additionally, the substituted glycolamide blocking agent may comprise more than one glycolamide groups, such as, with reference to Structure (I), when n is greater than 1. It should be understood that when n is 1 the R group is univalent and when n is greater than 1 the R group is multi-valent, such as a multi-valent C₁ to C₁₀ alkyl group, aryl group, cycloaliphatic group, polyether, polyester, or polyurethane polymer.

The alpha-hydroxy amide blocking agent may comprise a substituted lactamide. As used herein, the term “substituted lactamide” refers to a lactamide compound having at least one of the hydrogen atoms bonded to the nitrogen atom substituted for a substituent such as a monovalent organic group. A substituted lactamide, with reference to Structure (I), comprises a compound wherein X is N(R₂); R₁ is methyl; each R₂ is independently hydrogen, a C₁ to C₁₀ alkyl group, an aryl group, a cycloaliphatic group, a hydroxy-alkyl group, or a thio-alkyl group; and R is a C₁ to C₁₀ alkyl group, an aryl group, a cycloaliphatic group, a polyether, a polyester, a polyurethane, a hydroxy-alkyl group, or a thio-alkyl group. Accordingly, the substituted lactamide may comprise an alkyl lactamide, an aryl lactamide, a polyether lactamide, a polyester lactamide, a polyurethane lactamide, a hydroxy-alkyl lactamide, or a thio-alkyl lactamide. Each of these compounds may be mono- or di-substituted, such as, for example, with reference to the alkyl lactamide, a mono-alkyl lactamide or di-alkyl lactamide. Non-limiting specific examples of the mono-alkyl lactamide include methyl lactamide, ethyl lactamide, propyl lactamide, isopropyl lactamide, butyl lactamide, pentyl lactamide, hexyl lactamide, heptyl lactamide, octyl lactamide, ethyl-hexyl lactamide, nonyl lactamide, decyl lactamide, and the like, and specific examples of the di-alkyl lactamide include di-methyl lactamide, di-ethyl lactamide, di-propyl lactamide, di-butyl lactamide, di-pentyl lactamide, di-hexyl lactamide, and the like.

Additionally, the substituted lactamide blocking agent may comprise more than one lactamide groups, such as, with reference to Structure (I), when n is greater than 1. It should be understood that when n is 1 the R group is univalent and when n is greater than 1 the R group is multi-valent, such as a multi-valent C₁ to C₁₀ alkyl group, aryl group, cycloaliphatic group, polyether, polyester, or polyurethane polymer.

The alkyl glycolamide or the alkyl lactamide blocking group of the present disclosure may comprise, for example, a compound of the structure:

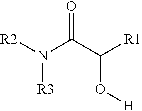

wherein R₁ is hydrogen or a methyl group; R₂ is a C₁ to C₁₀ alkyl group; and R₃ is hydrogen, a C₁ to C₁₀ alkyl group. It will be understood that R₁ is a methyl group in the alkyl lactamide.

Non-limiting examples of the blocking agent comprising an alpha-hydroxy amide, ester or thioester are provided in Int'l Pub. No. WO 2018/148306 A1, at par. [0012] to [0026], the cited portion of which is incorporated herein by reference.

As used herein, the term “multi-valent” refers to an organic moiety having two or more bonding sites through which the organic moiety is covalently bonds to other organic moieties. For example, a polyisocyanate is multi-valent because it includes two or more isocyanato groups through which it covalently bonds with other organic moieties. The organic moiety may be, for example, an alkyl group, a cycloaliphatic group, an aryl group, a polyether, a polyester, a polyurethane, and the like.

As used herein, the term “mono-valent” refers to an organic moiety having one bonding site through which the organic moiety is covalently bonded to another organic moiety. Although mono-valent is used to refer to an organic moiety having only one bonding site, that does not preclude the presence of other functional groups through which the organic moiety may bind to additional organic moieties, such as, for example, during cure.

The blocked polyisocyanate curing agent may comprise a tris(alkoxycarbonylamino)-1,3,5-triazine (TACT). The tris(alkoxycarbonylamino)-1,3,5-triazine may be according to the following structure:

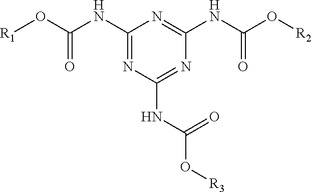

wherein R₁, R₂, and R₃ each independently comprise a C₁-C₈ alkyl group, such as a C₁-C₆ alkyl group, such as a C₁-C₄ alkyl group. In a non-limiting example, R₁ and R₂ are each methyl and R₃ is n-butyl, or R₁ and R₂ are each n-butyl and R₃ methyl. In a non-limiting example, each of the radicals R₁, R₂, and R₃ is n-butyl. Examples of suitable tris(alkoxycarbonylamino)-1,3,5-triazines include tris(methoxycarbonylamino)-, tris(butoxycarbonylamino)-, and tris(2-ethylhexoxycarbonylamino)-1,3,5-triazines, and any combination thereof.

The curing agent may be present in the electrodepositable coating composition in an amount of at least 10% by weight, such as at least 20% by weight, such as at least 25% by weight, based on the total weight of the resin solids of the electrodepositable coating composition. The curing agent may be present in the electrodepositable coating composition in an amount of no more than 60% by weight, such as no more than 50% by weight, such as no more than 45% by weight, such as no more than 40% by weight, based on the total weight of the resin solids of the electrodepositable coating composition. The curing agent may be present in the electrodepositable coating composition in an amount of 10% to 60% by weight, such as 10% to 50% by weight, such as 10% to 45% by weight, such as 10% to 40% by weight, such as 20% to 60% by weight, such as 20% to 50% by weight, such as 20% to 45% by weight, such as 20% to 40% by weight, such as 25% to 60% by weight, such as 25% to 50% by weight, such as 25% to 45% by weight, such as 25% to 40% by weight, based on the total weight of the resin solids of the electrodepositable coating composition.

### Curing Catalyst

The electrodepositable coating composition further comprises a curing catalyst. As used herein, the term “curing catalyst” refers to catalysts that catalyze transurethanation reactions, and specifically catalyze the deblocking of blocked polyisocyanate blocking groups. The curing catalyst optionally may be a curing catalyst that does not contain tin, lead, iron, zinc, or manganese. Non-limiting examples of curing catalysts include organic curing catalysts, such as, but not limited to, amine-containing compounds; bismuth compounds or complexes; compounds or complexes of titanium; compounds or complexes of zinc; and combinations thereof.

The amine-containing curing catalyst may comprise any suitable amine-containing curing catalyst. For example, the amine-containing curing catalyst may comprise a guanidine curing catalyst, an imidazole curing catalyst, an amidine, or any combination thereof.

It will be understood that “guanidine,” as used herein, refers to guanidine and derivatives thereof. For example, the guanidine may comprise a compound, moiety, and/or residue having the following general structure:

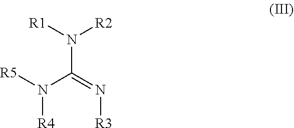

wherein each of R1, R2, R3, R4, and R5 (i.e., substituents of structure (III)) comprise hydrogen, (cyclo)alkyl, aryl, aromatic, organometallic, a polymeric structure, or together can form a cycloalkyl, aryl, or an aromatic structure, and wherein R1, R2, R3, R4, and R5 may be the same or different. As used herein, “(cyclo)alkyl” refers to both alkyl and cycloalkyl. When any of the R groups “together can form a (cyclo)alkyl, aryl, and/or aromatic group” it is meant that any two adjacent R groups are connected to form a cyclic moiety, such as the rings in structures (IV)-(VII) below.

It will be appreciated that the double bond between the carbon atom and the nitrogen atom that is depicted in structure (III) may be located between the carbon atom and another nitrogen atom of structure (III). Accordingly, the various substituents of structure (III) may be attached to different nitrogen atoms depending on where the double bond is located within the structure.

The guanidine may comprise a cyclic guanidine such as a guanidine of structure (III) wherein two or more R groups of structure (III) together form one or more rings. In other words, the cyclic guanidine may comprise ≥1 ring(s).

The cyclic guanidine may comprise a bicyclic guanidine, and the bicyclic guanidine may comprise 1,5,7-triazabicyclo[4.4.0]dec-5-ene (“TBD” or “BCG”).

The guanidine is present in the electrodepositable coating composition such that a weight ratio of bismuth metal from the solubilized bismuth catalyst to guanidine of from 1.00:0.071 to 1.0:2.1, such as from 1.0:0.17 to 1.0:2.0, such as from 1.0:0.33 to 1.0:1.33, such as from 1.0:0.47 to 1.0:1.0.

The guanidine is present in the electrodepositable coating composition such that a molar ratio of bismuth metal to guanidine of from 1.0:0.25 to 1.0:3.0, such as from 1:0.5 to 1.0:2.0, such as from 1:0.7 to 1:1.5.

It has been surprisingly discovered that the addition of a guanidine to a bismuth-catalyzed electrodepositable coating composition allows for the production of an electrodepositable coating composition that maintains cure even as the concentration of phosphate ions increases. Sufficient cure performance may be maintained despite phosphate ions present in the electrodepositable coating composition. For example, the electrodepositable coating composition may achieve cure with phosphate ions present in the electrodepositable coating composition in an amount of 1 to 1,000 ppm, such as 1 to 800 ppm, such as 1 to 500 ppm, such as 1 to 300 ppm, such as 1 to 200 ppm, such as 100 to 1,000 ppm, such as 100 to 800 ppm, such as 100 to 500 ppm, such as 100 to 300 ppm, such as 100 to 200 ppm, such as 200 to 1,000 ppm, such as 200 to 800 ppm, such as 200 to 500 ppm, such as 200 to 300 ppm, such as 300 to 1,000 ppm, such as 300 to 800 ppm, such as 300 to 500 ppm.

The imidazole curing catalyst may comprise the imidazole modified product as described in Int'l Pub. No. WO 2020/203311 A1.

The amidine curing catalyst may comprise 1,8-diazabicyclo[5.4.0]undec-7-ene (DBU).

The amine-containing curing catalyst may be present in the coating composition in an amount of at least 0.1% by weight, based on the total weight of the resin solids of the coating composition, such as at least 0.2% by weight, such as at least 0.5% by weight, such as at least 0.8% by weight, such as at least 1% by weight, such as at least 1.5% by weight. The amine-containing curing catalyst may be present in the coating composition in an amount of no more than 7% by weight, based on the total weight of the resin solids of the coating composition, such as no more than 4% by weight, such as no more than 2% by weight, such as no more than 1.5% by weight, such as no more than 1% by weight. The amine-containing curing catalyst may be present in the coating composition in an amount of 0.1% to 7% by weight, based on the total weight of the resin solids of the coating composition, such as 0.1% to 4% by weight, such as 0.1% to 2% by weight, such as 0.1% to 1.5% by weight, such as 0.1% to 1% by weight, such as 0.2% to 7% by weight, such as 0.2% to 4% by weight, such as 0.2% to 2% by weight, such as 0.2% to 1.5% by weight, such as 0.2% to 1% by weight, such as 0.5% to 7% by weight, such as 0.5% to 4% by weight, such as 0.5% to 2% by weight, such as 0.5% to 1.5% by weight, such as 0.5% to 1% by weight, such as 0.8% to 7% by weight, such as 0.8% to 4% by weight, such as 0.8% to 2% by weight, such as 0.8% to 1.5% by weight, such as 0.8% to 1% by weight, such as 1% to 7% by weight, such as 1% to 4% by weight, such as 1% to 2% by weight, such as 1% to 1.5% by weight, such as 1.5% to 7% by weight, such as 1.5% to 4% by weight, such as 1.5% to 2% by weight.

The zinc-containing catalyst may comprise a metal salt and/or complex of zinc. For example, the zinc-containing curing catalyst may comprise a zinc (II) amidine complex, zinc octoate, zinc naphthenate, zinc tallate, zinc carboxylates having from about 8 to 14 carbons in the carboxylate group, zinc acetate, zinc sulfonates, zinc methanesulfonates, or any combination thereof.

The zinc (II) amidine complex contains amidine and carboxylate ligands. More specifically, the zinc (II) amidine complex comprises compounds having the formula Zn(A)₂(C)₂ wherein A represents an amidine and C represents a carboxylate. More specifically, A may be represented by the formula (1) or (2):

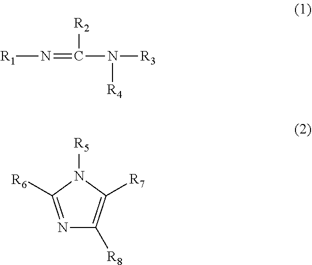

wherein R¹ and R³ are each independently hydrogen or an organic group attached through a carbon atom or are joined to one another by an N═C—N linkage to form a heterocyclic ring with one or more hetero atoms or a fused bicyclic ring with one or more heteroatoms; R² is hydrogen, an organic group attached through a carbon atom, an amine group which is optionally substituted, or a hydroxyl group which is optionally etherified with a hydrocarbyl group having up to 8 carbon atoms; R⁴ is hydrogen, an organic group attached through a carbon atom or a hydroxyl group which can be optionally etherified with a hydrocarbyl group having up to 8 carbon atoms; and R⁵, R⁶, R⁷ and R⁸ are independently hydrogen, alkyl substituted alkyl hydroxyalkyl, aryl, aralkyl, cycloalkyl, heterocyclics, ether, thioether, halogen, —N(R)₂, polyethylene polyamines, nitro groups, keto groups, ester groups, or carbonamide groups optionally alkyl substituted with alkyl substituted alkyl hydroxyalkyl, aryl, aralkyl, cycloalkyl, heterocycles, ether, thioether, halogen, —N(R)₂, polyethylene polyamines, nitro groups, keto groups or ester groups; and C is an aliphatic, aromatic or polymeric carboxylate with an equivalent weight of 45 to 465.

The zinc-containing curing catalyst may be present in the coating composition in an amount of at least 0.1% by weight, based on the total weight of the resin solids of the coating composition, such as at least 0.2% by weight, such as at least 0.5% by weight, such as at least 0.8% by weight, such as at least 1% by weight, such as at least 1.5% by weight. The zinc-containing curing catalyst may be present in the coating composition in an amount of no more than 7% by weight, based on the total weight of the resin solids of the coating composition, such as no more than 4% by weight, such as no more than 2% by weight, such as no more than 1.5% by weight, such as no more than 1% by weight. The zinc-containing curing catalyst may be present in the coating composition in an amount of 0.1% to 7% by weight, based on the total weight of the resin solids of the coating composition, such as 0.1% to 4% by weight, such as 0.1% to 2% by weight, such as 0.1% to 1.5% by weight, such as 0.1% to 1% by weight, such as 0.2% to 7% by weight, such as 0.2% to 4% by weight, such as 0.2% to 2% by weight, such as 0.2% to 1.5% by weight, such as 0.2% to 1% by weight, such as 0.5% to 7% by weight, such as 0.5% to 4% by weight, such as 0.5% to 2% by weight, such as 0.5% to 1.5% by weight, such as 0.5% to 1% by weight, such as 0.8% to 7% by weight, such as 0.8% to 4% by weight, such as 0.8% to 2% by weight, such as 0.8% to 1.5% by weight, such as 0.8% to 1% by weight, such as 1% to 7% by weight, such as 1% to 4% by weight, such as 1% to 2% by weight, such as 1% to 1.5% by weight, such as 1.5% to 7% by weight, such as 1.5% to 4% by weight, such as 1.5% to 2% by weight.

According to the present disclosure, the curing catalyst may comprise a bismuth catalyst. As used herein, the term “bismuth catalyst” refers to catalysts that contain bismuth and catalyze transurethanation reactions, and specifically catalyze the deblocking of the blocked polyisocyanate curing agent blocking groups.

The bismuth catalyst may comprise a soluble bismuth catalyst. As used herein, a “soluble” or “solubilized” bismuth catalyst is at catalyst wherein at least 35% of the bismuth catalyst dissolves in an aqueous medium having a pH in the range of 4 to 7 at room temperature (e.g., 23° C.). The soluble bismuth catalyst may provide solubilized bismuth metal in an amount of at least 0.04% by weight, based on the total weight of the electrodepositable coating composition.

Alternatively, the bismuth catalyst may comprise an insoluble bismuth catalyst. As used herein, an “insoluble” bismuth catalyst is at catalyst wherein less than 35% of the catalyst dissolves in an aqueous medium having a pH in the range of 4 to 7 at room temperature (e.g., 23° C.). The insoluble bismuth catalyst may provide solubilized bismuth metal in an amount of less than 0.04% by weight, based on the total weight of the electrodepositable coating composition.

The percentage of solubilized bismuth catalyst present in the composition may be determined using ICP-MS to calculate the total amount of bismuth metal (i.e., soluble and insoluble) and total amount of solubilized bismuth metal and calculating the percentage using those measurements.

The bismuth catalyst may comprise a bismuth compound and/or complex.

The bismuth catalyst may, for example, comprise a colloidal bismuth oxide or bismuth hydroxide, a bismuth compound complex such as, for example, a bismuth chelate complex, or a bismuth salt of an inorganic or organic acid, wherein the term “bismuth salt” includes not only salts comprising bismuth cations and acid anions, but also bismuthoxy salts.

Examples of inorganic or organic acids from which the bismuth salts may be derived are hydrochloric acid, sulphuric acid, nitric acid, inorganic or organic sulphonic acids, carboxylic acids, for example, formic acid or acetic acid, amino carboxylic acids and hydroxy carboxylic acids, such as lactic acid or dimethylolpropionic acid.

Non-limiting examples of bismuth salts are aliphatic hydroxycarboxylic acid salts of bismuth, such as lactic acid salts or dimethylolpropionic acid salts of bismuth, for example, bismuth lactate or bismuth dimethylolpropionate; bismuth subnitrate; amidosulphonic acid salts of bismuth; hydrocarbylsulphonic acid salts of bismuth, such as alkyl sulphonic acid salts, including methane sulphonic acid salts of bismuth, for example, bismuth methane sulphonate. Further non-limiting examples of bismuth compound or complex catalysts include bismuth oxides, bismuth carboxylates, bismuth sulfamate, bismuth sulphonate, and combinations thereof.

The bismuth catalyst may be present in an amount of at least 0.01% by weight of bismuth metal, such as at least 0.1% by weight, such as at least 0.2% by weight, such as at least 0.5% by weight, such as at least 1% by weight, such as 1% by weight, based on the total resin solids weight of the composition. The bismuth catalyst may be present in an amount of no more than 3% by weight of bismuth metal, such as no more than 1.5% by weight, such as no more than 1% by weight, based on the total resin solids weight of the composition. The bismuth catalyst may be present in an amount of 0.01% to 3% by weight of bismuth metal, such as 0.1% to 1.5% by weight, such as 0.2% to 1% by weight, such as 0.5% to 3% by weight, such as 0.5% to 1.5% by weight, such as 0.5% to 1% by weight, such as 1% to 3% by weight, such as 1% to 1.5% by weight, based on the total resin solids weight of the composition.

The bismuth catalyst may be present in an amount such that the amount of solubilized bismuth metal may be at least 0.04% by weight, based on the total weight of the electrodepositable coating composition, such as at least 0.06% by weight, such as at least 0.07% by weight, such as at least 0.08% by weight, such as at least 0.09% by weight, such as at least 0.10% by weight, such as at least 0.11% by weight, such as at least 0.12% by weight, such as at least 0.13% by weight, such as at least 0.14% by weight, or higher. The bismuth catalyst may be present in an amount such that the amount of solubilized bismuth metal of no more than 0.30% by weight, based on the total weight of the electrodepositable coating composition.

The bismuth catalyst may be present in an amount such that the amount of solubilized bismuth metal may be at least 0.22% by weight, based on the total weight of the resin solids, such as at least 0.30% by weight, such as at least 0.34% by weight, such at least 0.40% by weight, such as at least 0.45% by weight, such as 0.51% by weight, such as at least 0.56% by weight, such as at least 0.62% by weight, such as at least 0.68% by weight, such as at least 0.73% by weight, such as at least 0.80% by weight, or higher.

The electrodepositable coating composition may be substantially free, essentially free, or completely free of bismuth subnitrate. As used herein, an electrodepositable coating composition is “substantially free” of bismuth subnitrate if bismuth subnitrate is present, if at all, in an amount less than 0.01% by weight, based on the total resin solids weight of the composition. As used herein, an electrodepositable coating composition is “essentially free” of bismuth subnitrate if bismuth subnitrate is present, if at all, in trace or incidental amounts insufficient to affect any properties of the composition, such as, e.g., less than 0.001% by weight, based on the total resin solids weight of the composition. As used herein, an electrodepositable coating composition is “completely free” of bismuth subnitrate if bismuth subnitrate is not present in the composition, i.e., 0.000% by weight, based on the total resin solids weight of the composition.

The electrodepositable coating composition may be substantially free, essentially free, or completely free of bismuth oxide. As used herein, an electrodepositable coating composition is “substantially free” of bismuth oxide if bismuth oxide is present, if at all, in an amount less than 0.01% by weight, based on the total resin solids weight of the composition. As used herein, an electrodepositable coating composition is “essentially free” of bismuth oxide if bismuth oxide is present, if at all, in trace or incidental amounts insufficient to affect any properties of the composition, such as, e.g., less than 0.001% by weight, based on the total resin solids weight of the composition. As used herein, an electrodepositable coating composition is “completely free” of bismuth oxide if bismuth oxide is not present in the composition, i.e., 0.000% by weight, based on the total resin solids weight of the composition.

The electrodepositable coating composition may be substantially free, essentially free, or completely free of bismuth silicate, bismuth titanate, bismuth sulfamate, and/or bismuth lactate. As used herein, an electrodepositable coating composition is “substantially free” of any of such materials (each individually) if the material is present, if at all, in an amount less than 0.01% by weight, based on the total resin solids weight of the composition. As used herein, an electrodepositable coating composition is “essentially free” of any of such materials (each individually) if the material is present, if at all, in trace or incidental amounts insufficient to affect any properties of the composition, such as, e.g., less than 0.001% by weight, based on the total resin solids weight of the composition. As used herein, an electrodepositable coating composition is “completely free” of any of such materials (each individually) if the material is not present in the composition, i.e., 0.000% by weight, based on the total resin solids weight of the composition.

### Edge Control Additive

The electrodepositable coating compositions of the present disclosure further comprises an edge control additive.

As used herein, the term “edge control additive” refers to a material that is added in an additive amount (i.e., generally less than 15% by weight, based on the total weight of the resin solids) that improves the coverage of the coating on the edges of the substrate to which it is applied after the coating is cured. The edge control additive may function by manipulating the flow of the binder components during cure.

The edge control additive may comprise (1) an addition polymer comprising a polymerization product of a polymeric dispersant and a second-stage ethylenically unsaturated monomer composition comprising a second-stage hydroxyl-functional (meth)acrylamide monomer and/or a second-stage hydroxyl-functional (meth)acrylate monomer; (2) a hydroxyl-functional addition polymer comprising constitutional units, at least 70% of which comprise formula VIII:

-[—C(R¹)₂—C(R¹)(OH)—]- (VIII),

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group, and the % based upon the total constitutional units of the hydroxyl-functional addition polymer; (3) a cellulose derivative; (4) polyvinyl formamide; (5) cationic epoxy microgel; (6) a polyamine-dialdehyde adduct, or any combination thereof.

As used herein, the term “addition polymer” refers to a polymerization product at least partially comprising the residue of unsaturated monomers.

Addition polymer comprising a polymerization product of a polymeric dispersant and a second-stage ethylenically unsaturated monomer composition comprising a second-stage hydroxyl-functional (meth)acrylamide monomer and/or a second-stage hydroxyl-functional (meth)acrylate monomer: The edge control additive may comprise an addition polymer comprising a polymerization product of a polymeric dispersant and a second-stage ethylenically unsaturated monomer composition comprising a second-stage hydroxyl-functional (meth)acrylamide monomer and/or a second-stage hydroxyl-functional (meth)acrylate monomer.

The addition polymer may comprise an acrylic polymer comprising a polymerization product of a polymeric dispersant and an aqueous dispersion of a second-stage ethylenically unsaturated monomer composition. As used herein, the term “acrylic polymer” refers to a polymerization product at least partially comprising the residue of (meth)acrylic monomers. The polymerization product may be formed by a two-stage polymerization process, wherein the polymeric dispersant is polymerized during the first-stage and the second-stage ethylenically unsaturated monomer composition is added to an aqueous dispersion of the polymeric dispersant and polymerized in the presence of the polymeric dispersant that participates in the polymerization to form the acrylic polymer during the second stage. A non-limiting example of an acrylic polymer comprising a polymerization product of a polymeric dispersant and an aqueous dispersion of a second-stage ethylenically unsaturated monomer composition is described in Int'l Pub. No. WO 2018/160799 A1, at par. [0013] to [0055], the cited portion of which is incorporated herein by reference.

The addition polymer may alternatively comprise a polymerization product of a polymeric dispersant and a second-stage ethylenically unsaturated monomer composition comprising a second-stage (meth)acrylamide monomer.

The polymerization product may be formed by a two-stage polymerization process, wherein the polymeric dispersant is polymerized during the first-stage and the second-stage ethylenically unsaturated monomer composition is added to an aqueous dispersion of the polymeric dispersant and polymerized in the presence of the polymeric dispersant that participates in the polymerization to form the addition polymer during the second stage.

The polymeric dispersant may comprise any polymeric dispersant having a sufficient salt-group content to stably disperse and participate in a subsequent polymerization of a second-stage ethylenically unsaturated monomer composition and to provide for a resulting addition polymer that is stable in an electrodepositable coating composition. Although reference is made to the polymeric dispersant polymerized during the first stage, it will be understood that pre-formed or commercially available dispersants may be used, and the prior formation of the polymeric dispersant would be considered to be first-stage polymerization.

The polymeric dispersant polymerized during the first stage may comprise the polymerization product of a first-stage ethylenically unsaturated monomer composition.

The first-stage ethylenically unsaturated monomer composition comprises one or more monomers that allow for the incorporation of ionic salt-groups into the polymeric dispersant such that the polymeric dispersant comprises an ionic salt group-containing polymeric dispersant. For example, the polymeric dispersant may comprise cationic salt groups such that the polymeric dispersant comprises a cationic salt group-containing polymeric dispersant or anionic salt groups such that the polymeric dispersant comprises an anionic salt group-containing polymeric dispersant. The cationic salt groups may be formed by incorporation of an epoxide functional unsaturated monomer, an amino functional unsaturated monomer, or a combination thereof, and subsequent neutralization. For example, the polymeric dispersant may comprise a cationic salt group-containing polymeric dispersant comprising a polymerization product of a first-stage ethylenically unsaturated monomer composition comprising an epoxide functional ethylenically unsaturated monomer, and/or an amino functional ethylenically unsaturated monomer. The anionic salt groups may be formed by incorporation of an acid functional unsaturated monomer and subsequent neutralization. For example, the polymeric dispersant may comprise an anionic salt group-containing polymeric dispersant comprising a polymerization product of a first-stage ethylenically unsaturated monomer composition comprising an acid-functional ethylenically unsaturated monomer.

The first-stage ethylenically unsaturated monomer composition may optionally comprise an epoxide functional monomer. The epoxide functional monomer allows for the incorporation of epoxide functional groups into the polymeric dispersant. The epoxide functional groups may be converted to cationic salt groups via reaction of the epoxide functional group with an amine and neutralization with acid. Examples of suitable epoxide functional monomers include glycidyl acrylate, glycidyl methacrylate, 3,4-epoxycyclohexylmethyl(meth)acrylate, 2-(3,4-epoxycyclohexyl)ethyl(meth)acrylate, or allyl glycidyl ether. The epoxide functional monomer may be present in an amount of 5% to 50% by weight, such as 5% to 40% by weight, such as 5% to 30% by weight, such as 5% to 25% by weight, such as 5% to 20% by weight, such as 10% to 50% by weight, such as 10% to 40% by weight, such as 10% to 30% by weight, such as 10% to 25% by weight, such as 10% to 20% by weight, such as 20% to 50% by weight, such as 20% to 40% by weight, such as 20% to 30% by weight, such as 20% to 25% by weight, based on the total weight of the first-stage ethylenically unsaturated monomer composition.

The first-stage ethylenically unsaturated monomer composition may optionally comprise an amino functional monomer. The amino functional monomer allows for the incorporation of amino functional groups into the polymeric dispersant. The amino functional groups may be converted to cationic salt groups by neutralization with acid. The amino functional monomer may comprise any suitable amino functional unsaturated monomer, such as, for example, a N-alkylamino alkyl(meth)acrylate, a N,N-(dialkyl)amino alkyl(meth)acrylate, an amino alkyl(meth)acrylate, or the like. Specific non-limiting examples of suitable amino functional monomers include 2-aminoethyl (meth)acrylate, 2-(dimethylamino)ethylmethacrylate (“DMAEMA”), 2-(dimethylamino)ethyl acrylate, 3-(dimethylamino)propyl (meth)acrylate, 2-(diethylamino)ethyl (meth)acrylate, 2-(tert-butylamino)ethyl (meth)acrylate, and 2-(diethylamino)ethyl (meth)acrylate, as well as combinations thereof. The amino functional monomer may be present in an amount of 5% to 50% by weight, such as 5% to 40% by weight, such as 5% to 30% by weight, such as 5% to 25% by weight, such as 5% to 20% by weight, such as 10% to 50% by weight, such as 10% to 40% by weight, such as 10% to 30% by weight, such as 10% to 25% by weight, such as 10% to 20% by weight, such as 20% to 50% by weight, such as 20% to 40% by weight, such as 20% to 30% by weight, such as 20% to 25% by weight, based on the total weight of the first-stage ethylenically unsaturated monomer composition.

The first-stage ethylenically unsaturated monomer composition may optionally comprise an acid-functional ethylenically unsaturated monomer. The acid-functional monomer allows for the incorporation of anionic salt groups into the polymeric dispersant by neutralization with a base. The acid-functional ethylenically unsaturated monomer may comprise phosphoric acid or carboxylic acid functional ethylenically unsaturated monomers, such as, for example, (meth)acrylic acid. The acid functional monomer may be present in the first-stage ethylenically unsaturated monomer composition in an amount of at least 5% by weight, such as at least 10% by weight, such as at least 20% by weight, based on the total weight of the first-stage ethylenically unsaturated monomer composition. The acid functional monomer may be present in the first-stage ethylenically unsaturated monomer composition in an amount of no more than 50% by weight, such as no more than 40% by weight, such as no more than 30% by weight, such as no more than 25% by weight, such as no more than 20% by weight, based on the total weight of the first-stage ethylenically unsaturated monomer composition. The acid functional monomer may be present in the first-stage ethylenically unsaturated monomer composition in an amount of 5% to 50% by weight, such as 5% to 40% by weight, such as 5% to 30% by weight, such as 5% to 25% by weight, such as 5% to 20% by weight, such as 10% to 50% by weight, such as 10% to 40% by weight, such as 10% to 30% by weight, such as 10% to 25% by weight, such as 10% to 20% by weight, such as 20% to 50% by weight, such as 20% to 40% by weight, such as 20% to 30% by weight, such as 20% to 25% by weight, based on the total weight of the first-stage ethylenically unsaturated monomer composition.

The first-stage ethylenically unsaturated monomer composition optionally may further comprise at least one of a C₁-C₁₈ alkyl (meth)acrylate; a first-stage hydroxyl-functional (meth)acrylate; a vinyl aromatic compound; and/or a monomer comprising two or more ethylenically unsaturated groups per molecule.

The first-stage ethylenically unsaturated monomer composition optionally may further comprise monoolefinic aliphatic compounds such as C₁-C₁₈ alkyl (meth)acrylates. Examples of suitable C₁-C₁₈ alkyl (meth)acrylates include, without limitation, methyl (meth)acrylate, ethyl (meth)acrylate, butyl (meth)acrylate, hexyl (meth)acrylate, octyl (meth)acrylate, isodecyl (meth)acrylate, stearyl (meth)acrylate, 2-ethylhexyl (meth)acrylate, isobornyl (meth)acrylate, t-butyl (meth)acrylate, and the like. The C₁-C₁₈ alkyl (meth)acrylates may be present in the first-stage ethylenically unsaturated monomer composition in an amount of at least 30% by weight, such as at least 40% by weight, such as at least 50% by weight, such as at least 60% by weight, such as at least 70% by weight, based on the total weight of the first-stage ethylenically unsaturated monomer composition. The C₁-C₁₈ alkyl (meth)acrylates may be present in the first-stage ethylenically unsaturated monomer composition in an amount of no more than 90% by weight, such as no more than 80% by weight, such as no more than 70% by weight, such as no more than 60% by weight, based on the total weight of the first-stage ethylenically unsaturated monomer composition. The C₁-C₁₈ alkyl (meth)acrylates may be present in the first-stage ethylenically unsaturated monomer composition in an amount of 30% to 90% by weight, such as 30% to 80% by weight, such as 30% to 70% by weight, such as 30% to 60% by weight, such as 40% to 90% by weight, such as 40% to 80% by weight, such as 40% to 70% by weight, such as 40% to 60% by weight, such as 50% to 90% by weight, such as 50% to 80% by weight, such as 50% to 70% by weight, such as 50% to 60% by weight, such as 60% to 90% by weight, such as 60% to 80% by weight, such as 60% to 70% by weight, such as 70% to 90% by weight, such as 70% to 80% by weight, based on the total weight of the first-stage ethylenically unsaturated monomer composition. As used herein, “(meth)acrylate” and like terms encompasses both acrylates and methacrylates.

The ethylenically unsaturated monomer composition optionally may comprise a hydroxyl-functional (meth)acrylate. As used herein the term “hydroxyl-functional (meth)acrylate” collectively refers both acrylates and methacrylates, which have hydroxyl functionality, i.e., comprise at least one hydroxyl functional group in the molecule. The hydroxyl-functional (meth)acrylate may comprise a hydroxyalkyl (meth)acrylate, such as, for example, hydroxymethyl (meth)acrylate, hydroxyethyl (meth)acrylate, hydroxypropyl (meth)acrylate, hydroxybutyl (meth)acrylate, hydroxypentyl (meth)acrylate, and the like, as well as combinations thereof. The hydroxyl-functional (meth)acrylate may be present in the first-stage ethylenically unsaturated monomer composition in an amount of at least 1% by weight, such as at least 5% by weight, such as at least 10% by weight, based on the total weight of the first-stage ethylenically unsaturated monomer composition. The hydroxyl-functional (meth)acrylate may be present in the first-stage ethylenically unsaturated monomer composition in an amount of no more than 40% by weight, such as no more than 30% by weight, such as no more than 25% by weight, such as no more than 15% by weight, based on the total weight of the first-stage ethylenically unsaturated monomer composition. The hydroxyl-functional (meth)acrylate may be present in the first-stage ethylenically unsaturated monomer composition in an amount of 1% to 40% by weight, such as 1% to 30% by weight, such as 1% to 25% by weight, such as 1% to 15% by weight, such as 5% to 40% by weight, such as 5% to 30% by weight, such as 5% to 25% by weight, such as 5% to 15% by weight, such as 10% to 40% by weight, such as 10% to 30% by weight, such as 10% to 25% by weight, such as 10% to 15% by weight, based on the total weight of the first-stage ethylenically unsaturated monomer composition.

The first-stage ethylenically unsaturated monomer composition may comprise a vinyl aromatic compound. Non-limiting examples of suitable vinyl aromatic compounds include styrene, alpha-methyl styrene, alpha-chloromethyl styrene and/or vinyl toluene. The vinyl aromatic compound may be present in the first-stage ethylenically unsaturated monomer composition in an amount of at least 0.5% by weight, such as at least 1% by weight, such as at least 5% by weight, such as at least 10% by weight, based on the total weight of the first-stage ethylenically unsaturated monomer composition. The vinyl aromatic compound may be present in the first-stage ethylenically unsaturated monomer composition in an amount of no more than 40% by weight, such as no more than 30% by weight, such as no more than 20% by weight, such as no more than 15% by weight, such as no more than 10% by weight, based on the total weight of the first-stage ethylenically unsaturated monomer composition. The vinyl aromatic compound may be present in the first-stage ethylenically unsaturated monomer composition in an amount of 0.5% to 40% by weight, such as 0.5% to 30% by weight, such as 0.5% to 20% by weight, such as 0.5% to 15% by weight, such as 0.5% to 10% by weight, such as 1% to 40% by weight, such as 1% to 30% by weight, such as 1% to 20% by weight, such as 1% to 15% by weight, such as 1% to 10% by weight, such as 5% to 40% by weight, such as 5% to 30% by weight, such as 5% to 20% by weight, such as 5% to 15% by weight, such as 5% to 10% by weight, such as 10% to 40% by weight, such as 10% to 30% by weight, such as 10% to 20% by weight, such as 10% to 15% by weight, based on the total weight of the first-stage ethylenically unsaturated monomer composition.

The first-stage ethylenically unsaturated monomer composition optionally may comprise a monomer comprising two or more ethylenically unsaturated groups per molecule. The monomer comprising two or more ethylenically unsaturated groups per molecule may comprise a monomer having two ethylenically unsaturated groups per molecule. Examples of suitable monomers having two ethylenically unsaturated groups per molecule include ethylene glycol dimethacrylate, allyl methacrylate, hexanediol diacrylate, methacrylic anhydride, tetraethylene glycol diacrylate, and/or tripropylene glycol diacrylate. Examples of monomers having three or more ethylenically unsaturated groups per molecule include ethoxylated trimethylolpropane triacrylate having 0 to 20 ethoxy units, [ethoxylated] trimethylolpropane trimethacrylate having 0 to 20 ethoxy units, di-pentaerythritoltriacrylate, pentaerythritol tetraacrylate, and/or di-pentaerythritolpentaacrylate. The monomer comprising two or more ethylenically unsaturated groups per molecule may be present in the first-stage ethylenically unsaturated monomer composition in an amount of at least 0.1% by weight, such as at least 1% by weight, such as at least 3% by weight, such as at least 5% by weight, based on the total weight of the first-stage ethylenically unsaturated monomer composition. The monomer comprising two or more ethylenically unsaturated groups per molecule may be present in the first-stage ethylenically unsaturated monomer composition in an amount of no more than 10% by weight, such as no more than 5% by weight, such as no more than 3% by weight, based on the total weight of the first-stage ethylenically unsaturated monomer composition. The monomer comprising two or more ethylenically unsaturated groups per molecule may be present in the first-stage ethylenically unsaturated monomer composition in an amount of 0.1% to 10% by weight, such as 0.1% to 5% by weight, such as 0.1% to 3% by weight, such as 1% to 10% by weight, such as 1% to 5% by weight, such as 1% to 3% by weight, such as 3% to 10% by weight, such as 3% to 5% by weight, such as 5% to 10% by weight, based on the total weight of the first-stage ethylenically unsaturated monomer composition. The use of a monomer comprising two or more ethylenically unsaturated groups per molecule in the first-stage ethylenically unsaturated monomer composition may result in a polymeric dispersant comprising ethylenically unsaturated groups. Accordingly, the polymeric dispersant may comprise ethylenically unsaturated groups.

The first-stage ethylenically unsaturated monomer composition may comprise a first-stage (meth)acrylamide monomer. As used herein, the term “first-stage” with respect to a monomer, such as the (meth)acrylamide monomers, is intended to refer to a monomer used during the polymerization of the polymeric dispersant, and the resulting polymeric dispersant comprises the residue thereof. As used herein, the term “(meth)acrylamide” and like terms encompasses both acrylamides and methacrylamides. The first-stage (meth)acrylamide monomers may comprise any suitable (meth)acrylamide monomer such as, for example, (meth)acrylamide, substituted or unsubstituted monoalkyl (meth)acrylamide monomers, or substituted or unsubstituted dialkyl (meth)acrylamide monomers. Non-limiting examples of the first-stage (meth)acrylamide monomers include (meth)acrylamide, a C₁-C₁₈ alkyl (meth)acrylamide monomer, a hydroxyl-functional (meth)acrylamide monomer, and the like.

The first-stage (meth)acrylamide monomers of the first-stage ethylenically unsaturated monomer composition optionally may comprise a C₁-C₁₈ alkyl (meth)acrylamide monomer. Examples of suitable C₁-C₁₈ alkyl (meth)acrylamide monomers include, without limitation, methyl (meth)acrylamide, ethyl (meth)acrylamide, butyl (meth)acrylamide, hexyl (meth)acrylamide, octyl (meth)acrylamide, isodecyl (meth)acrylamide, stearyl (meth)acrylamide, 2-ethylhexyl (meth)acrylamide, isobornyl (meth)acrylamide, t-butyl (meth)acrylamide, and the like. The C₁-C₁₈ alkyl (meth)acrylamide monomer may be present in the first-stage ethylenically unsaturated monomer composition in an amount of at least 30% by weight, such as at least 40% by weight, such as at least 50% by weight, such as at least 60% by weight, such as at least 70% by weight, based on the total weight of the first-stage ethylenically unsaturated monomer composition. The C₁-C₁₈ alkyl (meth)acrylamide monomer may be present in the first-stage ethylenically unsaturated monomer composition in an amount of no more than 90% by weight, such as no more than 80% by weight, such as no more than 70% by weight, such as no more than 60% by weight, based on the total weight of the first-stage ethylenically unsaturated monomer composition. The C₁-C₁₈ alkyl (meth)acrylamide monomer may be present in the first-stage ethylenically unsaturated monomer composition in an amount of 30% to 90% by weight, such as 30% to 80% by weight, such as 30% to 70% by weight, such as 30% to 60% by weight, such as 40% to 90% by weight, such as 40% to 80% by weight, such as 40% to 70% by weight, such as 40% to 60% by weight, such as 50% to 90% by weight, such as 50% to 80% by weight, such as 50% to 70% by weight, such as 50% to 60% by weight, such as 60% to 90% by weight, such as 60% to 80% by weight, such as 60% to 70% by weight, such as 70% to 90% by weight, such as 70% to 80% by weight, based on the total weight of the first-stage ethylenically unsaturated monomer composition.

The ethylenically unsaturated monomer composition optionally may comprise a first-stage hydroxyl-functional (meth)acrylamide monomer. As used herein the term “hydroxyl-functional (meth)acrylamide” collectively refers both acrylamides and methacrylamides, which have hydroxyl functionality, i.e., comprise at least one hydroxyl functional group in the molecule. The first-stage hydroxyl-functional (meth)acrylamide monomer may comprise a hydroxyalkyl (meth)acrylamide, such as, for example, hydroxymethyl (meth)acrylamide, hydroxyethyl (meth)acrylamide, hydroxypropyl (meth)acrylamide, 2-hydroxypropyl (meth)acrylamide, hydroxybutyl (meth)acrylamide, hydroxypentyl (meth)acrylamide, and the like, as well as combinations thereof. The first-stage hydroxyl-functional (meth)acrylamide monomer may be present in the first-stage ethylenically unsaturated monomer composition in an amount of at least 1% by weight, such as at least 5% by weight, such as at least 10% by weight, based on the total weight of the first-stage ethylenically unsaturated monomer composition. The first-stage hydroxyl-functional (meth)acrylamide monomer may be present in the first-stage ethylenically unsaturated monomer composition in an amount of no more than 40% by weight, such as no more than 30% by weight, such as no more than 25% by weight, such as no more than 15% by weight, based on the total weight of the first-stage ethylenically unsaturated monomer composition. The first-stage hydroxyl-functional (meth)acrylamide monomer may be present in the first-stage ethylenically unsaturated monomer composition in an amount of 1% to 40% by weight, such as 1% to 30% by weight, such as 1% to 25% by weight, such as 1% to 15% by weight, such as 5% to 40% by weight, such as 5% to 30% by weight, such as 5% to 25% by weight, such as 5% to 15% by weight, such as 10% to 40% by weight, such as 10% to 30% by weight, such as 10% to 25% by weight, such as 10% to 15% by weight, based on the total weight of the first-stage ethylenically unsaturated monomer composition.

The first-stage ethylenically unsaturated monomer composition may comprise, consist essentially of, or consist of an epoxide functional ethylenically unsaturated monomer, and may optionally further comprise, consist essentially of, or consist of at least one of an amino functional unsaturated monomer, a C₁-C₁₈ alkyl (meth)acrylate, a hydroxyl-functional (meth)acrylate, a vinyl aromatic compound, and a monomer comprising two or more ethylenically unsaturated groups per molecule. Accordingly, the polymeric dispersant may comprise, consist essentially of, or consist of the residue of an epoxide functional ethylenically unsaturated monomer, and may optionally further comprise, consist essentially of, or consist of the residue of at least one of an amino functional unsaturated monomer, a C₁-C₁₈ alkyl (meth)acrylate, a hydroxyl-functional (meth)acrylate, a vinyl aromatic compound, an epoxide functional ethylenically unsaturated monomer, and/or a monomer comprising two or more ethylenically unsaturated groups per molecule. The polymeric dispersant may further comprise any amine incorporated into the polymeric dispersant through reaction with an epoxide functional group.

The first-stage ethylenically unsaturated monomer composition may comprise, consist essentially of, or consist of an amino functional unsaturated monomer, and may further comprise, consist essentially of, or consist of at least one of a C₁-C₁₈ alkyl (meth)acrylate, a hydroxyl-functional (meth)acrylate, a vinyl aromatic compound, an epoxide functional ethylenically unsaturated monomer, and/or a monomer comprising two or more ethylenically unsaturated groups per molecule. Accordingly, the polymeric dispersant may comprise, consist essentially of, or consist of the residue of an amino functional unsaturated monomer, and may further comprise, consist essentially of, or consist of the residue of at least one of a C₁-C₁₈ alkyl (meth)acrylate, a hydroxyl-functional (meth)acrylate, a vinyl aromatic compound, an epoxide functional ethylenically unsaturated monomer, and/or a monomer comprising two or more ethylenically unsaturated groups per molecule. The polymeric dispersant may further comprise any amine incorporated into the polymeric dispersant through reaction with an epoxide functional group (if present).

The first-stage ethylenically unsaturated monomer composition may comprise, consist essentially of, or consist of an acid-functional ethylenically unsaturated monomer, and may optionally further comprise, consist essentially of, or consist of at least one of a C₁-C₁₈ alkyl (meth)acrylate, a hydroxyl-functional (meth)acrylate, a vinyl aromatic compound, and/or a monomer comprising two or more ethylenically unsaturated groups per molecule. Accordingly, the polymeric dispersant may comprise, consist essentially of, or consist of the residue of an acid-functional ethylenically unsaturated monomer, and may optionally further comprise, consist essentially of, or consist of the residue of at least one of a C₁-C₁₈ alkyl (meth)acrylate, a hydroxyl-functional (meth)acrylate, a vinyl aromatic compound, an acid-functional ethylenically unsaturated monomer, and/or a monomer comprising two or more ethylenically unsaturated groups per molecule.

The polymeric dispersant may be prepared in organic solution by techniques well known in the art. For example, the polymeric dispersant may be prepared by conventional free radical initiated solution polymerization techniques wherein the first-stage ethylenically unsaturated monomer composition is dissolved in a solvent or a mixture of solvents and polymerized in the presence of a free radical initiator. Examples of suitable solvents which may be used for organic solution polymerization include alcohols, such as ethanol, tertiary butanol, and tertiary amyl alcohol; ketones, such as acetone, methyl ethyl ketone; and ethers, such as dimethyl ether of ethylene glycol. Examples of suitable free radical initiators include those which are soluble in the mixture of monomers, such as azobisisobutyronitrile, 2,2′-azobis(2-methylbutyronitrile), azobis-(alpha, gamma-dimethylvaleronitrile), tertiary-butyl perbenzoate, tertiary-butyl peracetate, benzoyl peroxide, and ditertiary-butyl peroxide. The free radical initiator may be present in an amount of 0.01% to 6% by weight, such as 1.0% to 4.0% by weight, such as 2.0% to 3.5% by weight, based on the total weight of the first-stage ethylenically unsaturated monomer composition. In examples, the solvent may be first heated to reflux and a mixture of the first-stage ethylenically unsaturated monomer composition and a free radical initiator may be added slowly to the refluxing solvent. The reaction mixture may be held at polymerizing temperatures so as to reduce the free monomer content to below 1.0%, such as below 0.5% by weight, based on the total weight of the first-stage ethylenically unsaturated monomer composition.

A chain transfer agent may be used in the synthesis of the polymeric dispersant, such as those that are soluble in the mixture of monomers. Suitable non-limiting examples of such agents include alkyl mercaptans, for example, tertiary-dodecyl mercaptan; ketones, such as methyl ethyl ketone; and chlorohydrocarbons, such as chloroform.

The polymeric dispersant may have a z-average molecular weight (M_{z}) of at least 200,000 g/mol, such as at least 250,000 g/mol, such as at least 300,000 g/mol, and may be no more than 2,000,000 g/mol, such as no more than 1,200,000 g/mol, such as no more than 900,000. The polymeric dispersant may have a z-average molecular weight (M_{z}) of 200,000 g/mol to 2,000,000 g/mol, such as 200,000 g/mol to 1,200,000 g/mol, such as 200,000 g/mol to 900,000 g/mol, such as 250,000 g/mol to 2,000,000 g/mol, such as 250,000 g/mol to 1,200,000 g/mol, such as 250,000 g/mol to 900,000 g/mol, such as 300,000 to 2,000,000 g/mol, such as 300,000 g/mol to 1,200,000 g/mol, such as 300,000 g/mol to 900,000 g/mol.

The polymeric dispersant may have a weight average molecular weight of 150,000 g/mol to 750,000 g/mol, such as 150,000 g/mol to 400,000 g/mol, such as 150,000 g/mol to 300,000 g/mol, such as 175,000 g/mol to 750,000 g/mol, such as 175,000 g/mol to 400,000 g/mol, such as 175,000 g/mol to 300,000 g/mol, such as 200,000 g/mol to 750,000 g/mol, such as 200,000 g/mol to 400,000 g/mol, such as 200,000 g/mol to 300,000 g/mol.

Ionic groups in the polymeric dispersant may be formed by at least partially neutralizing basic or acidic groups present in the polymeric dispersant with an acid or base, respectively. The ionic groups in the polymeric molecules may be charge neutralized by counter-ions. Ionic groups and charge neutralizing counter-ions may together form salt groups, such that the polymeric dispersant comprises an ionic salt group-containing polymeric dispersant.

Accordingly, the polymeric dispersant may be, prior to or during dispersion in a dispersing medium comprising water, at least partially neutralized by, for example, treating with an acid to form a water-dispersible cationic salt group-containing polymeric dispersant. As used herein, the term “cationic salt group-containing polymeric dispersant” refers to a cationic polymeric dispersant comprising at least partially neutralized cationic functional groups, such as sulfonium groups and ammonium groups, that impart a positive charge. Non-limiting examples of suitable acids are inorganic acids, such as phosphoric acid and sulfamic acid, as well as organic acids, such as, acetic acid and lactic acid, among others. Besides acids, salts such as dimethylhydroxyethylammonium dihydrogenphosphate and ammonium dihydrogenphosphate may be used to at least partially neutralize the polymeric dispersant. The polymeric dispersant may be neutralized to the extent of at least 50%, such as at least 70% of the total theoretical neutralization equivalent. As used herein, the “total theoretical neutralization equivalent” refers to a percentage of the stoichiometric amount of acid to the total amount of basic groups, such as amino groups, theoretically present on the polymer. As discussed above, amines may be incorporated into the cationic polymeric dispersant by reaction of an amine with epoxide functional groups present in the polymeric dispersant. The step of dispersion may be accomplished by combining the neutralized or partially neutralized cationic salt group-containing polymeric dispersant with the dispersing medium of the dispersing phase. Neutralization and dispersion may also be accomplished in one step by combining the polymeric dispersant and the dispersing medium. The polymeric dispersant (or its salt) may be added to the dispersing medium or the dispersing medium may be added to the polymeric dispersant (or its salt). The pH of the dispersion may be within the range of 5 to 9.

The cationic salt group-containing polymeric dispersant may comprise a sufficient cationic salt group content to stabilize a subsequent polymerization of a second-stage ethylenically unsaturated monomer composition (described below) and to provide for a resulting addition polymer that is stable in a cationic electrodepositable coating composition. Also, the cationic salt group-containing polymeric dispersant may have sufficient cationic salt group content so that, when used with the other film-forming resins in the cationic electrodepositable coating composition, the composition upon being subjected to electrodeposition conditions will deposit as a coating on the substrate. The cationic salt group-containing polymeric dispersant may comprise, for example, 0.1 to 5.0, such as 0.3 to 1.1 milliequivalents of cationic salt groups per gram of cationic salt group-containing polymeric dispersant.

The polymeric dispersant may be, prior to or during dispersion in a dispersing medium comprising water, at least partially neutralized by, for example, treating with a base to form a water-dispersible anionic salt group-containing polymeric dispersant. As used herein, the term “anionic salt group-containing polymeric dispersant” refers to an anionic polymeric dispersant comprising at least partially neutralized anionic functional groups, such as carboxylic acid and phosphoric acid groups, that impart a negative charge. Non-limiting examples of suitable bases are amines, such as, for example, tertiary amines. Specific examples of suitable amines include, but are not limited to, trialkylamines and dialkylalkoxyamines, such as triethylamine, diethylethanol amine and dimethylethanolamine. The polymeric dispersant may be neutralized to the extent of at least 50 percent or, in some cases, at least 70 percent, or, in other cases 100 percent or more, of the total theoretical neutralization equivalent. The step of dispersion may be accomplished by combining the neutralized or partially neutralized anionic salt group-containing polymeric dispersant with the dispersing medium of the dispersing phase. Neutralization and dispersion may be accomplished in one step by combining the polymeric dispersant and the dispersing medium. The polymeric dispersant (or its salt) may be added to the dispersing medium or the dispersing medium may be added to the polymeric dispersant (or its salt). The pH of the dispersion may be within the range of 5 to 9.

The anionic salt group-containing polymeric dispersant may comprise a sufficient anionic salt group content to stabilize a subsequent polymerization of a second-stage ethylenically unsaturated monomer composition (described below) and to provide for a resulting addition polymer that is stable in an anionic electrodepositable coating composition. Also, the anionic salt group-containing polymeric dispersant may have sufficient anionic salt group content so that, when used with the other film-forming resins in the anionic electrodepositable coating composition, the composition upon being subjected to anionic electrodeposition conditions will deposit as a coating on the substrate. The anionic salt group-containing polymeric dispersant may contain from 0.1 to 5.0, such as 0.3 to 1.1 milliequivalents of anionic salt groups per gram of anionic salt group-containing polymeric dispersant.

The second-stage ethylenically unsaturated monomer composition comprises, consists essentially of, or consists of a monomer comprising three or more ethylenically unsaturated groups per molecule and at least one other monomer comprising a C₁-C₁₈ alkyl (meth)acrylate, a hydroxyl-functional (meth)acrylate, a vinyl aromatic compound, or any combination thereof. The second-stage ethylenically unsaturated monomer composition may be substantially free or, in some case, completely free, of diene monomers. As used herein, when it is stated that the second-stage ethylenically unsaturated monomer composition is “substantially free” of diene monomers, it means that diene monomers are present in the monomer composition, if at all, in an amount of less than 10% by weight, such as less than 5% by weight, less than 2% by weight, or, in some cases, less than 1% or 0.1% by weight, based on the total weight of the second-stage ethylenically unsaturated monomer composition.

Non-limiting examples of monomers comprising three or more ethylenically unsaturated groups per molecule include, for example, trimethylolpropane triacrylate, pentaerythritol tetraacrylate, di-pentaerythritoltriacrylate, di-pentaerythritolpentaacrylate, ethoxylated trimethylolpropane triacrylate having 0 to 20 ethoxy units, and ethoxylated trimethylolpropane trimethacrylate having 0 to 20 ethoxy units. The ethylenically unsaturated monomer(s) having three or more sites of unsaturation are used in amounts of 0.1 to 10% by weight, such as 0.1 to 5% by weight, based on the total weight of the second-stage ethylenically unsaturated monomer composition.

The second-stage ethylenically unsaturated monomer composition may comprise the C₁-C₁₈ alkyl (meth)acrylate(s), if at all, in an amount of 20% to 80% by weight, such as 20% to 60% by weight, based on total weight of the second-stage ethylenically unsaturated monomer composition.

The second-stage ethylenically unsaturated monomer composition may comprise hydroxyl-functional (meth)acrylates, if at all, in an amount of 5% to 20% by weight, such as 5% to 15% by weight, based on total weight of the second-stage ethylenically unsaturated monomer composition.

The second-stage ethylenically unsaturated monomer composition may comprise vinyl aromatic compounds, if at all, in an amount of 20% to 80% by weight, such as 20% to 60% by weight, based on total weight of the second-stage ethylenically unsaturated monomer composition.

The second-stage ethylenically unsaturated monomer composition comprises, consists essentially of, or consists of one or more second-stage (meth)acrylamide monomers. As used herein, the term “second-stage” with respect to a monomer, such as the (meth)acrylamide monomers, is intended to refer to a monomer used during the second polymerization step of the addition polymer that is polymerized in the presence of the pre-formed polymeric dispersant, and the resulting addition polymer comprises the residue thereof. The (meth)acrylamide monomers may comprise any suitable (meth)acrylamide monomer such as, for example, (meth)acrylamide, substituted or unsubstituted monoalkyl (meth)acrylamides, or substituted or unsubstituted dialkyl (meth)acrylamides. Non-limiting examples include (meth)acrylamide, a C₁-C₁₈ alkyl (meth)acrylamide, a hydroxyl-functional (meth)acrylamide, and the like.

The second-stage ethylenically unsaturated monomer composition may comprise, consist essentially of, or consist of (meth)acrylamide, such as (meth)acrylamide or acrylamide. The (meth)acrylamide monomer may be present in the second-stage ethylenically unsaturated monomer composition in an amount of at least 20% by weight, such as at least 30% by weight, such as at least 40% by weight, such as at least 50% by weight, such as at least 60% by weight, such as at least 70% by weight, such at least 80% by weight, such as at least 90% by weight, such as at least 95% by weight, such as at least 99% by weight, such as 100% by weight, based on the total weight of the second-stage ethylenically unsaturated monomer composition. The (meth)acrylamide monomer may be present in the second-stage ethylenically unsaturated monomer composition in an amount of no more than 99% by weight, such as no more than 90% by weight, such as no more than 80% by weight, such as no more than 70% by weight, such as no more than 60% by weight, such as no more than 50% by weight, based on the total weight of the second-stage ethylenically unsaturated monomer composition. The (meth)acrylamide monomer may be present in the second-stage ethylenically unsaturated monomer composition in an amount of 20% to 100% by weight, such as 20% to 99% by weight, such as 20% to 90% by weight, such as 20% to 80% by weight, such as 20% to 70% by weight, such as 20% to 60% by weight, such as 20% to 50% by weight, such as 30% to 100% by weight, such as 30% to 99% by weight, such as 30% to 90% by weight, such as 30% to 80% by weight, such as 30% to 70% by weight, such as 30% to 60% by weight, such as 30% to 50% by weight, such as 40% to 100% by weight, such as 40% to 99% by weight, such as 40% to 90% by weight, such as 40% to 80% by weight, such as 40% to 70% by weight, such as 40% to 60% by weight, such as 40% to 50% by weight, such as 50% to 100% by weight, such as 50% to 99% by weight, such as 50% to 90% by weight, such as 50% to 80% by weight, such as 50% to 70% by weight, such as 50% to 60% by weight, such as 60% to 100% by weight, such as 60% to 99% by weight, such as 60% to 90% by weight, such as 60% to 80% by weight, such as 60% to 70% by weight, such as 70% to 100% by weight, such as 70% to 99% by weight, such as 70% to 90% by weight, such as 70% to 80% by weight, such as 80% to 100% by weight, such as 80% to 99% by weight, such as 80% to 90% by weight, such as 90% to 100% by weight, such as 90% to 99% by weight, such as 95% to 100% by weight, such as 95% to 99% by weight, such as 95% to 100% by weight, such as 95% to 99% by weight, based on the total weight of the second-stage ethylenically unsaturated monomer composition.

The second-stage ethylenically unsaturated monomer composition may comprise, consist essentially of, or consist of a second-stage hydroxyl-functional (meth)acrylamide monomer. The second-stage hydroxyl-functional (meth)acrylamide monomer may comprise a primary hydroxyl group. The second-stage hydroxyl-functional (meth)acrylamide monomer may comprise a secondary hydroxyl group. The second-stage hydroxyl-functional (meth)acrylamide monomer may comprise one or more of a C₁-C₉ hydroxyalkyl (meth)acrylamide, such as a C₁-C₆ hydroxyalkyl (meth)acrylamide, such as a C₁-C₅ hydroxyalkyl (meth)acrylamide such as, for example, hydroxymethyl (meth)acrylamide, hydroxyethyl (meth)acrylamide, hydroxypropyl (meth)acrylamide, 2-hydroxypropyl (meth)acrylamide, hydroxybutyl (meth)acrylamide, hydroxypentyl (meth)acrylamide, or any combination thereof.

The second-stage hydroxyl-functional (meth)acrylamide monomer may be present in the second-stage ethylenically unsaturated monomer composition in an amount of at least 20% by weight, such as at least 30% by weight, such as at least 40% by weight, such as at least 50% by weight, such as at least 60% by weight, such as at least 70% by weight, such at least 80% by weight, such as at least 90% by weight, such as at least 95% by weight, such as at least 99% by weight, such as 100% by weight, based on the total weight of the second-stage ethylenically unsaturated monomer composition. The second-stage hydroxyl-functional (meth)acrylamide monomer may be present in the second-stage ethylenically unsaturated monomer composition in an amount of no more than 99% by weight, such as no more than 90% by weight, such as no more than 80% by weight, such as no more than 70% by weight, such as no more than 60% by weight, such as no more than 50% by weight, based on the total weight of the second-stage ethylenically unsaturated monomer composition. The second-stage hydroxyl-functional (meth)acrylamide monomer may be present in the second-stage ethylenically unsaturated monomer composition in an amount of 20% to 100% by weight, such as 20% to 99% by weight, such as 20% to 90% by weight, such as 20% to 80% by weight, such as 20% to 70% by weight, such as 20% to 60% by weight, such as 20% to 50% by weight, such as 30% to 100% by weight, such as 30% to 99% by weight, such as 30% to 90% by weight, such as 30% to 80% by weight, such as 30% to 70% by weight, such as 30% to 60% by weight, such as 30% to 50% by weight, such as 40% to 100% by weight, such as 40% to 99% by weight, such as 40% to 90% by weight, such as 40% to 80% by weight, such as 40% to 70% by weight, such as 40% to 60% by weight, such as 40% to 50% by weight, such as 50% to 100% by weight, such as 50% to 99% by weight, such as 50% to 90% by weight, such as 50% to 80% by weight, such as 50% to 70% by weight, such as 50% to 60% by weight, such as 60% to 100% by weight, such as 60% to 99% by weight, such as 60% to 90% by weight, such as 60% to 80% by weight, such as 60% to 70% by weight, such as 70% to 100% by weight, such as 70% to 99% by weight, such as 70% to 90% by weight, such as 70% to 80% by weight, such as 80% to 100% by weight, such as 80% to 99% by weight, such as 80% to 90% by weight, such as 90% to 100% by weight, such as 90% to 99% by weight, such as 95% to 100% by weight, such as 95% to 99% by weight, such as 95% to 100% by weight, such as 95% to 99% by weight, based on the total weight of the second-stage ethylenically unsaturated monomer composition.

The second-stage ethylenically unsaturated monomer composition may optionally further comprise a phosphorous acid-functional ethylenically unsaturated monomer. The phosphorous acid group may comprise a phosphonic acid group, a phosphinic acid group, or combinations thereof, as well as salts thereof. The phosphorous acid-functional ethylenically unsaturated monomer may be dihydrogen phosphate esters of an alcohol in which the alcohol contains or is substituted with a polymerizable vinyl or olefinic group. Suitable phosphorous acid-functional ethylenically unsaturated monomer may include phosphoalkyl (meth)acrylates such as phosphoethyl (meth)acrylate, phosphopropyl (meth)acrylate, phosphobutyl (meth)acrylate, salts of phosphoalkyl (meth)acrylates, and mixtures thereof; CH₂═C(R)—C(O)—O—(RₚO)ₙ—P(O)(OH)₂, wherein R═H or CH₃ and Rₚ=alkyl, n is from 1 to 20, such as SIPOMER PAM-100, SIPOMER PAM-200, SIPOMER PAM-300, and SIPOMER PAM-4000 all available from Solvay; phosphoalkoxy (meth)acrylates such as phospho ethylene glycol (meth)acrylate, phospho di-ethylene glycol (meth)acrylate, phospho tri-ethylene glycol (meth)acrylate, phospho propylene glycol (meth)acrylate, phospho dipropylene glycol (meth)acrylate, phospho tri-propylene glycol (meth)acrylate, salts thereof, and mixtures thereof. The phosphorous acid-functional ethylenically unsaturated monomer may be present in the second-stage ethylenically unsaturated monomer composition in an amount of at least 0.1% by weight, such as at least 0.5% by weight, such as at least 1% by weight, such as at least 1.5% by weight, based on the total weight of the second-stage ethylenically unsaturated monomer composition. The phosphorous acid-functional ethylenically unsaturated monomer may be present in the second-stage ethylenically unsaturated monomer composition in an amount of no more than 20% by weight, such as no more than 10% by weight, such as no more than 4% by weight, such as no more than 2.5% by weight, based on the total weight of the second-stage ethylenically unsaturated monomer composition. The phosphorous acid-functional ethylenically unsaturated monomer may be present in the second-stage ethylenically unsaturated monomer composition in an amount of 0.1% to 20% by weight, such as 0.1% to 10% by weight, such as 0.1% to 4% by weight, such as 0.1% to 2.5% by weight, such as 0.5% to 20% by weight, such as 0.5% to 10% by weight, such as 0.5% to 4% by weight, such as 0.5% to 2.5% by weight, such as 1% to 20% by weight, such as 1% to 10% by weight, such as 1% to 4% by weight, such as 1% to 2.5% by weight, such as 1.5% to 20% by weight, such as 1.5% to 10% by weight, such as 1.5% to 4% by weight, such as 1.5% to 2.5% by weight, based on the total weight of the second-stage ethylenically unsaturated monomer composition.

The second-stage ethylenically unsaturated monomer composition may optionally comprise other ethylenically unsaturated monomers. The other ethylenically unsaturated monomers may comprise any ethylenically unsaturated monomers known in the art. Examples of other ethylenically unsaturated monomers that may be used in the second-stage ethylenically unsaturated monomer composition include, without limitation, the monomers described above with respect to the preparation of the polymeric dispersant, as well as di(meth)acrylates and poly(ethylene glycol) (meth)acrylates. Such monomers may be present, if at all, in an amount of 1% to 80% by weight, such as 1% to 70% by weight, such as 1% to 60% by weight, such as 1% to 50% by weight, such as 1% to 40% by weight, such as 1% to 30% by weight, such as 1% to 20% by weight, such as 1% to 10% by weight, such as 1% to 5% by weight, such as 5% to 80% by weight, such as 5% to 70% by weight, such as 5% to 60% by weight, such as 5% to 50% by weight, such as 5% to 40% by weight, such as 5% to 30% by weight, such as 5% to 20% by weight, such as 5% to 10% by weight, such as 10% to 80% by weight, such as 10% to 70% by weight, such as 10% to 60% by weight, such as 10% to 50% by weight, such as 10% to 40% by weight, such as 10% to 30% by weight, such as 10% to 20% by weight, such as 20% to 80% by weight, such as 20% to 70% by weight, such as 20% to 60% by weight, such as 20% to 50% by weight, such as 20% to 40% by weight, such as 20% to 30% by weight, such as 30% to 80% by weight, such as 30% to 70% by weight, such as 30% to 60% by weight, such as 30% to 50% by weight, such as 30% to 40% by weight, based on the total weight of the second-stage ethylenically unsaturated monomer composition.

The addition polymer may comprise a polymerization product comprising at least 10% by weight of the residue of the polymeric dispersant, such as at least 20% by weight, such as at least 30% by weight, such as at least 40% by weight, such as at least 50% by weight, such as at least 60% by weight, such as at least 70% by weight, such as at least 80% by weight, the percent by weight being based on the total weight of the addition polymer. The addition polymer may comprise a polymerization product comprising no more than 90% by weight of the residue of the polymeric dispersant, such as no more than 80% by weight, such as no more than 70% by weight, such as no more than 60% by weight, such as no more than 50% by weight, such as no more than 40% by weight, such as no more than 30% by weight, such as no more than 20% by weight, the percent by weight being based on the total weight of the addition polymer. The addition polymer may comprise a polymerization product comprising 10% to 90% by weight of the residue of the polymeric dispersant, such as 10% to 80% by weight, such as 10% to 70% by weight, such as 10% to 60% by weight, such as 10% to 50% by weight, such as 10% to 40% by weight, such as 10% to 30% by weight, such as 10% to 20% by weight, such as 20% to 90% by weight, such as 20% to 80% by weight, such as 20% to 70% by weight, such as 20% to 60% by weight, such as 20% to 50% by weight, such as 20% to 40% by weight, such as 20% to 30% by weight, such as 30% to 90% by weight, such as 30% to 80% by weight, such as 30% to 70% by weight, such as 30% to 60% by weight, such as 30% to 50% by weight, such as 30% to 40% by weight, such as 40% to 90% by weight, such as 40% to 80% by weight, such as 40% to 70% by weight, such as 40% to 60% by weight, such as 40% to 50% by weight, such as 50% to 90% by weight, such as 50% to 80% by weight, such as 50% to 70% by weight, such as 50% to 60% by weight, such as 60% to 90% by weight, such as 60% to 80% by weight, such as 60% to 70% by weight, such as 70% to 90% by weight, such as 70% to 80% by weight, such as 80% to 90% by weight, the percent by weight being based on the total weight of the addition polymer.

The addition polymer may comprise a polymerization product comprising at least 10% by weight of the residue of the second-stage ethylenically unsaturated monomer composition, such as at least 20% by weight, such as at least 30% by weight, such as at least 40% by weight, such as at least 50% by weight, such as at least 60% by weight, such as at least 70% by weight, such as at least 80% by weight, the percent by weight being based on the total weight of the addition polymer. The addition polymer may comprise a polymerization product comprising no more than 90% by weight of the residue of the second-stage ethylenically unsaturated monomer composition, such as no more than 80% by weight, such as no more than 70% by weight, such as no more than 60% by weight, such as no more than 50% by weight, such as no more than 40% by weight, such as no more than 30% by weight, such as no more than 20% by weight, the percent by weight being based on the total weight of the addition polymer. The addition polymer may comprise a polymerization product comprising 10% to 90% by weight of the residue of the second-stage ethylenically unsaturated monomer composition, such as 10% to 80% by weight, such as 10% to 70% by weight, such as 10% to 60% by weight, such as 10% to 50% by weight, such as 10% to 40% by weight, such as 10% to 30% by weight, such as 10% to 20% by weight, such as 20% to 90% by weight, such as 20% to 80% by weight, such as 20% to 70% by weight, such as 20% to 60% by weight, such as 20% to 50% by weight, such as 20% to 40% by weight, such as 20% to 30% by weight, such as 30% to 90% by weight, such as 30% to 80% by weight, such as 30% to 70% by weight, such as 30% to 60% by weight, such as 30% to 50% by weight, such as 30% to 40% by weight, such as 40% to 90% by weight, such as 40% to 80% by weight, such as 40% to 70% by weight, such as 40% to 60% by weight, such as 40% to 50% by weight, such as 50% to 90% by weight, such as 50% to 80% by weight, such as 50% to 70% by weight, such as 50% to 60% by weight, such as 60% to 90% by weight, such as 60% to 80% by weight, such as 60% to 70% by weight, such as 70% to 90% by weight, such as 70% to 80% by weight, such as 80% to 90% by weight, the percent by weight being based on the total weight of the addition polymer.

The addition polymer may comprise a polymerization product of the polymeric dispersant and the second-stage ethylenically unsaturated monomer composition wherein the weight ratio of the second-stage ethylenically unsaturated monomer composition to the polymeric dispersant may be 9:1 to 1:9, such as 9:1 to 1:4, such as 9:1 to 3:7, such as 9:1 to 2:3, such as 9:1 to 1:1, such as 9:1 to 3:2, such as 9:1 to 7:3, such as 9:1 to 4:1, such as 4:1 to 1:9, such as 4:1 to 1:4, such as 4:1 to 3:7, such as 4:1 to 2:3, such as 4:1 to 1:1, such as 4:1 to 3:2, such as 4:1 to 7:3, such as 4:1 to 9:1, such as 7:3 to 1:9, such as 7:3 to 1:4, such as 7:3 to 3:7, such as 7:3 to 2:3, such as 7:3 to 1:1, such as 7:3 to 3:2, such as 7:3 to 4:1, such as 7:3 to 9:1, such as 3:2 to 1:9, such as 3:2 to 1:4, such as 3:2 to 3:7, such as 3:2 to 2:3, such as 3:2 to 1:1, such as 3:2 to 7:3, such as 3:2 to 4:1, such as 3:2 to 9:1, such as 1:1 to 1:9, such as 1:1 to 1:4, such as 1:1 to 3:7, such as 1:1 to 2:3, such as 1:1 to 3:2, such as 1:1 to 7:3, such as 1:1 to 4:1, such as 1:1 to 9:1, such as 2:3 to 1:9, such as 2:3 to 1:4, such as 2:3 to 3:7, such as 2:3 to 1:1, such as 2:3 to 3:2, such as 9:1 to 7:3, such as 2:3 to 4:1, such as 2:3 to 9:1, such as 3:7 to 1:9, such as 3:7 to 1:4, such as 3:7 to 2:3, such as 3:7 to 1:1, such as 3:7 to 3:2, such as 3:7 to 7:3, such as 3:7 to 4:1, such as 3:7 to 9:1, such as 1:4 to 1:9, such as 1.4 to 3:7, such as 1.4 to 2:3, such as 1.4 to 1:1, such as 1.4 to 3:2, such as 1.4 to 7:3, such as 1.4 to 4:1, such as 1:4 to 9:1, such as 1:9 to 1:4, such as 1:9 to 3:7, such as 1:9 to 2:3, such as 1:9 to 1:1, such as 1:9 to 3:2, such as 1:9 to 7:3, such as 1:9 to 4:1, such as 1:9 to 9:1.

The addition polymer may comprise a polymerization product of the polymeric dispersant and the second-stage ethylenically unsaturated monomer composition wherein the weight ratio of the residue of the second-stage ethylenically unsaturated monomer composition to the residue of the polymeric dispersant may be 9:1 to 1:9, such as 9:1 to 1:4, such as 9:1 to 3:7, such as 9:1 to 2:3, such as 9:1 to 1:1, such as 9:1 to 3:2, such as 9:1 to 7:3, such as 9:1 to 4:1, such as 4:1 to 1:9, such as 4:1 to 1:4, such as 4:1 to 3:7, such as 4:1 to 2:3, such as 4:1 to 1:1, such as 4:1 to 3:2, such as 4:1 to 7:3, such as 4:1 to 9:1, such as 7:3 to 1:9, such as 7:3 to 1:4, such as 7:3 to 3:7, such as 7:3 to 2:3, such as 7:3 to 1:1, such as 7:3 to 3:2, such as 7:3 to 4:1, such as 7:3 to 9:1, such as 3:2 to 1:9, such as 3:2 to 1:4, such as 3:2 to 3:7, such as 3:2 to 2:3, such as 3:2 to 1:1, such as 3:2 to 7:3, such as 3:2 to 4:1, such as 3:2 to 9:1, such as 1:1 to 1:9, such as 1:1 to 1:4, such as 1:1 to 3:7, such as 1:1 to 2:3, such as 1:1 to 3:2, such as 1:1 to 7:3, such as 1:1 to 4:1, such as 1:1 to 9:1, such as 2:3 to 1:9, such as 2:3 to 1:4, such as 2:3 to 3:7, such as 2:3 to 1:1, such as 2:3 to 3:2, such as 9:1 to 7:3, such as 2:3 to 4:1, such as 2:3 to 9:1, such as 3:7 to 1:9, such as 3:7 to 1:4, such as 3:7 to 2:3, such as 3:7 to 1:1, such as 3:7 to 3:2, such as 3:7 to 7:3, such as 3:7 to 4:1, such as 3:7 to 9:1, such as 1:4 to 1:9, such as 1.4 to 3:7, such as 1.4 to 2:3, such as 1.4 to 1:1, such as 1.4 to 3:2, such as 1.4 to 7:3, such as 1.4 to 4:1, such as 1:4 to 9:1, such as 1:9 to 1:4, such as 1:9 to 3:7, such as 1:9 to 2:3, such as 1:9 to 1:1, such as 1:9 to 3:2, such as 1:9 to 7:3, such as 1:9 to 4:1, such as 1:9 to 9:1.

The addition polymer may comprise active hydrogen functional groups. The active hydrogen functional groups may include hydroxyl groups, mercaptan groups, primary amine groups and/or secondary amine groups.

The addition polymer may have a theoretical hydroxyl equivalent weight of at least 120 g/hydroxyl group (“OH”), such as at least 130 g/OH, such as at least 140 g/OH, such as at least 145 g/OH, and may be no more than 310 g/OH, such as no more than 275 g/OH, such as no more than 200 g/OH, such as no more than 160 g/OH. The addition polymer may have a theoretical hydroxyl equivalent weight of 120 g/OH to 310 g/OH, such as 130 g/OH to 275 g/OH, such as 140 g/OH to 200 g/OH, such as 145 g/OH to 160 g/OH.

The addition polymer may have a theoretical hydroxyl value of at least 190 mg KOH/gram addition polymer, such as at least 250 mg KOH/gram addition polymer, such as at least 320 mg KOH/gram addition polymer, such as at least 355 mg KOH/gram addition polymer, and may be no more than 400 mg KOH/gram addition polymer, such as no more than 390 mg KOH/gram addition polymer, such as no more than 380 mg KOH/gram addition polymer, such as no more than 370 mg KOH/gram addition polymer. The addition polymer may have a theoretical hydroxyl value of 190 to 400 mg KOH/gram addition polymer, such as 250 to 390 mg KOH/gram addition polymer, such as 320 to 380 mg KOH/gram addition polymer, such as 355 to 370 mg KOH/gram addition polymer. As used herein, the term “theoretical hydroxyl value” typically refers to the number of milligrams of potassium hydroxide required to neutralize the acetic acid taken up on acetylation of one gram of a chemical substance that contains free hydroxyl groups and was herein determined by a theoretical calculation of the number of free hydroxyl groups theoretically present in one gram of the addition polymer.

The addition polymer may have a z-average molecular weight of 500,000 g/mol to 5,000,000 g/mol, such as 1,400,000 g/mol to 2,600,000 g/mol, such as 1,800,000 g/mol to 2,200,000 g/mol, such as 1,500,000 g/mol to 1,700,000 g/mol, such as 750,000 g/mol to 950,000 g/mol. The z-average molecular weight may be measured by gel permeation chromatography using polystyrene standards by the same procedure as described above.

The addition polymer may have a weight average molecular weight of 200,000 g/mol to 1,600,000 g/mol, such as 400,000 g/mol to 900,000 g/mol, such as 500,000 g/mol to 800,000 g/mol. The weight average molecular weight may be measured by gel permeation chromatography using polystyrene standards by the same procedure as described above.

The addition polymer may be substantially free, essentially free, or completely free of silicon. As used herein, “silicon” refers to elemental silicon or any silicon containing compound, such as an organosilicon compound including an alkoxysilane. As used herein, the addition polymer is “substantially free” of silicon if silicon is present in the addition polymer in an amount of less than 2% by weight, based on the total weight of the addition polymer. As used herein, the addition polymer is “essentially free” of silicon if silicon present in the addition polymer in an amount of less than 1% by weight, based on the total weight of the addition polymer. As used herein, the addition polymer is “completely free” of silicon if silicon is not present in the addition polymer, i.e., 0% by weight.

The addition polymer may be formed by a two-stage polymerization process. The first stage of the two-stage polymerization process comprises the formation of the polymeric dispersant from the first-stage ethylenically unsaturated monomer composition as described above. The second-stage of the two-stage polymerization process comprises the formation of an addition polymer comprising a polymerization product of the polymeric dispersant formed during the first-stage and a second-stage ethylenically unsaturated monomer composition as described above. The second-stage of the polymerization process may comprise (a) dispersing the second-stage ethylenically unsaturated monomer composition and a free radical initiator in a dispersing medium comprising water in the presence of the at least partially neutralized polymeric dispersant to form an aqueous dispersion, and (b) subjecting the aqueous dispersion to emulsion polymerization conditions, for example, by heating in the presence of the free radical initiator, to polymerize the components to form an aqueous dispersion comprising the formed addition polymer. The time and temperature of polymerization may depend on one another, the ingredients selected and, in some cases, the scale of the reaction. For example, the polymerization may be conducted at 40° C. to 100° C. for 2 to 20 hours.

The free radical initiator utilized for the polymerization of the polymeric dispersant and the second-stage ethylenically unsaturated monomer composition may be selected from any of those used for aqueous addition polymerization techniques, including redox pair initiators, peroxides, hydroperoxides, peroxydicarbonates, azo compounds and the like. The free radical initiator may be present in an amount of 0.01% to 5% by weight, such as 0.05% to 2.0% by weight, such as 0.1% to 1.5% by weight, based on the weight of the second-stage ethylenically unsaturated monomer composition. A chain transfer agent that is soluble in the monomer composition, such as alkyl mercaptans, for example, tertiary-dodecyl mercaptan, 2-mercaptoethanol, isooctyl mercaptopropionate, n-octyl mercaptan or 3-mercapto acetic acid may be used in the polymerization of the polymeric dispersant and the second-stage ethylenically unsaturated monomer composition. Other chain transfer agents such as ketones, for example, methyl ethyl ketone, and chlorocarbons such as chloroform may be used. The amount of chain transfer agent, if present, may be 0.1% to 6.0% by weight, based on the weight of second-stage ethylenically unsaturated monomer composition. Relatively high molecular weight multifunctional mercaptans may be substituted, all or partially, for the chain transfer agent. These molecules may, for example, range in molecular weight from about 94 to 1,000 g/mol or more. Functionality may be from about 2 to about 4. Amounts of these multifunctional mercaptans, if present, may be 0.1% to 6.0% by weight, based on the weight of the second-stage ethylenically unsaturated monomer composition.

According to the present disclosure, water may be present in the aqueous dispersion in amounts of at least 40% by weight, such as at least 50% by weight, such as at least 60% by weight, such as at least 75% by weight, based on total weight of the aqueous dispersion. Water may be present in the aqueous dispersion in amounts of no more than 90% by weight, such as no more than 75% by weight, such as no more than 60% by weight, based on total weight of the aqueous dispersion. Water may be present in the aqueous dispersion in amounts of 40% to 90% by weight, such as 40% to 75% by weight, such as 40% to 60% by weight, such as 50% to 90% by weight, such as 50% to 75% by weight, such as 50% to 60% by weight, such as 60% to 90% by weight, such as 60% to 75% by weight, such as 75% to 90% by weight, based on total weight of the aqueous dispersion. The addition polymer may be added to the other components of the electrodepositable coating composition as an aqueous dispersion of the addition polymer.

In addition to water, the dispersing medium may further comprise organic cosolvents. The organic cosolvents may be at least partially soluble with water. Examples of such solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. If used, the organic cosolvents may be present in an amount of less than 10% by weight, such as less than 5% by weight, based on total weight of the dispersing medium.

The addition polymer described above may be present in the electrodepositable coating composition in an amount of at least 0.01% by weight, such as at least 0.1% by weight, such as at least 0.3% by weight, such as at least 0.5% by weight, such as at least 0.75% by weight, such as 1% by weight, based on the total weight of the resin solids of the electrodepositable coating composition. The addition polymer described above may be present in the electrodepositable coating composition in an amount no more than 5% by weight, such as no more than 3% by weight, such as no more than 2% by weight, such as no more than 1.5% by weight, such as no more than 1% by weight, such as n no more than 0.75% by weight, based on the total weight of the resin solids of the electrodepositable coating composition. The addition polymer may be present in the electrodepositable coating composition in an amount of 0.01% to 5% by weight, such as 0.01% to 3% by weight, such as 0.01% to 2% by weight, such as 0.01% to 1.5% by weight, such as 0.01% to 1% by weight, such as 0.01% to 0.75% by weight, such as 0.1% to 5% by weight, such as 0.1% to 3% by weight, such as 0.1% to 2% by weight, such as 0.1% to 1.5% by weight, such as 0.1% to 1% by weight, such as 0.1% to 0.75% by weight, such as 0.3% to 5% by weight, such as 0.3% to 3% by weight, such as 0.3% to 2% by weight, such as 0.3% to 1.5% by weight, such as 0.3% to 1% by weight, such as 0.3% to 0.75% by weight, such as 0.5% to 5% by weight, such as 0.5% to 3% by weight, such as 0.5% to 2% by weight, such as 0.5% to 1.5% by weight, such as 0.5% to 1% by weight, such as 0.5% to 0.75% by weight, such as 1% to 5% by weight, such as 1% to 3% by weight, such as 1% to 2% by weight, such as 1% to 1.5% by weight, based on the total weight of the resin solids of the electrodepositable coating composition.

Hydroxyl-functional addition polymer: As described above, the edge control additive may comprise a hydroxyl-functional addition polymer comprising constitutional units, at least 70% of which comprise formula VIII:

-[—C(R¹)₂—C(R¹)(OH)—]- (VIII),

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group, and the % based upon the total constitutional units of the hydroxyl-functional addition polymer. Although the addition polymer described above may comprise hydroxyl functional groups, it is different than the hydroxyl-functional addition polymer.

Non-limiting examples of suitable alkyl radicals are methyl, ethyl, propyl, isopropyl, n-butyl, isobutyl, tert-butyl, amyl, hexyl, and 2-ethylhexyl.

Non-limiting examples of suitable cycloalkyl radicals are cyclobutyl, cyclopentyl, and cyclohexyl.

Non-limiting examples of suitable alkylcycloalkyl radicals are methylenecyclohexane, ethylenecyclohexane, and propane-1,3-diylcyclohexane.

Non-limiting examples of suitable cycloalkylalkyl radicals are 2-, 3- and 4-methyl-,-ethyl-,-propyl-, and -butylcyclohex-1-yl.

Non-limiting examples of suitable aryl radicals are phenyl, naphthyl, and biphenylyl.

Non-limiting examples of suitable alkylaryl radicals are benzyl-[sic], ethylene- and propane-1,3-diyl-benzene.

Non-limiting examples of suitable cycloalkylaryl radicals are 2-, 3-, and 4-phenylcyclohex-1-yl.

Non-limiting examples of suitable arylalkyl radicals are 2-, 3- and 4-methyl-, -ethyl-,-propyl-, and -butylphen-1-yl.

Non-limiting examples of suitable arylcycloalkyl radicals are 2-, 3-, and 4-cyclohexylphen-1-yl.

The above-described radicals R¹ may be substituted. Electron-withdrawing or electron-donating atoms or organic radicals may be used for this purpose.

Examples of suitable substituents are halogen atoms, such as chlorine or fluorine, nitrile groups, nitro groups, partly or fully halogenated, such as chlorinated and/or fluorinated, alkyl, cycloalkyl, alkylcycloalkyl, cycloalkylalkyl, aryl, alkylaryl, cycloalkylaryl, arylalkyl and arylcycloalkyl radicals, including those exemplified above, especially tert-butyl; aryloxy, alkyloxy and cycloalkyloxy radicals, especially phenoxy, naphthoxy, methoxy, ethoxy, propoxy, butyloxy or cyclohexyloxy; arylthio, alkylthio and cycloalkylthio radicals, especially phenylthio, naphthylthio, methylthio, ethylthio, propylthio, butylthio or cyclohexylthio; hydroxyl groups; and/or primary, secondary and/or tertiary amino groups, especially amino, N-methylamino, N-ethylamino, N-propylamino, N-phenylamino, N-cyclohexylamino, N,N-dimethylamino, N,N-diethylamino, N,N-dipropylamino, N,N-diphenylamino, N,N-dicyclohexylamino, N-cyclohexyl-N-methylamino or N-ethyl-N-methylamino.

R¹ may comprise, consist essentially of, or consist of hydrogen. For example, R¹ may comprise hydrogen in at least 80% of the constitutional units according to formula VIII, such as at least 90% of the constitutional units, such as at least 92% of the constitutional units, such as at least 95% of the constitutional units, such as 100% of the constitutional units.

The hydroxyl-functional addition polymer may comprise constitutional units according to formula VIII in an amount of at least 70%, such as at least 80%, such as at least 85%, such as at least 90%, the % based upon the total constitutional units of the hydroxyl-functional addition polymer. The hydroxyl-functional addition polymer may comprise constitutional units according to formula VIII in an amount of no more than 100%, such as no more than 95%, such as no more than 92%, such as no more than 90%, the % based upon the total constitutional units of the hydroxyl-functional addition polymer. The hydroxyl-functional addition polymer may comprise constitutional units according to formula VIII in an amount of 70% to 95% of the hydroxyl-functional addition polymer, such as 80% to 95%, such as such as 85% to 95%, such as 90% to 95%, such as 92% to 95%, such as 70% to 92%, such as 80% to 92%, such as such as 85% to 92%, such as 90% to 92%, such as 70% to 90%, such as 80% to 90%, such as such as 85% to 90%, the % based upon the total constitutional units of the hydroxyl-functional addition polymer.

The hydroxyl-functional addition polymer may optionally further comprise constitutional units comprising the residue of a vinyl ester. The vinyl ester may comprise any suitable vinyl ester. For example, the vinyl ester may be according to the formula C(R¹)₂══C(R¹)(C(O)CH₃), wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group. Non-limiting examples of suitable vinyl esters include vinyl acetate, vinyl formate, or any combination thereof.

The hydroxyl-functional addition polymer may be formed from polymerizing vinyl ester monomers to form an intermediate polymer comprising constitutional units comprising the residue of vinyl ester, and then hydrolyzing the constitutional units comprising the residue of vinyl ester of the intermediate polymer to form the hydroxyl-functional addition polymer. The residue of vinyl ester may comprise 70% of the constitutional units comprising the intermediate polymer, such as at least 80%, such as at least 85%, such as at least 90%, the % based upon the total constitutional units of the intermediate polymer. The residue of vinyl ester may comprise no more than 100% of the constitutional units comprising the intermediate polymer, such as no more than 95%, such as no more than 92%, such as no more than 90%, the % based upon the total constitutional units of the intermediate polymer. The residue of vinyl ester may comprise 70% to 95% of the hydroxyl-functional addition polymer, such as 80% to 95%, such as such as 85% to 95%, such as 90% to 95%, such as 92% to 95%, such as 70% to 92%, such as 80% to 92%, such as such as 85% to 92%, such as 90% to 92%, such as 70% to 90%, such as 80% to 90%, such as such as 85% to 90%, the % based upon the total constitutional units of the intermediate polymer.

The hydroxyl-functional addition polymer may have a theoretical hydroxyl equivalent weight of at least 30 g/hydroxyl group (“OH”), such as at least 35 g/OH, such as at least 40 g/OH, such as at least 44 g/OH. The hydroxyl-functional addition polymer may have a theoretical hydroxyl equivalent weight of no more than 200 g/OH, such as no more than 100 g/OH, such as no more than 60 g/OH, such as no more than 50 g/OH. The hydroxyl-functional addition polymer may have a theoretical hydroxyl equivalent weight of 30 g/OH to 200 g/OH, such as 30 g/OH to 100 g/OH, such as 30 g/OH to 60 g/OH, such as 30 g/OH to 50 g/OH, such as 35 g/OH to 200 g/OH, such as 35 g/OH to 100 g/OH, such as 35 g/OH to 60 g/OH, such as 35 g/OH to 50 g/OH, such as 40 g/OH to 200 g/OH, such as 40 g/OH to 100 g/OH, such as 40 g/OH to 60 g/OH, such as 40 g/OH to 50 g/OH, such as 44 g/OH to 200 g/OH, such as 44 g/OH to 100 g/OH, such as 44 g/OH to 60 g/OH, such as 44 g/OH to 50 g/OH. As used herein, the term “theoretical hydroxyl equivalent weight” refers to the weight in grams of hydroxyl-functional addition polymer resin solids divided by the theoretical equivalents of hydroxyl groups present in the hydroxyl-functional addition polymer, and may be calculated according to the following formula (a):

$$hydroxyl equivalent weight = \frac{total grams addition polymer resin solds}{theoretical equivalents of OH} \qquad ( a )$$

The hydroxyl-functional addition polymer may have a theoretical hydroxyl value of at least 1,000 mg KOH/gram addition polymer, such as at least 1,100 mg KOH/gram addition polymer, such as at least 1,150 mg KOH/gram addition polymer, such as at least 1,200 mg KOH/gram addition polymer. The hydroxyl-functional addition polymer may have a theoretical hydroxyl value of no more than 1,300 mg KOH/gram addition polymer, such as no more than 1,200 mg KOH/gram addition polymer, such as no more than 1,150 mg KOH/gram addition polymer. The hydroxyl-functional addition polymer may have a theoretical hydroxyl value of 1,000 to 1,300 mg KOH/gram addition polymer, such as 1,000 to 1,200 mg KOH/gram addition polymer, such as 1,000 to 1,150 mg KOH/gram addition polymer, such as 1,100 to 1,300 mg KOH/gram addition polymer, such as 1,100 to 1,200 mg KOH/gram addition polymer, such as 1,100 to 1,150 mg KOH/gram addition polymer, such as 1,150 to 1,300 mg KOH/gram addition polymer, such as 1,150 to 1,200 mg KOH/gram addition polymer. As used herein, the term “theoretical hydroxyl value” typically refers to the number of milligrams of potassium hydroxide required to neutralize the acetic acid taken up on acetylation of one gram of a chemical substance that contains free hydroxyl groups and was herein determined by a theoretical calculation of the number of free hydroxyl groups theoretically present in one gram of the hydroxyl-functional addition polymer.

The hydroxyl-functional addition polymer may have a number average molecular weight (Mₙ) of at least 5,000 g/mol, such as at least 20,000 g/mol, such as at least 25,000 g/mol, such as at least 50,000 g/mol, such as at least 75,000 g/mol, such as 100,000 g/mol, such as 125,000 g/mol, as determined by Gel Permeation Chromatography using polystyrene calibration standards. The hydroxyl-functional addition polymer may have a number average molecular weight (Mₙ) of no more than 500,000 g/mol, such as no more than 300,000 g/mol, such as no more than 200,000, such as no more than 125,000 g/mol, such as no more than 100,000 g/mol, as determined by Gel Permeation Chromatography using polystyrene calibration standards. The hydroxyl-functional addition polymer may have a number average molecular weight (Mₙ) of 5,000 g/mol to 500,000 g/mol, such as 5,000 g/mol to 300,000 g/mol, such as 5,000 g/mol to 200,000 g/mol, such as 5,000 g/mol to 125,000 g/mol, such as 5,000 g/mol to 100,000 g/mol, such as 20,000 g/mol to 500,000 g/mol, such as 20,000 g/mol to 300,000 g/mol, such as 20,000 g/mol to 200,000 g/mol, such as 20,000 g/mol to 125,000 g/mol, such as 20,000 g/mol to 100,000 g/mol, such as 25,000 g/mol to 500,000 g/mol, such as 25,000 g/mol to 300,000 g/mol, such as 25,000 to 200,000 g/mol, such as 25,000 g/mol to 125,000 g/mol, such as 25,000 g/mol to 100,000 g/mol, such as 50,000 g/mol to 500,000 g/mol, such as 50,000 g/mol to 300,000 g/mol, such as 50,000 g/mol to 200,000 g/mol, such as 50,000 g/mol to 125,000 g/mol, such as 50,000 g/mol to 100,000 g/mol, such as 75,000 g/mol to 500,000 g/mol, such as 75,000 g/mol to 300,000 g/mol, such as 75,000 g/mol to 200,000 g/mol, such as 75,000 g/mol to 125,000 g/mol, such as 100,000 g/mol to 500,000 g/mol, such as 100,000 g/mol to 300,000 g/mol, such as 100,000 g/mol to 200,000 g/mol, such as 100,000 g/mol to 125,000 g/mol, as determined by Gel Permeation Chromatography using polystyrene calibration standards.

The hydroxyl-functional addition polymer may have a weight average molecular weight (Mw) of at least 5,000 g/mol, such as at least 20,000 g/mol, such as at least 25,000 g/mol, such as at least 50,000 g/mol, such as at least 75,000 g/mol, such as 100,000 g/mol, such as 125,000 g/mol, such as at least 150,000 g/mol, such as at least 200,000 g/mol, such as at least 250,000 g/mol, such as at least 300,000 g/mol, as determined by Gel Permeation Chromatography using polystyrene calibration standards. The hydroxyl-functional addition polymer may have a weight average molecular weight (Mw) of no more than 500,000 g/mol, such as no more than 300,000 g/mol, such as no more than 200,000, such as no more than 125,000 g/mol, such as no more than 100,000 g/mol, as determined by Gel Permeation Chromatography using polystyrene calibration standards. The hydroxyl-functional addition polymer may have a weight average molecular weight of 5,000 g/mol to 500,000 g/mol, such as 5,000 g/mol to 300,000 g/mol, such as 5,000 g/mol to 200,000 g/mol, such as 5,000 g/mol to 125,000 g/mol, such as 5,000 g/mol to 100,000 g/mol, such as 20,000 g/mol to 500,000 g/mol, such as 20,000 g/mol to 300,000 g/mol, such as 20,000 g/mol to 200,000 g/mol, such as 20,000 g/mol to 125,000 g/mol, such as 20,000 g/mol to 100,000 g/mol, such as 25,000 g/mol to 500,000 g/mol, such as 25,000 g/mol to 300,000 g/mol, such as 25,000 to 200,000 g/mol, such as 25,000 g/mol to 125,000 g/mol, such as 25,000 g/mol to 100,000 g/mol, such as 50,000 g/mol to 500,000 g/mol, such as 50,000 g/mol to 300,000 g/mol, such as 50,000 g/mol to 200,000 g/mol, such as 50,000 g/mol to 125,000 g/mol, such as 50,000 g/mol to 100,000 g/mol, such as 75,000 g/mol to 500,000 g/mol, such as 75,000 g/mol to 300,000 g/mol, such as 75,000 g/mol to 200,000 g/mol, such as 75,000 g/mol to 125,000 g/mol, such as 100,000 g/mol to 500,000 g/mol, such as 100,000 g/mol to 300,000 g/mol, such as 100,000 g/mol to 200,000 g/mol, such as 100,000 g/mol to 125,000 g/mol, such as 125,000 g/mol to 500,000 g/mol, such as 125,000 g/mol to 300,000 g/mol, such as 125,000 g/mol to 200,000 g/mol, such as 150,000 g/mol to 500,000 g/mol, such as 150,000 g/mol to 300,000 g/mol, such as 150,000 g/mol to 200,000 g/mol, such as 200,000 g/mol to 500,000 g/mol, such as 200,000 g/mol to 300,000 g/mol, such as 250,000 g/mol to 500,000 g/mol, such as 250,000 g/mol to 300,000 g/mol, such as 300,000 g/mol to 500,000 g/mol, as determined by Gel Permeation Chromatography using polystyrene calibration standards.

As used herein, unless otherwise stated, the terms “number average molecular weight (Mₙ)” and “weight average molecular weight (Mw)” means the number average molecular weight (M_{z}) and the weight average molecular weight (Mw) as determined by Gel Permeation Chromatography using Waters 2695 separation module with a Waters 410 differential refractometer (RI detector), polystyrene standards having molecular weights of from approximately 500 g/mol to 900,000 g/mol, dimethylformamide (DMF) with 0.05 M lithium bromide (LiBr) as the eluent at a flow rate of 0.5 mL/min, and one Asahipak GF-510 HQ column for separation.

The hydroxyl-functional addition polymer may have a z-average molecular weight (M_{z}) of at least 10,000 g/mol, such as at least 15,000 g/mol, such as at least 20,000 g/mol, as determined by Gel Permeation Chromatography using polystyrene calibration standards. The hydroxyl-functional addition polymer may have a z-average molecular weight (M_{z}) of no more than 35,000 g/mol, such as no more than 25,000 g/mol, such as no more than 20,000 g/mol, as determined by Gel Permeation Chromatography using polystyrene calibration standards. The hydroxyl-functional addition polymer may have a z-average molecular weight (M_{z}) of 10,000 g/mol to 35,000 g/mol, such as 10,000 g/mol to 25,000 g/mol, such as 10,000 g/mol to 20,000 g/mol, such as 15,000 g/mol to 35,000 g/mol, such as 15,000 g/mol to 25,000 g/mol, such as 15,000 g/mol to 20,000 g/mol, such as 20,000 to 35,000 g/mol, such as 20,000 g/mol to 25,000 g/mol, as determined by Gel Permeation Chromatography using polystyrene calibration standards.

According to the present disclosure, a 4% by weight solution of the hydroxyl-functional addition polymer dissolved in water may have a viscosity of at least 10 cP as measured using a Brookfield synchronized-motor rotary type viscometer at 20° C., such as at least 15 cP, such as at least 20 cP. A 4% by weight solution of the hydroxyl-functional addition polymer dissolved in water may have a viscosity of no more than 110 cP as measured using a Brookfield synchronized-motor rotary type viscometer at 20° C., such as no more than 90 cP, such as no more than 70 cP, such as no more than 60 cP, such as no more than 50 cP, such as no more than 40 cP. A 4% by weight solution of the hydroxyl-functional addition polymer dissolved in water may have a viscosity of 10 to 110 cP as measured using a Brookfield synchronized-motor rotary type viscometer at 20° C., such as 10 to 90 cP, such as 10 to 70 cP, such as 10 to 50 cP, such as 10 to 40 cP, such as 15 to 110 cP, such as 15 to 90 cP, such as 15 to 70 cP, such as 15 to 60 cP, such as 15 to 50 cP, such as 15 to 40 cP, such as 20 to 110 cP, such as 20 to 90 cP, such as 20 to 70 cP, such as 20 to 60 cP, such as 20 to 50 cP, such as 20 to 40 cP.

According to the present disclosure, the hydroxyl-functional addition polymer described above may be present in the electrodepositable coating composition in an amount of at least 0.01% by weight, such as at least 0.1% by weight, such as at least 0.3% by weight, such as at least 0.5% by weight, such as at least 0.75% by weight, such as 1% by weight, based on the total weight of the resin solids of the electrodepositable coating composition. The hydroxyl-functional addition polymer described above may be present in the electrodepositable coating composition in an amount no more than 5% by weight, such as no more than 3% by weight, such as no more than 2% by weight, such as no more than 1.5% by weight, such as no more than 1% by weight, such as n no more than 0.75% by weight, based on the total weight of the resin solids of the electrodepositable coating composition. The hydroxyl-functional addition polymer may be present in the electrodepositable coating composition in an amount of 0.01% to 5% by weight, such as 0.01% to 3% by weight, such as 0.01% to 2% by weight, such as 0.01% to 1.5% by weight, such as 0.01% to 1% by weight, such as 0.01% to 0.75% by weight, such as 0.1% to 5% by weight, such as 0.1% to 3% by weight, such as 0.1% to 2% by weight, such as 0.1% to 1.5% by weight, such as 0.1% to 1% by weight, such as 0.1% to 0.75% by weight, such as 0.3% to 5% by weight, such as 0.3% to 3% by weight, such as 0.3% to 2% by weight, such as 0.3% to 1.5% by weight, such as 0.3% to 1% by weight, such as 0.3% to 0.75% by weight, such as 0.5% to 5% by weight, such as 0.5% to 3% by weight, such as 0.5% to 2% by weight, such as 0.5% to 1.5% by weight, such as 0.5% to 1% by weight, such as 0.5% to 0.75% by weight, such as 1% to 5% by weight, such as 1% to 3% by weight, such as 1% to 2% by weight, such as 1% to 1.5% by weight, based on the total weight of the resin solids of the electrodepositable coating composition.

Cellulose: As described above, the edge control additive may comprise a water-soluble cellulose derivative. The water-soluble cellulose derivative may comprise hydroxyethyl cellulose, carboxymethyl cellulose, carboxymethylhydroxyethyl cellulose, hydroxymethyl cellulose, carboxyethyl cellulose, salts thereof, and combinations thereof. For example, the water-soluble cellulose derivative may comprise carboxymethylcellulose and salts thereof (CMC). CMC is a cellulosic ether in which a portion of the hydroxyl groups on the anhydroglucose rings are substituted with carboxymethyl groups. The degree of carboxymethyl substitution can range from 0.4-3. Since CMC is a long chain polymer, its viscosity in aqueous solutions depends on its molecular weight that can vary between 50,000 and 2,000,000 g/mol on a weight average basis. The carboxymethylcellulose may have a weight average molecular weight of at least 50,000, such as at least 100,000, or some cases, at least 200,000, such as 50,000 to 1,000,000, 100,000 to 500,000, or 200,000 to 300,000 g/mol. Both the degree of substitution and the viscosity of aqueous solutions can be determined via ASTM D 1439-03. Molecular weight is typically estimated from the viscosity of standard CMC solutions.

The water-soluble cellulose derivative may be present in the electrodepositable coating composition in an amount of at least 0.001% by weight, such as at least 0.05% by weight, based on the total weight of the resin solids, such as 0.001% to 10% or 0.05% to 2%.

Polyvinyl formamide polymer: As described above, the edge control additive may comprise a polyvinyl formamide polymer. The polyvinyl formamide polymer may be unhydrolyzed or partially or fully hydrolyzed. Hydrolysis of the formamide group provides a primary amine group; full hydrolysis of the polyvinyl formamide polymer provides a poly(vinyl amine). Hydrolyzed polyvinyl formamide polymers are commercially available from BASF under the trademark “LUAMIN®” with various weight average molecular weights (from about 340,000 dalton to less than 10,000 daltons) and various degrees of hydrolysis (10%, 30%, and 90%). The unhydrolyzed or hydrolyzed polyvinyl formamide polymer may also include monomer units other than vinyl amide and vinyl amine monomer units. For example, vinyl formamide may be copolymerized with vinyl acetate; hydrolysis of the resulting copolymer may provide vinyl alcohol monomer units as well as vinyl amine monomer units. In another example, the polyvinyl formamide polymer comprises only vinyl amide and vinyl amine monomer units (that is, the polyvinyl formamide polymer is a homopolymer of vinyl formamide or an at least partially hydrolyzed homopolymer of vinyl formamide).

The electrodeposition coating composition comprises the unhydrolyzed or hydrolyzed polyvinyl formamide polymer in an amount of generally less than one percent by weight of the coating composition. For example, the electrodeposition coating composition may comprise at least about 25 ppm by weight of the unhydrolyzed or hydrolyzed polyvinyl formamide polymer; in other examples, the aqueous electrodeposition coating composition may comprise at least about 50 ppm by weight of the unhydrolyzed or hydrolyzed polyvinyl formamide polymer. For example, the aqueous electrodeposition coating composition may comprise up to about 1000 ppm by weight of the unhydrolyzed or hydrolyzed polyvinyl formamide polymer; in other examples, the electrodeposition coating composition may comprise up to about 100 ppm by weight of the unhydrolyzed or hydrolyzed polyvinyl formamide polymer. Determining the optimum amount of the unhydrolyzed or hydrolyzed polyvinyl formamide polymer for a particular aqueous electrodeposition coating composition is straightforward, and, in general, satisfactory results may be achieved with amounts of the unhydrolyzed or hydrolyzed polyvinyl formamide polymer of less than 1000 ppm based on weight of the aqueous electrodeposition coating composition.

Cationic epoxy microgel: According to the present disclosure, the edge control additive may comprise a cationic epoxy microgel. The cationic epoxy microgel refers to a cationic microgel dispersion can be prepared by first dispersing in aqueous medium a reactive mixture of the cationic polyepoxide-amine reaction product and the polyepoxide crosslinking agent. The dispersion step can be accomplished by adding the polyepoxide-amine reaction product, preferably at elevated temperatures of from 100° C. to 150° C. to a mixture of water and acid to form a cationic dispersion of the resin in water. Typically, the solids content of the resulting dispersion will be about 20 to 50 percent by weight and the degree of neutralization will be from 20 to 100 percent of the total theoretical neutralization. The acid can be an organic acid such as formic acid, lactic acid and acetic acid as well as inorganic acid such as phosphoric acid and sulfamic acid. Also, blends of acids including blends of organic and inorganic acids can be used. The extent of neutralization depends upon the particular reaction product and usually only sufficient acid is added to stabilize the resulting microgel dispersion. The expression “cationic polyepoxide-amine reaction product which contains primary and/or secondary amine groups” includes primary and secondary amine groups and the acid salts thereof.

Polyamine-dialdehyde adduct: According to the present disclosure, the crater control additive may comprise a polyamine-dialdehyde adduct comprising, or in some cases consisting of, or in some cases consisting essentially of, a polymerization product of a polyamine and a dialdehyde, a polyamine and a dialdehyde may be polymerized to form the polymerization product. As used herein, “polyamine” includes compounds that include at least two amino groups, and the amino groups may comprise primary or secondary amino groups. As used herein, “primary amino groups” are derivatives of ammonia wherein one hydrogen atom has been replaced by an alkyl or aryl group and “secondary amino groups” are derivatives of ammonia wherein two hydrogen atoms have been replaced by alkyl or aryl groups. Non-limiting examples of the polyamine-dialdehyde adduct are provided in Int'l Pub. No. WO 2018/005869 A1, at par. [0009] to [0028], the cited portion of which is incorporated herein by reference.

### Further Components of the Electrodepositable Coating Compositions

The electrodepositable coating composition according to the present disclosure may optionally comprise one or more further components in addition to the active hydrogen-containing, ionic salt group-containing film-forming polymer, the at least partially blocked polyisocyanate curing agent, the curing catalyst, and the edge control additive described above.

According to the present disclosure, the electrodepositable coating compositions of the present disclosure may optionally comprise a corrosion inhibitor. Any suitable corrosion inhibitor may be used. For example, the corrosion inhibitor may comprise a corrosion inhibitor comprising yttrium, lanthanum, cerium, calcium, an azole, or any combination thereof.

Non-limiting examples of suitable azoles include benzotriazole, 5-methyl benzotriazole, 2-amino thiazole, as well as salts thereof.

The corrosion inhibitor(s) may be present, if at all, in the electrodepositable coating composition in an amount of at least 0.001% by weight, such as at least 5% by weight, based on the total weight of the electrodepositable coating composition. The corrosion inhibitor(s) may be present, if at all, in the electrodepositable coating composition in an amount of no more than 25% by weight, such as no more than 15% by weight, such as no more than 10% by weight, based on the total weight of the electrodepositable coating composition. The corrosion inhibitor(s) may be present, if at all, in the electrodepositable coating composition in an amount of 0.001% to 25% by weight, such as 0.001% to 15% by weight, such as 0.001% to 10% by weight, such as 5% to 25% by weight, such as 5% to 15% by weight, such as 5% to 10% by weight, based on the total weight of the electrodepositable coating composition.

Alternatively, the electrodepositable coating composition may be substantially free, essentially free, or completely free of a corrosion inhibitor.

According to the present disclosure, the electrodepositable coating composition may optionally further comprise a silane. The silane may comprise a functional group such as, for example, hydroxyl, carbamate, epoxy, isocyanate, amine, amine-salt, mercaptan, or combinations thereof. The silane may comprise, for example, an aminosilane, a mercaptosilane, or combinations thereof. Mixtures of an aminosilane and a silane having an unsaturated group, such as vinyltriacetoxysilane, may also be used.

The silane may be present, if at all, in the electrodepositable coating composition in an amount of at least 0.01% by weight, such as at least 0.1% by weight, such as at least 1% by weight, such as at least 3% by weight, based on the total weight of the resin solids. The silane may be present, if at all, in the electrodepositable coating composition in an amount of no more than 5% by weight, such as no more than 3% by weight, such as no more than 1% by weight, based on the total weight of the resin solids. The silane may be present, if at all, in the electrodepositable coating composition in an amount of 0.01% to 5% by weight, such as 0.01% to 3% by weight, such as 0.01% to 1% by weight, such as 0.1% to 5% by weight, such as 0.01% to 3% by weight, such as 0.1% to 1% by weight, such as 1% to 5% by weight, such as 1% to 3% by weight, such as 3% to 5% by weight, based on the total weight of the resin solids.

Alternatively, the electrodepositable coating composition may be substantially free, essentially free, or completely free of a silane.

The electrodepositable coating composition may optionally further comprise a pigment. The pigment may comprise an iron oxide, a lead oxide, strontium chromate, carbon black, coal dust, titanium dioxide, barium sulfate, a color pigment, a phyllosilicate pigment, a metal pigment, a thermally conductive, electrically insulative filler, fire-retardant pigment, or any combination thereof.

The pigment-to-binder (P:B) ratio as set forth in this disclosure may refer to the weight ratio of the pigment-to-binder in the electrodepositable coating composition, and/or the weight ratio of the pigment-to-binder in the deposited wet film, and/or the weight ratio of the pigment to the binder in the dry, uncured deposited film, and/or the weight ratio of the pigment-to-binder in the cured film. The pigment-to-binder (P:B) ratio of the pigment to the electrodepositable binder may be at least 0.05:1, such as at least 0.1:1, such as at least 0.2:1, such as at least 0.30:1, such as at least 0.35:1, such as at least 0.40:1, such as at least 0.50:1, such as at least 0.60:1, such as at least 0.75:1, such as at least 1:1, such as at least 1.25:1, such as at least 1.5:1. The pigment-to-binder (P:B) ratio of the pigment to the electrodepositable binder may be no more than 2.0:1, such as no more than 1.75:1, such no more than 1.5:1, such as no more than 1.25:1, such as no more than 1:1, such as no more than 0.75:1, such as no more than 0.70:1, such as no more than 0.60:1, such as no more than 0.55:1, such as no more than 0.50:1, such as no more than 0.30:1, such as no more than 0.20:1, such as no more than 0.10:1. The pigment-to-binder (P:B) ratio of the pigment to the electrodepositable binder may be 0.05:1 to 2.0:1, such as 0.05:1 to 1.75:1, such as 0.05:1 to 1.50:1, such as 0.05:1 to 1.25:1, such as 0.05:1 to 1:1, such as 0.05:1 to 0.75:1, such as 0.05:1 to 0.70:1, such as 0.05:1 to 0.60:1, such as 0.05:1 to 0.55:1, such as 0.05:1 to 0.50:1, such as 0.05:1 to 0.30:1, such as 0.05:1 to 0.20:1, such as 0.05:1 to 0.10:1, such as 0.1:1 to 2.0:1, such as 0.1:1 to 1.75:1, such as 0.1:1 to 1.50:1, such as 0.1:1 to 1.25:1, such as 0.1:1 to 1:1, such as 0.1:1 to 0.75:1, such as 0.1:1 to 0.70:1, such as 0.1:1 to 0.60:1, such as 0.1:1 to 0.55:1, such as 0.1:1 to 0.50:1, such as 0.1:1 to 0.30:1, such as 0.1:1 to 0.20:1, such as 0.2:1 to 2.0:1, such as 0.2:1 to 1.75:1, such as 0.2:1 to 1.50:1, such as 0.2:1 to 1.25:1, such as 0.2:1 to 1:1, such as 0.2:1 to 0.75:1, such as 0.2:1 to 0.70:1, such as 0.2:1 to 0.60:1, such as 0.2:1 to 0.55:1, such as 0.2:1 to 0.50:1, such as 0.2:1 to 0.30:1, such as 0.3:1 to 2.0:1, such as 0.3:1 to 1.75:1, such as 0.3:1 to 1.50:1, such as 0.3:1 to 1.25:1, such as 0.3:1 to 1:1, such as 0.3:1 to 0.75:1, such as 0.3:1 to 0.70:1, such as 0.3:1 to 0.60:1, such as 0.3:1 to 0.55:1, such as 0.3:1 to 0.50:1, such as 0.3:1 to 0.30:1, such as 0.35:1 to 2.0:1, such as 0.35:1 to 1.75:1, such as 0.35:1 to 1.50:1, such as 0.35:1 to 1.25:1, such as 0.35:1 to 1:1, such as 0.35:1 to 0.75:1, such as 0.35:1 to 0.70:1, such as 0.35:1 to 0.60:1, such as 0.35:1 to 0.55:1, such as 0.35:1 to 0.50:1, such as 0.4:1 to 2.0:1, such as 0.4:1 to 1.75:1, such as 0.4:1 to 1.50:1, such as 0.4:1 to 1.25:1, such as 0.4:1 to 1:1, such as 0.4:1 to 0.75:1, such as 0.4:1 to 0.70:1, such as 0.4:1 to 0.60:1, such as 0.4:1 to 0.55:1, such as 0.4:1 to 0.50:1, such as 0.5:1 to 2.0:1, such as 0.5:1 to 1.75:1, such as 0.5:1 to 1.50:1, such as 0.5:1 to 1.25:1, such as 0.5:1 to 1:1, such as 0.5:1 to 0.75:1, such as 0.5:1 to 0.70:1, such as 0.5:1 to 0.60:1, such as 0.5:1 to 0.55:1, such as 0.6:1 to 2.0:1, such as 0.6:1 to 1.75:1, such as 0.6:1 to 1.50:1, such as 0.6:1 to 1.25:1, such as 0.6:1 to 1:1, such as 0.6:1 to 0.75:1, such as 0.6:1 to 0.70:1, such as 0.75:1 to 2.0:1, such as 0.75:1 to 1.75:1, such as 0.75:1 to 1.50:1, such as 0.75:1 to 1.25:1, such as 0.75:1 to 1:1, such as 1:1 to 2.0:1, such as 1:1 to 1.75:1, such as 1:1 to 1.50:1, such as 1:1 to 1.25:1, such as 1.25:1 to 2.0:1, such as 1.25:1 to 1.75:1, such as 1.25:1 to 1.50:1, such as 1.50:1 to 2.0:1, such as 1.50:1 to 1.75:1.

The electrodepositable coating composition may optionally further comprise a grind resin. As used herein, the term “grind resin” refers to a resin chemically distinct from the main film-forming polymer that is used during milling of pigment to form a pigment paste separately from the main film-forming polymer of the binder. For example, the grind resin may include quaternary ammonium salt groups and/or tertiary sulfonium groups. Grind resin may be used interchangeably with grind vehicle.

Alternatively, the electrodepositable coating composition optionally may be substantially free, essentially free, or completely free of a grind resin. As used herein, an electrodepositable coating composition is substantially free of grind resin if grind resin is present, if at all, in an amount of no more than 5% by weight, based on the total resin solids weight of the composition. As used herein, an electrodepositable coating composition is essentially free of grind resin if grind resin is present, if at all, in an amount no more than 3% by weight, based on the total resin solids weight of the composition. As used here, an electrodepositable coating composition is completely free of grind resin if grind resin is not present in the composition, i.e., 0.00% by weight, based on the total resin solids weight of the composition.

The electrodepositable coating composition may be substantially free, essentially free, or completely free of electrically conductive particles. The electrically conductive particles may comprise any particles capable of conducting electricity. As used herein, an electrically conductive particle is “capable of conducting electricity” if the material has a conductivity of at least 1×10⁵ S/m and a resistivity of no more than 1×10⁶ W-m at 20° C. The electrically conductive particles may include carbonaceous materials such as, activated carbon, carbon black such as acetylene black and furnace black, graphene, carbon nanotubes, including single-walled carbon nanotubes and/or multi-walled carbon nanotubes, carbon fibers, fullerene, metal particles, and combinations thereof. As used herein, an electrodepositable coating composition is substantially free of electrically conductive particles if electrically conductive particles are present in an amount of less than 5% by weight, based on the total weight of the pigment of the composition. As used herein, an electrodepositable coating composition is essentially free of electrically conductive particles if electrically conductive particles are present in an amount of less than 1% by weight, based on the total weight of the pigment of the composition. As used here, an electrodepositable coating composition is completely free of electrically conductive particles if electrically conductive particles are not present in the composition, i.e., 0.00% by weight, based on the total weight of the pigment of the composition.

The electrodepositable coating composition may be substantially free, essentially free, or completely free of metal particles. As used herein, the term “metal particles” refers to metal and metal alloy pigments that consist primarily of metal(s) in the elemental (zerovalent) state. The metal particles may include zinc, aluminum, cadmium, magnesium, beryllium, copper, silver, gold, iron, titanium, nickel, manganese, chromium, scandium, yttrium, zirconium, platinum, tin, and alloys thereof, as well as various grades of steel. As used herein, an electrodepositable coating composition is substantially free of metal particles if metal particles are present in an amount of less than 5% by weight, based on the total weight of the pigment of the composition. As used herein, an electrodepositable coating composition is essentially free of metal particles if metal particles are present in an amount of less than 1% by weight, based on the total weight of the pigment of the composition. As used here, an electrodepositable coating composition is completely free of metal particles if metal particles are not present in the composition, i.e., 0.00% by weight, based on the total weight of the pigment of the composition.

The electrodepositable coating composition of the present disclosure may be substantially free, essentially free, or completely free of lithium-containing compounds. As used herein, lithium-containing compounds refers to compounds or complexes that comprise lithium, such as, for example, LiCoC, LiNIC, LiFePO₄, LiCOPCO₄, LiMnO₂, LiMn₂O₄, Li(NiMnCo)O₂, and Li(NiCoAl)O₂. As used herein, an electrodepositable coating composition is “substantially free” of lithium-containing compounds if lithium-containing compounds are present in the electrodepositable coating composition in an amount of less than 1% by weight, based on the total solids weight of the composition. As used herein, an electrodepositable coating composition is “essentially free” of lithium-containing compounds if lithium-containing compounds are present in the electrodepositable coating composition in an amount of less than 0.1% by weight, based on the total solids weight of the composition. As used herein, an electrodepositable coating composition is “completely free” of lithium-containing compounds if lithium-containing compounds are not present in the electrodepositable coating composition, i.e., <0.001% by weight, based on the total solids weight of the composition.

According to the present disclosure, the electrodepositable coating compositions of the present disclosure may optionally comprise crater control additives which may be incorporated into the coating composition, such as, for example, a polyalkylene oxide polymer which may comprise a copolymer of butylene oxide and propylene oxide. According to the present disclosure, the molar ratio of butylene oxide to propylene oxide may be at least 1:1, such as at least 3:1, such as at least 5:1, and in some instances, may be no more than 50:1, such as no more than 30:1, such as no more than 20:1. According to the present disclosure, the molar ratio of butylene oxide to propylene oxide may be 1:1 to 50:1, such as 3:1 to 30:1, such as 5:1 to 20:1.

The polyalkylene oxide polymer may comprise at least two hydroxyl functional groups, and may be monofunctional, difunctional, trifunctional, or tetrafunctional. As used herein, a “hydroxyl functional group” comprises an —OH group. For clarity, the polyalkylene oxide polymer may comprise additional functional groups in addition to the hydroxyl functional group(s).

The hydroxyl equivalent weight of the polyalkylene oxide polymer may be 100 g/mol to 2,000 g/mol, such as 200 g/mol to 1,000 g/mol, such as 400 g/mol to 800 g/mol. As used herein, with respect to the polyalkylene oxide polymer, the “hydroxyl equivalent weight” is determined by dividing the molecular weight of the polyalkylene oxide polymer by the number of hydroxyl groups present in the polyalkylene oxide polymer.

The polyalkylene oxide polymer may have a z-average molecular weight of 200 g/mol to 5,000 g/mol, such as 400 g/mol to 3,000 g/mol, such as 600 g/mol to 2,000 g/mol.

The polyalkylene oxide polymer may be present in the electrodepositable coating composition in an amount of at 0.1% by weight to 10% by weight based on the total weight of the resin blend solids, such as 0.5% by weight to 4% by weight, such as 0.75% by weight to 3% by weight.

According to the present disclosure, the electrodepositable coating composition may further comprise a polyetheramine-adduct comprising an ungelled ionic reaction product prepared from reactants comprising: (a) a reaction product prepared from reactants comprising: (1) a polyol; and (2) an epoxy functional material; and (b) a polyetheramine.

Examples of suitable polyols useful for forming the ungelled ionic reaction product include resorcinol, dihydroxy benzene, aliphatic, cycloaliphatic or aralaphatic hydroxyl containing compounds, such as ethylene glycol, propylene glycol, bisphenol A, dihydroxyl cyclohexane, dimethylol cyclohexane, or combinations thereof. The polyol may be present in the polyetheramine adduct in an amount of about 0% to 20% by weight based on the total weight of the reactants that form the polyether reaction product, such as 0% to 15% by weight.

Examples of suitable epoxy-functional materials useful for forming the ungelled ionic reaction product contain at least one epoxy group in the molecule, such as di- or polyglycidyl ethers of polyhydric alcohols, such as a polyglycidyl ether of bisphenol A. Suitable epoxy-functional materials may have an epoxy equivalent weight ranging from about 90 to about 2000, as measured by titration with perchloric acid using methyl violet as an indicator. The epoxy-functional material may comprise about 10% to 40% by weight based on the total weight of the epoxy functional polyester, such as 15% to 35% by weight of the epoxy functional material is combined or reacted with the polyester described above to form the epoxy functional polyester.

According to the present disclosure, the polyetheramine adduct may be formed by reacting the ungelled ionic reaction product with at least one polyetheramine which may be the same as those described above characterized by propylene oxide, ethylene oxide, or mixed propylene oxide and ethylene oxide repeating units in their respective structures, such as, for example, one of the Jeffamine series products (commercially available from Huntsman Corporation). Examples of such polyetheramines include aminated propoxylated pentaerythritols, such as Jeffamine XTJ-616, and those represented by Formulas (I) through (III) above.

Further examples of the polyetheramine-adduct are those described in U.S. Pat. Nos. 4,420,574, and 4,423,166, which are incorporated herein by reference.

According to the present disclosure, the polyetheramine-adduct may be present in the electrodepositable coating composition in an amount of at least 3% by weight based on the total weight of the resin blend solids, such as at least 5% by weight, such as at least 10% by weight, such as at least 15% by weight, and no more than 20% by weight, such as no more than 15% by weight, such as no more than 10% by weight, such as no more than 5% by weight. The polyetheramine-adduct may be present in the electrodepositable coating composition in an amount of 3% to 20% by weight based on the total weight of the resin blend solids, such as 5% to 15% by weight, such as 5% to 10% by weight.

According to the present disclosure, the electrodepositable coating composition may comprise other optional ingredients, such as if desired, various additives such as fillers, plasticizers, anti-oxidants, biocides, UV light absorbers and stabilizers, hindered amine light stabilizers, defoamers, fungicides, dispersing aids, flow control agents, surfactants, wetting agents, or combinations thereof. Alternatively, the electrodepositable coating composition may be completely free of any of the optional ingredients, i.e., the optional ingredient is not present in the electrodepositable coating composition. The other additives mentioned above may be present in the electrodepositable coating composition in amounts of 0.01% to 3% by weight, based on total weight of the resin solids of the electrodepositable coating composition.

The electrodepositable coating composition may optionally further comprise bis[2-(2-butoxyethoxy)ethoxy]methane. The bis[2-(2-butoxyethoxy)ethoxy]methane may be present in an amount of at least 0.1% by weight, such as at least 0.5% by weight, based on the resin solids weight. The bis[2-(2-butoxyethoxy)ethoxy]methane may be present in an amount of no more than 15% by weight, such as no more than 10% by weight, such as no more than 3% by weight, based on the resin solids weight. The bis[2-(2-butoxyethoxy)ethoxy]methane may be present in an amount of 0.1% to 15% by weight, such as 0.1% to 10% by weight, such as 0.1% to 3% by weight, such as 0.5% to 15% by weight, such as 0.5% to 10% by weight, such as 0.5% to 3% by weight, based on the resin solids weight.

According to the present disclosure, the electrodepositable coating composition may comprise water and/or one or more organic solvent(s). Water can for example be present in amounts of 40% to 90% by weight, such as 50% to 75% by weight, based on total weight of the electrodepositable coating composition. Examples of suitable organic solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. If used, the organic solvents may typically be present in an amount of less than 10% by weight, such as less than 5% by weight, based on total weight of the electrodepositable coating composition. The electrodepositable coating composition may in particular be provided in the form of a dispersion, such as an aqueous dispersion.

According to the present disclosure, the total solids content of the electrodepositable coating composition may be at least 1% by weight, such as at least 5% by weight, and may be no more than 50% by weight, such as no more than 40% by weight, such as no more than 20% by weight, based on the total weight of the electrodepositable coating composition. The total solids content of the electrodepositable coating composition may be from 1% to 50% by weight, such as 5% to 40% by weight, such as 5% to 20% by weight, based on the total weight of the electrodepositable coating composition. As used herein, “total solids” refers to the non-volatile content of the electrodepositable coating composition, i.e., materials which will not volatilize when heated to 110° C. for 15 minutes.

### Substrates

According to the present disclosure, the electrodepositable coating composition may be electrophoretically applied to a substrate. The cationic electrodepositable coating composition may be electrophoretically deposited upon any electrically conductive substrate. Suitable substrates include metal substrates, metal alloy substrates, and/or substrates that have been metallized, such as nickel-plated plastic. Additionally, substrates may comprise non-metal conductive materials including composite materials such as, for example, materials comprising carbon fibers or conductive carbon. According to the present disclosure, the metal or metal alloy may comprise cold rolled steel, hot rolled steel, steel coated with zinc metal, zinc compounds, or zinc alloys, such as electrogalvanized steel, hot-dipped galvanized steel, galvanealed steel, and steel plated with zinc alloy. Aluminum alloys of the 2XXX, 3XXX, 4XXX, 5XXX, 6XXX, or 7XXX series as well as clad aluminum alloys and cast aluminum alloys of the A356 series also may be used as the substrate. Magnesium alloys of the AZ31B, AZ91C, AM60B, or EV31A series also may be used as the substrate. The substrate used in the present disclosure may also comprise titanium and/or titanium alloys. Other suitable non-ferrous metals include copper and magnesium, as well as alloys of these materials. Suitable metal substrates for use in the present disclosure include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, agricultural equipment, lawn and garden equipment, air conditioning units, heat pump units, lawn furniture, and other articles. As used herein, “vehicle” or variations thereof includes, but is not limited to, civilian, commercial and military aircraft, and/or land vehicles such as cars, motorcycles, and/or trucks. The metal substrate also may be in the form of, for example, a sheet of metal or a fabricated part. It will also be understood that the substrate may be pretreated with a pretreatment solution including a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091.

### Methods of Coating, Coatings and Coated Substrates

The present disclosure is also directed to methods for coating a substrate, such as any one of the electroconductive substrates mentioned above. According to the present disclosure such method may comprise electrophoretically applying an electrodepositable coating composition as described above to at least a portion of the substrate and curing the coating composition to form an at least partially cured coating on the substrate. According to the present disclosure, the method may comprise (a) electrophoretically depositing onto at least a portion of the substrate an electrodepositable coating composition of the present disclosure and (b) heating the coated substrate to a temperature and for a time sufficient to cure the electrodeposited coating on the substrate. According to the present disclosure, the method may optionally further comprise (c) applying directly to the at least partially cured electrodeposited coating one or more pigment-containing coating compositions and/or one or more pigment-free coating compositions to form a topcoat over at least a portion of the at least partially cured electrodeposited coating, and (d) heating the coated substrate of step (c) to a temperature and for a time sufficient to cure the topcoat.

According to the present disclosure, the cationic electrodepositable coating composition of the present disclosure may be deposited upon an electrically conductive substrate by placing the composition in contact with an electrically conductive cathode and an electrically conductive anode, with the surface to be coated being the cathode. Following contact with the composition, an adherent film of the coating composition is deposited on the cathode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the cationic electrodepositable coating composition is electrodeposited over at least a portion of the electroconductive substrate, the coated substrate is heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 250° F. to 450° F. (121.1° C. to 232.2° C.), such as from 275° F. to 400° F. (135° C. to 204.4° C.), such as from 300° F. to 360° F. (149° C. to 180° C.). The curing time may be dependent upon the curing temperature as well as other variables, for example, the film thickness of the electrodeposited coating, level and type of catalyst present in the composition and the like. For purposes of the present disclosure, all that is necessary is that the time be sufficient to effect cure of the coating on the substrate. For example, the curing time can range from 10 minutes to 60 minutes, such as 20 to 40 minutes. The thickness of the resultant cured electrodeposited coating may range from 15 to 50 microns.

According to the present disclosure, the anionic electrodepositable coating composition of the present disclosure may be deposited upon an electrically conductive substrate by placing the composition in contact with an electrically conductive cathode and an electrically conductive anode, with the surface to be coated being the anode. Following contact with the composition, an adherent film of the coating composition is deposited on the anode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the anionic electrodepositable coating composition is electrodeposited over at least a portion of the electroconductive substrate, the coated substrate may be heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 200° F. to 450° F. (93° C. to 232.2° C.), such as from 275° F. to 400° F. (135° C. to 204.4° C.), such as from 300° F. to 360° F. (149° C. to 180° C.). The curing time may be dependent upon the curing temperature as well as other variables, for example, film thickness of the electrodeposited coating, level and type of catalyst present in the composition and the like. For purposes of the present disclosure, all that is necessary is that the time be sufficient to effect cure of the coating on the substrate. For example, the curing time may range from 10 to 60 minutes, such as 20 to 40 minutes. The thickness of the resultant cured electrodeposited coating may range from 15 to 50 microns.

The electrodepositable coating compositions of the present disclosure may also, if desired, be applied to a substrate using non-electrophoretic coating application techniques, such as flow, dip, spray and roll coating applications. For non-electrophoretic coating applications, the coating compositions may be applied to conductive substrates as well as non-conductive substrates such as glass, wood and plastic.

The present disclosure is further directed to a coating formed by at least partially curing the electrodepositable coating composition described herein.

The present disclosure is further directed to a substrate that is coated, at least in part, with the electrodepositable coating composition described herein in an at least partially cured state. The coated substrate may comprise a coating comprising (a) an active hydrogen containing, ionic salt group-containing film-forming polymer; (b) blocked polyisocyanate curing agent; (c) a curing catalyst; and (d) an edge control additive, wherein the electrodepositable coating composition has a gel point of less than 150° C., as measured by the GEL POINT TEST METHOD, an edge coverage of greater than 20%, as measured by the EDGE COVERAGE TEST METHOD, and an Ra of no more than 0.45, as measured by the SURFACE ROUGHNESS TEST METHOD.

The electrodepositable coating compositions of the present disclosure may be utilized in an electrocoating layer that is part of a multi-layer coating composite comprising a substrate with various coating layers. The coating layers may include a pretreatment layer, such as a phosphate layer (e.g., zinc phosphate layer), an electrocoating layer which results from the aqueous resinous dispersion of the present disclosure, and suitable topcoat layers (e.g., base coat, clear coat layer, pigmented monocoat, and color-plus-clear composite compositions). It is understood that suitable topcoat layers include any of those known in the art, and each independently may be waterborne, solventborne, in solid particulate form (i.e., a powder coating composition), or in the form of a powder slurry. The topcoat typically includes a film-forming polymer, crosslinking material and, if a colored base coat or monocoat, one or more pigments. According to the present disclosure, the primer layer is disposed between the electrocoating layer and the base coat layer. According to the present disclosure, one or more of the topcoat layers are applied onto a substantially uncured underlying layer. For example, a clear coat layer may be applied onto at least a portion of a substantially uncured basecoat layer (wet-on-wet), and both layers may be simultaneously cured in a downstream process.

Moreover, the topcoat layers may be applied directly onto the electrodepositable coating layer. In other words, the substrate lacks a primer layer. For example, a basecoat layer may be applied directly onto at least a portion of the electrodepositable coating layer.

It will also be understood that the topcoat layers may be applied onto an underlying layer despite the fact that the underlying layer has not been fully cured. For example, a clearcoat layer may be applied onto a basecoat layer even though the basecoat layer has not been subjected to a curing step. Both layers may then be cured during a subsequent curing step thereby eliminating the need to cure the basecoat layer and the clearcoat layer separately.

According to the present disclosure, additional ingredients such as colorants and fillers may be present in the various coating compositions from which the topcoat layers result. Any suitable colorants and fillers may be used. For example, the colorant may be added to the coating in any suitable form, such as discrete particles, dispersions, solutions and/or flakes. A single colorant or a mixture of two or more colorants can be used in the coatings of the present disclosure. It should be noted that, in general, the colorant can be present in a layer of the multi-layer composite in any amount sufficient to impart the desired property, visual and/or color effect.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant may be organic or inorganic and may be agglomerated or non-agglomerated. Colorants may be incorporated into the coatings by grinding or simple mixing. Colorants may be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPP red BO”), titanium dioxide, carbon black, zinc oxide, antimony oxide, etc. and organic or inorganic UV opacifying pigments such as iron oxide, transparent red or yellow iron oxide, phthalocyanine blue and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

The colorant may be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions may include colorants such as pigments or dyes having a particle size of less than 150 nm, such as less than 70 nm, or less than 30 nm. Nanoparticles may be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions may also be produced by crystallization, precipitation, gas phase condensation, and chemical attrition (i.e., partial dissolution). In order to minimize re-agglomeration of nanoparticles within the coating, a dispersion of resin-coated nanoparticles may be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. patent application Ser. No. 10/876,031 filed Jun. 24, 2004, which is incorporated herein by reference, and U.S. Provisional Pat. Application No. 60/482,167 filed Jun. 24, 2003, which is also incorporated herein by reference.

According to the present disclosure, special effect compositions that may be used in one or more layers of the multi-layer coating composite include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions may provide other perceptible properties, such as reflectivity, opacity or texture. For example, special effect compositions may produce a color shift, such that the color of the coating changes when the coating is viewed at different angles. Example color effect compositions are identified in U.S. Pat. No. 6,894,086, incorporated herein by reference. Additional color effect compositions may include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

According to the present disclosure, a photosensitive composition and/or photochromic composition, which reversibly alters its color when exposed to one or more light sources, can be used in a number of layers in the multi-layer composite. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. For example, the photochromic and/or photosensitive composition may be colorless in a non-excited state and exhibit a color in an excited state. Full color-change may appear within milliseconds to several minutes, such as from 20 seconds to 60 seconds. Example photochromic and/or photosensitive compositions include photochromic dyes.

According to the present disclosure, the photosensitive composition and/or photochromic composition may be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with the present disclosure, have minimal migration out of the coating. Example photosensitive compositions and/or photochromic compositions and methods for making them are identified in U.S. patent application Ser. No. 10/892,919 filed Jul. 16, 2004 and incorporated herein by reference.

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

In this application, the use of the singular includes the plural and plural encompasses singular, unless specifically stated otherwise. For example, although reference is made herein to “an” ionic salt group-containing film-forming polymer, “a” hydroxyl functional addition polymer, “a” monomer, “an” ionic salt group-containing film-forming polymer, “a” blocked polyisocyanate curing agent, a combination (i.e., a plurality) of these components may be used. In addition, in this application, the use of “or” means “and/or” unless specifically stated otherwise, even though “and/or” may be explicitly used in certain instances.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

### Example 1: Preparation of Blocked Polyisocyanate Curing Agent (Crosslinkers I, Ia-c, II)

A blocked polyisocyanate curing agent was prepared in the following manner: Components 2-9 listed in Table 1, below, were mixed in a flask set up for total reflux with stirring under nitrogen. The mixture was heated to a temperature of 30° C., and Component 1 was added dropwise so that the temperature increased due to the reaction exotherm and was maintained under 100° C. After the addition of Component 1 was complete, Component 10 was added to the mixture. A temperature of 100° C. was then established and the reaction mixture was held at temperature until no residual isocyanate was detected by IR spectroscopy. Component 11 was then added, and the reaction mixture was allowed to stir for 30 minutes before cooling to ambient temperature.

TABLE 1

| | | Parts by Weight | | | | |
|---|---|---|---|---|---|---|
| # | Component | I | Ia | Ib | Ic | II |
| 1 | Polymeric methylene diphenyl | 1560.9 | 711.0 | 785.0 | 810.0 | 914.1 |
| | diisocyanate¹ | | | | | |
| 2 | Dibutyltin dilaurate | 1.4 | 0.9 | 0.8 | 0.9 | 0.9 |
| 3 | Methyl isobutyl ketone | 445.5 | 270.2 | 269.7 | 269.3 | 154.0 |
| 4 | Propylene glycol | 619.7 | — | — | — | — |
| 5 | N,N-Dibutylglycolamide | — | 695.8 | — | — | — |
| 6 | N-Butyllactamide | — | — | 594.3 | — | — |
| 7 | Solketal (DL-1,2- | — | — | — | 558.4 | — |
| | Isopropylidene glycerol) | | | | | |
| 8 | (2-(2-Butoxyethoxy)ethanol) | 566.1 | 257.2 | 283.9 | 293.5 | 221.0 |
| 9 | 2-Butoxyethanol | — | — | — | — | 644.0 |
| 10 | (2-(2-Butoxyethoxy)ethanol) | 56.9 | 34.3 | 34.4 | 38.2 | — |
| 11 | Methyl isobutyl ketone | 49.5 | 30.2 | 30.3 | 32.2 | 66.0 |

¹Rubinate M, available from Huntsman Corporation.

### Example 2: Preparation of a Cationic, Amine-Functionalized, Polyepoxide-Based Resin

A cationic, amine-functionalized, polyepoxide-based polymeric resin was prepared in the following manner. Components 1-8 listed in Table 2, below, were mixed in a flask set up for total reflux with stirring under nitrogen. The mixture was heated to a temperature of 130° C. and allowed to exotherm (175° C. maximum). A temperature of 145° C. was established in the reaction mixture and the reaction mixture was then held for 2 hours. Component 9 was introduced slowly while allowing the mixture to cool to 125° C. followed by the addition of Components 10-14. A temperature of 105° C. was established, and Components 15 and 16 were then added to the reaction mixture quickly (sequential addition) and the reaction mixture was allowed to exotherm. A temperature of 115° C. was established and the reaction mixture held for 1 hour, resulting in Resin Synthesis Products A-H.

A portion of the Resin Synthesis Product A-H (Component 17) was then poured into a pre-mixed solution of Components 18 and 19 to form a resin dispersion, and the resin dispersion was stirred for 30 min. Component 20 was then introduced over 30 minutes to dilute further the resin dispersion, followed by the addition of Component 21. The free MIBK in the resin dispersion was removed from the dispersion under vacuum at a temperature of 60-70° C.

The solids content of the resulting cationic, amine-functionalized, polyepoxide-based polymeric resin dispersion was determined by adding a quantity of the resin dispersion to a tared aluminum dish, recording the initial weight of the resin dispersion, heating the resin dispersion in the dish for 60 minutes at 110° C. in an oven, allowing the dish to cool to ambient temperature, reweighing the dish to determine the amount of non-volatile content remaining, and calculating the solids content by dividing the weight of the remaining non-volatile content by the initial resin dispersion weight and multiplying by 100. (Note, this procedure was used to determine the solids content in each of resin dispersion examples described below). The solids contents of Resin Dispersions A-H are reported in Table 2.

TABLE 2

| | | Resin Example: | | | | | | | |
|---|---|---|---|---|---|---|---|---|---|
| | | A³ | B | C | D⁴ | E | F | G | H |
| # | Material | Resin Synthesis Stage - Parts by Weight | | | | | | | |
| 1 | EPON 828¹ | 2210.6 | 863.4 | 516.1 | 928.4 | 363.4 | 363.1 | 382.2 | 896.5 |
| 2 | Bisphenol A | 760.5 | 284.8 | 168.4 | 400.5 | 125.3 | 124.9 | 135.1 | 309.0 |
| 3 | Bisphenol A - | 955.6 | 416.5 | 250.0 | 404.6 | 188.8 | 177.2 | 183.1 | 404.4 |
| | ethylene | | | | | | | | |
| | oxide adduct | | | | | | | | |
| | (1/6 molar | | | | | | | | |
| | ratio | | | | | | | | |
| | BPA/EO) | | | | | | | | |
| 4 | Phenol | 163.3 | — | — | — | 26.8 | 26.8 | 28.2 | 66.5 |
| 5 | 4- | — | 176.8 | — | — | — | — | — | — |
| | Dodecylphenol | | | | | | | | |
| 6 | 12- | — | — | 121.9 | — | — | — | — | — |
| | Hydroxystearic | | | | | | | | |
| | acid | | | | | | | | |
| 7 | Methyl | 126.5 | 53.5 | 32.6 | 53.6 | 22.2 | 21.4 | 22.4 | 52.1 |
| | isobutyl | | | | | | | | |
| | ketone | | | | | | | | |
| | (MIBK) | | | | | | | | |
| 8 | Ethyl | 3.5 | 1.3 | 0.8 | 1.5 | 0.6 | 0.6 | 0.6 | 1.4 |
| | triphenyl | | | | | | | | |
| | phosphonium | | | | | | | | |
| | bromide | | | | | | | | |
| 9 | Methyl | 28.1 | 12.4 | 7.5 | 11.7 | — | — | — | 69.3 |
| | isobutyl | | | | | | | | |
| | ketone | | | | | | | | |
| 10 | Crosslinker I | 3166.0 | 1337.4 | 816.8 | 1344.2 | — | — | — | — |
| 11 | Crosslinker Ia | — | — | — | — | 739.0 | — | — | — |
| 12 | Crosslinker Ib | — | — | — | — | — | 647.5 | — | — |
| 13 | Crosslinker Ic | — | — | — | — | — | — | 656.8 | — |
| 14 | Crosslinker II | — | — | — | — | — | — | — | 1342.4 |
| 15 | Diethylene | 203.0 | 85.4 | 52.2 | 86.6 | 52.3 | 52.7 | 55.4 | 82.0 |
| | triamine - | | | | | | | | |
| | MIBK | | | | | | | | |
| | diketimine ² | | | | | | | | |
| 16 | N-Methyl | 173.4 | 73.7 | 44.3 | 73.1 | 24.2 | 24.6 | 25.9 | 70.2 |
| | ethanolamine | | | | | | | | |
| 17 | Resin | 7011.4 | 2971.0 | 1737.6 | 2967.4 | 1315.9 | 1266.1 | 1307.9 | 1752.2 |
| | Synthesis | | | | | | | | |
| | Product | | | | | | | | |
| 18 | Formic Acid | 98.1 | 41.5 | 24.2 | 41.5 | 18.2 | 17.5 | 18.1 | 24.5 |
| | (90% in | | | | | | | | |
| | water) | | | | | | | | |
| 19 | DI Water | 2734.4 | 1158.3 | 674.7 | 1158.2 | 491.2 | 476.0 | 492.7 | 682.0 |
| 20 | DI Water | 6152.4 | 2607.0 | 1519.3 | 2606.0 | 1140.5 | 1099.7 | 1136.7 | 1534.7 |
| 21 | DI Water | 3199.3 | 1355.9 | 789.4 | 1355.0 | 592.9 | 571.9 | 591.1 | 798.8 |
| | Dispersion | 40.6 | 37.9 | 39.6 | 39.5 | 38.5 | 40.5 | 40.3 | 39.1 |
| | Solids (wt %) | | | | | | | | |

¹ Diglycidyl ether of Bisphenol A with an epoxy equivalent weight of 186-190.
² 72.7% by weight (in MIBK) of the diketimine reaction product of 1 equivalent of diethylene triamine and 2 equivalents of MIBK.
³Multiple batches of resin A were made. Their resin solids varied and are further indicated by specific batch in % by weight on total composition weight: Resin A1 = 37.70%; A2 = 40.56%; A3 = 39.54%; A4 = 39.94%; A5 = 38.21%; and A6 = 39.76%.
⁴Multiple batches of resin D were made. Their resin solids varied and are further indicated by specific batch in % by weight on total composition weight: Resin D1 = 39.83%; D2 = 36.07%; D3 = 37.63%; D4 = 39.47%; D5 = 36.10%.

### Example 3: Preparation of Polyvinyl Alcohol Solution

Component 1 was added to a 1 L glass jar. The liquid was agitated while component 2 was added over 30 minutes with one quarter of the material added every 5-minutes. After stirring for 1-3 hours, mixing was stopped, and the solution was heated to 71° C. for 16 hours. The solution was then cooled to room temperature.

TABLE 3

| | Material | EA 1 | EA 3 | EA 4 | EA 5 | EA 6 |
|---|---|---|---|---|---|---|
| 1 | DI Water | 500 | 500 | 500 | 500 | 500 |
| 2 | Hydroxyl-functional addition | 50 | — | — | — | — |
| | polymer¹ | | | | | |
| | Hydroxyl-functional addition | — | 50 | — | — | — |
| | polymer² | | | | | |
| | Hydroxyl-functional addition | — | — | 50 | — | — |
| | polymer³ | | | | | |
| | Hydroxyl-functional addition | — | — | — | 50 | — |
| | polymer⁴ | | | | | |
| | Hydroxyl-functional addition | — | — | — | — | 50 |
| | polymer⁵ | | | | | |

¹Polyvinyl alcohol polymer having a reported weight average molecular weight of 146,000 to 186,000 g/mol, a reported number average molecular weight of 70,000 to 101,000 g/mol, a reported hydrolysis amount of 88%, and a reported viscosity of 50 ± 5 cP for a 4% by weight aqueous solution at 20° C. measured using a Brookfield synchronized-motor rotary type viscometer, commercially available from Sekisui Specialty Chemicals America, LLC. as SELVOL ™ 540.
²Polyvinyl alcohol polymer having a reported weight average molecular weight of 61,600 g/mol, a reported hydrolysis amount of 88%, and a reported viscosity of 3.8 to 4.4 cP for a 4% by weight aqueous solution at 20° C. measured using a Brookfield synchronized-motor rotary type viscometer, commercially available as Kuraray POVAL ™ 4-88 from Kuraray
³Polyvinyl alcohol polymer having a reported weight average molecular weight of 86,000 g/mol, a reported hydrolysis amount of 74%, and a reported viscosity of 3.6 to 4.2 cP for a 4% by weight aqueous solution at 20° C. measured using a Brookfield synchronized-motor rotary type viscometer, commercially available as Kuraray POVAL ™ 5-74 from Kuraray
⁴Polyvinyl alcohol polymer having a reported weight average molecular weight of 214,500 g/mol, a reported hydrolysis amount of 88%, and a reported viscosity of 20.5 to 24.5 cP for a 4% by weight aqueous solution at 20° C. measured using a Brookfield synchronized-motor rotary type viscometer, commercially available as Kuraray POVAL ™ 22-88 from Kuraray
⁵Polyvinyl alcohol polymer having a reported weight average molecular weight of 310,800 g/mol, a reported hydrolysis amount of 88%, and a reported viscosity of 90.0 to 120.0 cP for a 4% by weight aqueous solution at 20° C. measured using a Brookfield synchronized-motor rotary type viscometer, commercially available as Kuraray POVAL ™ 100-88 from Kuraray

### Example 4: Synthesis of an Acrylic Microgel Edge Additive-EA 6

TABLE 4

| Charge # | Material | Parts |
|---|---|---|
| 1 | Product of Example (cationic salt group- | 756.80 |
| | containing polymeric dispersant) | |
| | Deionized Water | 1528.70 |
| 2 | 2-Hydroxyethyl acrylate | 156.37 |
| 3 | Deionized Water | 46.35 |
| | Hydrogen Peroxide (35% in Deionized Water) | 2.37 |
| 4 | Iso-Ascorbic Acid | 0.435 |
| | Ferrous Ammonium Sulfate | 0.0047 |
| | Deionized Water | 66.4 |
| 5 | Deionized Water | 15.65 |
| | Hydrogen Peroxide (35% in Deionized Water) | 0.068 |
| 6 | Iso-Ascorbic Acid | 0.068 |
| | Deionized Water | 15.9 |

An aqueous dispersion of Edge Addition 6 was formed from the ingredients included in the table above. Edge Addition 6 includes the cationic polymeric dispersant and an ethylenically unsaturated monomer composition having 10% by weight of a hydroxyl-functional acrylate (2-hydroxyethyl acrylate), based on the weight of the ethylenically unsaturated monomer composition. The Edge Addition 6 was prepared as follows: Charge 1 was added to a 4-necked flask fitted with a thermocouple, nitrogen sparge, and a mechanical stirrer. Under a nitrogen blanket and rigorous stirring, the flask was heated to 25° C. At 25° C., the solution was sparged under nitrogen for an additional 30 minutes. Charge 2 was then added to the reaction vessel over 10 minutes. Charge 3 was then added to the reaction vessel over 2-3 minutes. The components of charge 4 were mixed together and added to the reactor through an addition funnel over 30 minutes. The reaction was allowed to exotherm during the addition of charge 4. After the addition was complete, the reactor was heated to 50° C. and held at that temperature for 30 minutes. Charges 5 and 6 were added dropwise and held for 30 minutes at 50° C. The reactor was then cooled to ambient temperature.

The solids content of the resulting aqueous dispersion of Edge Addition 6 was determined using the method described in Example 2. The measured solids content was 12.33%.

The weight average molecular weight (Mw) and z-average molecular weight (M_{z}) were determined by Gel Permeation Chromatography (GPC). For polymers having a z-average molecular weight of less than 900,000, GPC was performed using a Waters 2695 separation module with a Waters 410 differential refractometer (RI detector), polystyrene standards having molecular weights of from approximately 500 g/mol to 900,000 g/mol, dimethylformamide (DMF) with 0.05 M lithium bromide (LiBr) as the eluent at a flow rate of 0.5 mL/min, and one Asahipak GF-510 HQ column for separation. With respect to polymers having a z-average molecular weight (M_{z}) of greater than 900,000 g/mol, GPC was performed using a Waters 2695 separation module with a Waters 410 differential refractometer (RI detector), polystyrene standards having molecular weights of from approximately 500 g/mol to 3,000,000 g/mol, dimethylformamide (DMF) with 0.05 M lithium bromide (LiBr) as the eluent at a flow rate of 0.5 mL/min, and one Asahipak GF-7M HQ column for separation. This procedure was followed for all of the molecular weights measurements included in the Examples. It was determined that the Comparative Edge Addition 2 Polymer had a weight average molecular weight of 404,989 g/mol and the z-average molecular weight of 1,198,186 g/mol.

### Example 5: Preparation of Catalyst Solution

An aqueous bismuth methane sulfonate catalyst solution was prepared using the ingredients from the table below in the following manner: Component 1 was added to an Erlenmeyer flask with stirring, followed by the sequential introduction of Components 2 and 3. The content of the flask was stirred for 3 hours at room temperature, and the resulting catalyst solution was then filtered through a Buchner funnel to remove any undissolved residue.

TABLE 5

| # | Material | Parts |
|---|---|---|
| 1 | Deionized water | 2109.7 |
| 2 | Methanesulfonic acid¹ | 191.9 |
| 3 | Bismuth(III) oxide² | 288.8 |

¹70% solution in deionized water.
²5N Plus Frit grade.

### Example 6: Prep. of Quaternary Ammonium-Containing Grind Vehicle (Grind Vehicle 1)

This example describes the preparation of a quaternary ammonium salt containing pigment-grinding resin. Example 6-1 describes the preparation of an amine-acid salt quaternizing agent and Example 6-2 describes the preparation of an epoxy group-containing polymer that is subsequently quaternized with the amine-acid salt of Example 6-1.

Example 6-1: The amine-acid salt quaternizing agent was prepared using the following procedure:

TABLE 6

| # | Material | Parts |
|---|---|---|
| 1 | Dimethyl ethanolamine | 445.0 |
| 2 | PAPI 290¹ | 661.1 |
| 3 | Bis[2-(2-butoxyethoxy)ethoxy]methane² | 22.1 |
| 4 | 88% Lactic acid aqueous | 511.4 |
| 5 | Deionized water | 1026.4 |

¹Polymeric diisocyanate commercially available from Dow Chemical Co.
²Available as Mazon 1651 from BASF Corporation

To a suitably equipped, four-neck flask, Component 1 was charged. Component 2 was then added over a 1.5 hr period, keeping the reaction temperature ≤100° C., followed by addition of Component 3. The resulting mixture was mixed at 90-95° C. until reaction of the isocyanate was complete, as determined by infrared spectroscopy, ˜1 hr. Components 4 and 5 were pre-mixed and added over 1 hr. A temperature of 85° C. was then established, and the mixture was held at this temperature for 3 hr to yield the amine-acid salt quaternizing agent.

Example 6-2: The quaternary ammonium salt group-containing polymer was prepared using the following procedure:

TABLE 7

| # | Material | Parts |
|---|---|---|
| 1 | EPON 828¹ | 568.2 |
| 2 | Bisphenol A | 241.9 |
| 3 | Bisphenol A - ethylene oxide adduct (1/6 | 90.0 |
| | molar ratio BPA/EO) | |
| 4 | Bis[2-(2-butoxyethoxy )ethoxy]methane ² | 9.9 |
| 5 | Ethyltriphenylphosphonium iodide | 0.5 |
| 6 | Bis[2-(2-butoxyethoxy)ethoxy]methane ² | 142.9 |
| 7 | Bisphenol A diglycidyl ether¹ | 10.5 |
| 8 | Bis[2-(2-butoxyethoxy)ethoxy]methane ² | 9.0 |
| 9 | Amine-acid quaternizing agent, Example 6-1 | 314.9 |
| 10 | Deionized water | 1731.9 |

¹Diglycidyl ether of Bisphenol A with an epoxy equivalent weight of 186-190.
² Available as Mazon 1651 from BASF Corporation

Components 1-5 were charged to a four-neck flask equipped with stirrer and reflux condenser. The reaction mixture was heated to about 140° C., then allowed to exotherm to about 180° C. A temperature of 160° C. was subsequently established, and the mixture was held at that temperature for 1 hr to achieve an epoxy equivalent weight of 900-1100 g/equiv. Component 6 was charged, and a temperature of 120° C. was established. Components 7-8 were then added, and the mixture was held at 120° C. for 1 hr. The temperature was subsequently lowered to 90° C. Components 9-10 were pre-mixed and then added over 1.5 hr. The reaction temperature was held at about 80° C. for approximately 6 hours until the acid number of the reaction product fell below 1.0, as measured using a Metrohm 799 MPT Titrino automatic titrator utilizing a 0.1 M potassium hydroxide solution in methanol.

### Example 7: Prep. of Ternary Sulfonium-Containing Grind Vehicle (Grind Vehicles 2 and 3)

TABLE 8

| | | Parts | |
|---|---|---|---|
| | | Grind | Grind |
| # | Material | Vehicle 2 | Vehicle 3 |
| 1 | EPON 828¹ | 670.2 | 150.8 |
| 2 | Nonylphenol | 24.0 | 5.4 |
| 3 | Bisphenol A | 249.7 | 56.4 |
| 4 | Ethyltriphenyl phosphonium iodide | 0.9 | 0.2 |
| 5 | Bis[2-(2-butoxyethoxy)ethoxy]-methane | — | 55.0 |
| 6 | Propylene glycol n-butyl ether | 243.7 | — |
| 7 | Propylene glycol methyl ether | 63.3 | — |
| 8 | Thiodiethanol | 152.8 | 34.6 |
| 9 | Propylene glycol n-butyl ether | 8.8 | 14.3 |
| 10 | Deionized water | 38.5 | 28.6 |
| 11 | Dimethylolpropionic acid | 167.6 | 37.9 |
| 12 | Resin Synthesis Product | 1376.5 | 383.2 |
| 13 | Deionized water | 1339.7 | 480.8 |
| 14 | Icomeen T2² | — | 5.8 |
| 15 | Deionized water | 750.2 | 25.5 |

¹Diglycidyl ether of Bisphenol A with an epoxy equivalent weight of 186-190.
²A surfactant available from BASF.

The grind vehicles were prepared with the materials listed in the table above according to the following procedure: Components 1-6 were charged to a four-neck flask equipped with stirrer and reflux condenser. The mixture was heated to 125° C. and allowed to exotherm to about 175° C. A temperature of 160-165° C. was established, and the mixture was held for 1 hr. Component 7 was added, and a temperature of 80° C. was established. Components 8-11 were charged, and the mixture was held at 78-80° C. until the measured acid value was less than 2, as measured using a Metrohm 799 MPT Titrino automatic titrator and 0.1 M potassium hydroxide in methanol titrant solution. The resulting Resin Synthesis Product, Component 12, was added to Component 13 with stirring. This dispersion was mixed for 30 min, followed by addition of Components 14-15 to afford the product.

### Example 8: Preparation of the Pigment Pastes

The catalyst free pigment dispersion was prepared by sequentially adding charges 1-8 listed below under high shear agitation. When the ingredients were thoroughly blended, the pigment dispersion was transferred to a vertical sand mill and ground to a Hegman value of >7.5.

TABLE 9

| # | Material | Paste 1¹ | Paste 2 | Paste 3 | Paste 4 |
|---|---|---|---|---|---|
| 1 | Grind Vehicle 1 | 1875.00 | 750.00 | 637.5 | — |
| | Grind Vehicle 2 | — | — | — | 1665.26 |
| | Grind Vehicle 3 | — | — | — | 178.16 |
| 2 | N-butoxypropanol | 75.32 | 30.13 | 25.61 | 3.94 |
| 3 | Printex 200² | 28.13 | 11.25 | 9.56 | 24.63 |
| 4 | ASP 200³ | — | 888.75 | 249.263 | 947.44 |
| 5 | Titanium Dioxide⁴ | 2221.88 | — | 425.21 | 328.48 |
| 6 | Barium Sulfate⁵ | — | — | 80.96 | 164.34 |
| 7 | Fascat 4201⁶ | — | — | — | 105.31 |
| 8 | Deionized water | 799.68 | 319.87 | 271.89 | 584.40 |

¹Paste 1 was made up three separate times having a slightly different solids content and used to produce a composition having the indicated pigment-to-binder ratio below.
²Carbon Black pigment suppled from Orion Engineered Carbon
³Kaolin Clay available from BASF corporation
⁴Pigment grade from The Chemours Company
⁵Pigment grade from Micro Blanc Fixe
⁶DBTO available from Arkema, Inc.

### Example 9: Preparation of Electrodepositable Coating Compositions

For each paint composition described in the tables below, charges 1-5 were added sequentially into a plastic container at room temperature under agitation with 10 minutes of stirring after each addition. The mixture was stirred for at least 30 minutes at room temperature. Charge 6 was then added, and the paint was allowed to stir until uniform, a minimum of 30 minutes. Charge 7 was added, and the paint was allowed to stir for a minimum of 30 minutes until uniform. The resulting cationic electrodepositable paint compositions had a solids contend of 25%, determined as by described previously, and a pigment to binder ratio of 0.13/1.0 by weight.

In addition, comparative compositions to Compositions C and G were also repeated with the same formulation of Compositions C and G except that charge 2 was omitted. These compositions are indicated as C2 and G2.

After 20% ultrafiltration (and reconstitution with deionized water), coated panels were prepared from a bath containing the cationic electrodepositable coating composition.

TABLE 10

| Charge | Material | A | B | C | D | E |
|---|---|---|---|---|---|---|
| 1 | Resin A1 | — | 1218.97 | — | | 1218.97 |
| | Resin A3 | — | — | 1133.02 | 1138.89 | — |
| | Resin B | 1211.90 | — | — | — | — |
| 2 | Bis[2-(2- | 14.29 | 42.87 | 57.16 | 14.29 | 28.58 |
| | butoxyethoxy)ethoxy] | | | | | |
| | methane¹ | | | | | |
| 3 | EA 1 | — | — | 23.81 | — | — |
| | EA 2 | — | — | — | — | 23.81 |
| | EA 6 | 19.31 | 19.31 | — | — | 23.81 |
| 4 | Catalyst Solution of | 47.62 | 47.62 | 47.62 | 47.62 | 47.62 |
| | Ex. 5 | | | | | |
| 5 | DI Water | 29.71 | 22.64 | 104.10 | 122.04 | 18.14 |
| 6 | Paste 1 | 135.00 | 135.00 | 135.00 | 135.00 | 135.00 |
| 7 | Water | 792.10 | 792.10 | 792.10 | 792.10 | 792.10 |

¹Available from BASF of Florham Park, NJ as Mazon 1651.

TABLE 11

| Charge | Material | F | G | H | I | J |
|---|---|---|---|---|---|---|
| 1 | Resin A1 | 1187.40 | — | — | — | — |
| | Resin A3 | — | — | — | — | 748.60 |
| | Resin C | — | — | — | 1159.61 | - |
| | Resin D1 | — | 1153.79 | — | — | — |
| | Resin D4 | — | — | 1025.56 | — | — |
| 2 | Bis[2-(2- | 14.29 | 14.29 | 57.15 | 14.29 | 9.44 |
| | butoxyethoxy)ethoxy] | | | | | |
| | methane¹ | | | | | |
| 3 | EA 1 | — | 23.81 | — | — | — |
| | EA 2 | 115.87 | — | — | — | — |
| | EA 6 | — | — | 115.87 | 19.42 | 12.76 |
| 4 | Catalyst Sol. of Ex. 5 | 47.62 | 47.62 | 47.62 | 47.62 | — |
| 5 | DI Water | 135.48 | 83.33 | | 81.90 | 103.21 |
| 6 | Paste 1 | 135.00 | 135.00 | 92.34 | 82.16 | — |
| | Paste 4 | — | — | 230.5 | — | 105.00 |
| 7 | Water | 714.30 | 792.10 | — | 189.9 | 521.00 |

¹Available from BASF of Florham Park, NJ as Mazon 1651.

TABLE 12

| Charge | Material | K | L | M | N |
|---|---|---|---|---|---|
| 1 | Resin H | 1175.33 | — | — | — |
| | Resin E | | 1192.41 | — | — |
| | Resin G | — | — | 811.63 | — |
| | Resin F | — | — | — | 1133.58 |
| 2 | Bis[2-(2- | 14.29 | 14.29 | 12.70 | 14.29 |
| | butoxyethoxy)ethoxy] | | | | |
| | methane¹ | | | | |
| 3 | EA 6 | 19.31 | 19.31 | 17.26 | 19.31 |
| 4 | Catalyst Sol. of Ex. 5 | 47.62 | 47.62 | 42.33 | 47.62 |
| 5 | DI Water | 66.29 | 49.21 | 291.93 | 108.04 |
| 6 | Paste 1 | 135.00 | 134.50 | 119.50 | 134.50 |
| 7 | Water | 792.10 | 720.70 | 704.60 | 792.70 |

¹Available from BASF of Florham Park, NJ as Mazon 1651.

TABLE 13

| Charge | Material | O | Q | Q | R |
|---|---|---|---|---|---|
| 1 | Resin A2 | — | 1133.02 | 1133.02 | 1133.02 |
| | Resin A3 | 1162.25 | — | — | — |
| 2 | Bis[2-(2- | 14.29 | 14.29 | 14.29 | 14.29 |
| | butoxyethoxy)ethoxy] | | | | |
| | methane¹ | | | | |
| 3 | EA 2 | 23.81 | — | — | — |
| | EA 3 | — | 23.81 | — | — |
| | EA 4 | — | — | 23.81 | — |
| | EA 5 | — | — | — | 23.81 |
| 4 | Catalyst Sol. of Ex. 5 | 47.62 | 47.62 | 47.62 | 47.62 |
| 5 | DI Water | 74.87 | 104.1 | 104.1 | 104.1 |
| 6 | Paste 1 | 134.5 | 134.5 | 134.5 | 134.5 |
| 7 | Water | 792.7 | 792.1 | 792.7 | 792.7 |

¹Available from BASF of Florham Park, NJ as Mazon 1651.

TABLE 14

| Charge | Material | S | T | U | V |
|---|---|---|---|---|---|
| 1 | Resin A2 | 1162.25 | — | — | — |
| | Resin D2 | — | — | 1274.06 | — |
| | Resin D3 | — | 1221.24 | — | — |
| | Resin D4 | — | — | — | 1164.31 |
| 2 | Bis[2-(2- | 14.29 | 14.29 | 14.29 | 14.29 |
| | butoxyethoxy)ethoxy] | | | | |
| | methane¹ | | | | |
| 3 | EA 1 | — | 23.81 | — | — |
| | EA 6 | 19.31 | — | 19.31 | 19.31 |
| 4 | Catalyst Sol. of Ex. 5 | 47.62 | 47.62 | 47.62 | 47.62 |
| 5 | Yttrium solution² | 1.90 | 1.90 | — | — |
| | DI Water | 79.37 | 15.87 | 5.35 | 77.31 |
| 6 | Paste 1 | 134.5 | 134.5 | 135.00 | — |
| | Paste 2 | — | — | — | 149.6 |
| | Paste 3 | — | — | — | — |
| 7 | Water | 790.80 | 790.80 | 754.30 | 777.60 |

¹Available from BASF of Florham Park, NJ as Mazon 1651.
²Yttrium dissolved in methane sulfonic acid providing 400 ppm yttrium on resin solids.

TABLE 15

| Charge | Material | W | X | Y | Z |
|---|---|---|---|---|---|
| 1 | Resin A5 | 1202.71 | 1202.71 | 1202.71 | 1202.71 |
| | Resin A6 | — | — | — | — |
| 2 | Bis [2-(2- | 42.87 | 28.58 | 28.58 | 14.29 |
| | butoxyethoxy)ethoxy] | | | | |
| | methane¹ | | | | |
| 3 | EA 6 | 19.31 | 19.31 | 19.31 | 19.31 |
| 4 | Catalyst Sol. of Ex. 5 | 47.62 | 47.62 | 47.62 | 47.62 |
| 5 | DI Water | 38.91 | 38.91 | 38.91 | 38.91 |
| 6 | Paste 1 | 136.4 | — | 68.20 | 95.49 |
| | Paste 2 | — | 149.60 | 74.80 | 44.87 |
| | Paste 3 | — | — | — | — |
| 7 | Water | 790.80 | 777.60 | 784.20 | 786.80 |

¹Available from BASF of Florham Park, NJ as Mazon 1651.

### Evaluation of Electrodepositable Coating Compositions

The paints were evaluated in accordance with the SURFACE ROUGHNESS TEST METHOD, the EDGE COVERAGE TEST METHOD, the GEL POINT METHOD the COALESCENCE TEMPERATURE TEST METHOD, and the SMOOTHING TEST METHOD.

Surface Roughness (Appearance): Surface roughness may be evaluated in accordance with the SURFACE ROUGHNESS TEST METHOD by the following method: The electrodepositable coating composition is electrodeposited onto a metal panel and cured, and then coating texture is evaluated using a profilometer over a specified length of the panel, filtering the roughness profile according to ISO 4287-1997 3.1.6 using an Lc parameter of 2.5 mm and an Ls parameter of 8 μm before summarizing an Ra metric according to ISO 4287-1997 4.2.1, hereinafter referred to as Ra. A specific test procedure may be performed as follows: The electrodepositable coating composition may be electrodeposited coated on to cold-rolled steel (CRS) panels that are 4×6×0.032 inches and pretreated with CHEMFOS C700/DI (CHEMFOS C700 is a zinc phosphate immersion pretreatment composition available from PPG Industries, Inc.). These panels are available from ACT Laboratories of Hillside, Mich. The above described electrodepositable paint compositions were electrodeposited onto these specially prepared panels in a manner well known in the art by immersing them into a stirring bath at a temperature between 32.2° C. to 37.2° C. and connecting the cathode of the direct current rectifier to the panel and connecting the anode of the direct current rectifier to the stainless-steel tubing used to circulate cooling water for bath temperature control. The voltage was increased from 0 to a set point voltage of 190V over a period of 30 seconds and then held at that voltage until the desired film thickness was achieved. This combination of time, temperature and voltage deposited a coating that when cured had a dry film thickness of 16-20 microns. Three panels were electrocoated for each paint composition. After electrodeposition, the panels were removed from the bath, rinsed vigorously with a spray of deionized water, and cured by baking for 20 minutes at 150° C. in an electric oven (Despatch Industries, model LFD-series).

Coated panel texture may be evaluated using a Mitutoyo Surftest SJ-402 skidded stylus profilometer equipped with a 0.75 mN detector and a diamond stylus tip with a 60° C. one and a 2 μm tip radius. The scan force is less than 400 mN. The scan length, measuring speed, and data-sampling interval were 15 mm, 0.5 mm/s, and 1.5 μm, respectively. The raw data was first filtered to a roughness profile according to ISO 4287-1997 3.1.6 using an Lc parameter of 2.5 mm and an Ls parameter of 8 μm before summarizing an Ra metric according to ISO 4287-1997 4.2.1, hereinafter referred to as Ra (2.5 mm).

Edge Coverage Evaluation: Edge coverage may be evaluated in accordance with the EDGE COVERAGE TEST METHOD by the following method: Test panels were specially prepared from cold rolled steel panels, 4×12×0.032 inches, pretreated with CHEMFOS C700/DI and available from ACT Laboratories of Hillside, Michigan. The 4×12×0.3 2-inch panels were first cut into two 4×5¾-inch panels using a Di-Acro Hand Shear No. 24 (DiAcro, Oak Park Heights, Minnesota). The panels are positioned in the cutter so that the burr edge from the cut along the 4-inch edge ends up on the opposite side from the top surface of the panel. Each 4×5¾ panel is then positioned in the cutter to remove ¼ of an inch from one of the 5¾-inch sides of the panel in such a manner that the burr resulting from the cut faces upward from the top surface of the panel.

The above described electrodepositable paint compositions were then electrodeposited onto these specially prepared panels in a manner well known in the art by immersing them into a stirring bath at 32.2° C. to 37.2° C. and connecting the cathode of the direct current rectifier to the panel and connecting the anode of the direct current rectifier to the stainless-steel tubing used to circulate cooling water for bath temperature control. The voltage was increased from 0 to a set point voltage of 190V over a period of 30 seconds and then held at that voltage until the desired film thickness was achieved. This combination of time, temperature and voltage deposited a coating that when cured had a dry film thickness of 16-20 microns. Two panels were electrocoated for each paint composition. After electrodeposition, the panels were removed from the bath, rinsed vigorously with a spray of deionized water and cured by baking for 20 minutes at 150° C. in an electric oven.

A Di-Acro panel cutter (model number 12 SHEAR) was used to cut out square pieces, approximately 0.5 in ×0.5 in, from the burr edge of the panel. The burr edges are placed within epoxy cups, ten burrs per epoxy mount. This is done using Ted Pella plastic multi clips. Leco Epoxy (811-563-101) and Leco Hardener (812-518) are mixed together using a 100:14 ratio and poured into the mounting cups where the burr samples were placed. The epoxy is allowed to cure overnight. The epoxy mounts are then grinded and polished using a Buehler AutoMet 250. 240 Grit paper is used first, 2 minutes and 30 seconds. 320 grit paper is used next, 2 minutes. 600 grit paper follows, 1 minute. Samples are then polished for 3 minutes and 30 seconds using a 9 micron paste then for 3 minutes using a 3-micron paste. Once polished, the samples are coated for 20 seconds with Au/Pd using an EMS Quorum EMS150TES Sputter coater and placed on aluminum mounts with carbon tape. The coating thickness on the burr was evaluated and compared to the flat area coating thickness.

Gel Point Evaluation: The gel point may be evaluated in accordance with the GEL POINT TEST METHOD by the following method: The electrodepositable coating composition is coated onto 4″×12″ 0.025″ Aluminum Q panel available Q-Labs of Westlake, OH, until reaching a target film of 0.7-0.9 mils (17-23 microns). The applied, uncured coating is then dissolved in THF and deposited on to a type P-PTD200/56 platen and placed into an Anton Paar rheometer (a 302 model) using an Anton Paar PPR 25/23 spindle and settings of constant 5% shear strain and constant 1 Hz frequency. The temperature is held at 40° C. for 30 min then ramped from 40° C. to 175° C. at a rate of 3.3° C./min. The complex viscosity (cps, n*), shear strain (%, y), loss factor (G″/G′), loss modulus (Pa, G″), storage modulus (Pa, G′), and shear stress (Pa, t) are measured over the temperature ramp, and the gel point is determined to be the point at which loss modulus (G″) crosses the storage modulus (G′).

Coalescence Temperature Evaluation: Coalescence temperature may be evaluated in accordance with the COALESCENCE TEMPERATURE TEST METHOD by the following method: The electrodepositable coating composition is coated onto test panels, such as a cold-rolled steel (CRS) panels that are 4×6×0.031 inches and pretreated with CHEMFOS C₇₀₀/DI (CHEMFOS C₇₀₀ is a zinc phosphate immersion pretreatment composition available from PPG Industries, Inc.). The panels are available from ACT Laboratories of Hillside, Mich. Panels are electrocoated at electrodeposition bath temperatures of 70-102° F. at 3° F. intervals (to the maximum temperature of 102° F.) using a voltage of 190 V and a 3-minute deposition time. The panels are then baked at 150° C. for 20 minutes. The film build is measured using a Fischer Dualscope FMP40 permascope instrument. If a film build minimum is identified in the tested temperature range, the temperature where the lowest film build is measured is designated as the coalescence temperature of the electrodepositable coating composition.

% Smoothing: The % smoothing was evaluated in accordance with the SMOOTHING TEST METHOD by the following method: Cold-rolled steel (CRS) panels available from ACT Laboratories of Hillside, Mich. that are 4×6×0.031 inches and pretreated with CHEMFOS C700/DI (CHEMFOS C700 is a zinc phosphate immersion pretreatment composition available from PPG Industries, Inc.) are used for these evaluations. These substrates typically have an Ra (2.5 mm) of 0.6. The surface roughness of an uncoated panel is evaluated using a Mitutoyo Surftest SJ-402 skidless stylus profilometer equipped with a 4 mN detector and a diamond stylus tip with a 90° C. one and a 5 μm tip radius. The scan length, measuring speed, and data-sampling interval are 48 mm, 1 mm/s, and 5 μm, respectively. The sampling data is then transferred to a personal computer by use of a USB port located on the profilometer, and the raw data is first filtered to a roughness profile according to ISO 4287-1997 3.1.6 using an Lc parameter of 2.5 mm and an Ls parameter of 8 μm before summarizing an Ra metric according to ISO 4287-1997 4.2.1, hereinafter referred to as Ra (2.5 mm).

The results of the testing are provided in the tables below.

TABLE 16

| | Mono-func. | | | Ra | | | | |
|---|---|---|---|---|---|---|---|---|
| Paint | reactant | CAT | EA | (2.5 mm) | Smooth | Burr | CT | GP |
| A | DDP | Bi-MSA | EA 6 | 0.344 | 43% | 21% | 78 | 136 |
| B | Phenol | Bi-MSA | EA 6 | 0.228 | 62% | 41% | 72 | 136 |
| C | Phenol | Bi-MSA | EA 1 | 0.450 | 25% | 24% | 75 | 138 |
| Comp. | None | Bi-MSA | EA 1 | 0.873 | −46% | 28% | 72 | 127 |
| G | | | | | | | | |
| I | HSA* | Bi-MSA | EA 6 | 0.267 | 56% | 22% | 72 | 137 |

*HSA—12-Hydroxystearic acid

The results show above demonstrate that the use of a mono-functional reactant in making the electrodepositable binder resin results in in good cure performance and appearance compared to a similar electrodepositable coating composition that did not include a mono-functional reactant in making its resin. For example, Composition C including phenol as a mono-functional reactant and EA 1 as the edge additive had significantly reduced surface roughness and resulted in a smoother surface than Comparative Composition G having the same edge additive but no mono-functional reactant. Likewise, Compositions A, B, and I also include a mono-functional reactant and provided good appearance, smoothing, and edge coverage.

TABLE 17

| | Mono- | | | | | | | |
|---|---|---|---|---|---|---|---|---|
| | func. | | | Ra | | | | |
| Paint | reactant | CAT | EA | (2.5 mm) | Smooth | Burr | CT | GP |
| A | DDP | Bi-MSA | EA 6 | 0.344 | 43% | 21% | 78 | 136 |
| B | Phenol | Bi-MSA | EA 6 | 0.228 | 62% | 41% | 72 | 136 |
| C | Phenol | Bi-MSA | EA 1 | 0.450 | 25% | 24% | 75 | 138 |
| Comp. | Phenol | Bi-MSA | None | 0.159 | 74% | 2% | 72 | 137 |
| D | | | | | | | | |
| E | Phenol | Bi-MSA | EA 2 | 0.321 | 47% | 2% | 72 | 135 |
| Comp. | None | Bi-MSA | EA 1 | 0.873 | −46% | 28% | 72 | 127 |
| G | | | | | | | | |
| Comp. | None | Bi-MSA | EA 6 | 3.638 | −506% | 152% | 72 | 131 |
| H | | | | | | | | |

The results in the table above demonstrate that various edge additives may be used to increase the edge coverage of the electrodepositable coating composition while providing good appearance and low temperature cure. For example, Compositions A, B, and C all provide good appearance, edge coverage, smoothing, coalescence, and gel point. In contrast, Comparative Composition D did not include an edge additive and provided poor edge coverage.

The results in the table above also demonstrate that the use of a mono-functional reactant can help to improve appearance while maintaining edge coverage. For example, Composition B can be compared to Comparative Composition H that does not include the mono-functional reactant in making its resin and resulted in a very rough surface with significant composition collecting at the edge.

TABLE 18

| | Mono- | | | | | | |
|---|---|---|---|---|---|---|---|
| | func. | | | Ra | | | |
| Paint | reactant | CAT | EA | (2.5 mm) | Smooth | CT | GP |
| C | Phenol | Bi-MSA | EA 1 | 0.450 | 25% | 75 | 138 |
| G | None | Bi-MSA | EA 1 | 0.873 | −46% | 72 | 127 |
| C2 | Phenol | Bi-MSA | EA 1 | 0.513 | 14% | 85 | 137 |
| G2 | None | Bi-MSA | EA 1 | 2.079 | −246% | 91 | 129 |

These result demonstrate that the coalescence temperature may be reduced by including 0.8% by weight bis[2-(2-butoxyethoxy)ethoxy]methane, based on resin solids, and that the use of the mono-functional reactant can also impact coalescence temperature (compare Composition C2 to Composition G2 showing a reduced CT for the mono-functional reactant-containing resin of Composition C2).

TABLE 19

| | Mono- | | | Ra | | | | |
|---|---|---|---|---|---|---|---|---|
| | func. | | | (2.5 | | | | |
| Paint | reactant | CAT | EA | mm) | Smooth | Burr | CT | GP |
| A | DDP | Bi-MSA | EA 6 | 0.344 | 43% | 21% | 78 | 136 |
| J | Phenol | DBTO | EA 6 | 0.435 | 28% | 20% | 72 | 137 |

The Results in the table above demonstrate that other catalysts may be used to achieve the appearance, smoothness, edge coverage, coalescence temperature and gel point.

TABLE 20

| | Mono- | | | | | | |
|---|---|---|---|---|---|---|---|
| | func. | | Ra | | | | |
| Paint | reactant | EA | (2.5 mm) | Smooth | Burr | CT | GP |
| Comp. | Phenol | EA 6 | 0.110 | 87% | 21% | 72 | 166 |
| K | | | | | | | |
| L | Phenol | EA 6 | 0.381 | 37% | 41% | 72 | 118 |
| M | Phenol | EA 6 | 0.410 | 32% | 24% | 72 | 148 |
| N | Phenol | EA 6 | 0.240 | 60% | 21% | 75 | 134 |

Catalyst Bi-MSA - all

These results in the table above indicate that the blocking agent used to form the blocking group of the crosslinker can impact the gel point temperature of the compositions. For example, Comparative Composition K that had a polyisocyanate blocked with Butyl CELLOSOLVE had a significantly higher gel point than the Compositions L, M, and N that used different blocking agents.

TABLE 21

| | Mono- | | | | | | |
|---|---|---|---|---|---|---|---|
| | func. | | | Ra | | | |
| Paint | reactant | Pigment | EA | (2.5 mm) | Smooth | Burr | GP |
| U | none | 100% TiO₂ | EA 6 | 0.415 | 31% | 6% | 132 |
| Comp. | none | 100% clay | EA 6 | 0.623 | −4% | 14% | 155 |
| V | | | | | | | |
| W | Phenol | 100% TiO₂ | EA 6 | 0.256 | 57% | 20% | 139 |
| X | Phenol | 100% clay | EA 6 | 0.446 | 26% | 33% | 135 |
| Y | Phenol | 50:50 (TiO₂:clay) | EA 6 | 0.439 | 27% | 16% | 137 |
| Z | Phenol | 70:30 (TiO₂:clay) | EA 6 | 0.434 | 28% | 46% | 137 |

The results in the table above demonstrate that when no mono-functional reactant is used to make the resin the cure temperature may be dependent on the type of pigment used. For example, Composition U including 100% TiO₂ pigment had a low-temperature gel point compared to Comparative Composition V that included 100% clay pigment and had a higher gel point. The clay also impacted the edge coverage as Comp. Composition V and Composition Y each had poorer edge coverage with clay present in an amount of 100% by weight and 50% by weight, respectively, based on the total pigment weight. Composition Z that included only 30% by weight clay had good gel point and edge coverage. The results also indicate that the pigment may be more freely changed when a mono-functional reactant is used to make the resin. For example, Compositions W, Y, X, and Z all use resins that include a mono-functional reactant (phenol) and maintained low-temperature gel point regardless of the pigment used.

TABLE 22

| | Mono- | | | Ra | | | | |
|---|---|---|---|---|---|---|---|---|
| | func. | | | (2.5 | | | | |
| Paint | reactant | Additive | EA | mm) | Smooth | Burr | CT | GP |
| S | Phenol | Yttrium | EA 6 | 0.294 | 51% | 52% | 72 | 148 |
| T | none | Yttrium | EA 6 | 0.434 | 28% | 19% | 72 | 151 |

The results in the table above indicate that a corrosion inhibitor such as yttrium may be incorporated into the electrodepositable coating composition without disrupting the properties of the composition.

TABLE 23

| | Mono- | | | | | |
|---|---|---|---|---|---|---|
| | func. | | | Ra | | |
| Paint | reactant | Pigment | EA | (2.5 mm) | Smooth | Burr |
| O | Phenol | 100% TiO₂ | EA 2 | 0.150 | 75% | 0% |
| P | Phenol | 100% TiO₂ | EA 3 | 0.156 | 74% | 0% |
| Q | Phenol | 100% TiO₂ | EA 4 | 0.206 | 66% | 24% |
| R | Phenol | 100% TiO₂ | EA 5 | 0.279 | 54% | 40% |

The results show by example a number of different types of hydroxyl-functional additives may be incorporated into the electrodepositable coating composition. In particular, the higher molecular weight hydroxyl-functional addition polymers provided better edge coverage than lower-molecular weight edge additives. For example, EA 2 and EA 3 have lower molecular weights, whereas EA 4 and EA 5 have higher molecular weights. However, each provide good appearance and smoothing.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. An electrodepositable coating composition comprising:
(a) an active hydrogen-containing, ionic salt group-containing film-forming polymer;
(b) a blocked polyisocyanate curing agent;
(c) a curing catalyst; and
(d) an edge control additive;
wherein the electrodepositable coating composition has a gel point of less than 150° C., as measured by the GEL POINT TEST METHOD, an edge coverage of greater than 20%, as measured by the EDGE COVERAGE TEST METHOD, and an Ra of no more than 0.45, as measured by the SURFACE ROUGHNESS TEST METHOD.

2. The electrodepositable coating composition of claim 1, wherein the ionic salt group-containing film-forming polymer comprises a reaction product of a reaction mixture comprising:
(1) a polyepoxide;
(2) di-functional chain extender; and
(3) a mono-functional reactant,
wherein the ratio of functional groups from the di-functional chain extender and the mono-functional reactant to the epoxide functional groups from the polyepoxide may be 0.50:1 to 0.85:1.

3. (canceled)

4. The electrodepositable coating composition of claim 2, wherein the reaction product has an epoxy equivalent weight of 700 to 1,500 g/equivalent.

5. The electrodepositable coating composition of claim 1, wherein the electrodepositable coating composition has a coalescence temperature of less than 90° F., as measured by the COALESCENCE TEMPERATURE TEST METHOD.

6. An electrodepositable coating composition comprising:
(a) an active hydrogen-containing, ionic salt group-containing film-forming polymer comprising a reaction product of a reaction mixture comprising:
(1) a polyepoxide;
(2) di-functional chain extender; and
(3) a mono-functional reactant;
(b) a blocked polyisocyanate curing agent;
(c) a curing catalyst; and
(d) an edge control additive;
wherein the electrodepositable coating composition has a gel point of less than 150° C., as measured by the GEL POINT TEST METHOD, and a coalescence temperature of less than 90° F., as measured by the COALESCENCE TEMPERATURE TEST METHOD.

7-8. (canceled)

9. The electrodepositable coating composition of claim 1, wherein the blocked polyisocyanate curing agent comprises blocking groups comprising a 1,2-polyol as a blocking agent.

10-13. (canceled)

14. The electrodepositable coating composition of claim 9, wherein the 1,2-polyol comprises propylene glycol.

15-18. (canceled)

19. The electrodepositable coating composition of claim 1, wherein the blocked polyisocyanate curing agent comprising a blocking group derived from a blocking agent comprising an alpha-hydroxy amide, ester or thioester.

20. (canceled)

21. The electrodepositable coating composition of claim 1, wherein the blocking agent comprises an alpha-hydroxy amide blocking agent comprising an alkyl glycolamide and/or an alkyl lactamide.

22-28. (canceled)

29. The electrodepositable coating composition of claim 1, wherein the curing catalyst comprises a guanidine.

30. (canceled)

31. The electrodepositable coating composition of claim 1, wherein the curing catalyst comprises a bismuth catalyst and/or a zinc-containing catalyst.

32. The electrodepositable coating composition of claim 1, wherein the curing catalyst comprises a bismuth catalyst.

33. The electrodepositable coating composition of claim 32, wherein the curing catalyst further comprises a guanidine.

34. (canceled)

35. The electrodepositable coating composition of claim 1, wherein the active hydrogen-containing, ionic salt group-containing film-forming polymer comprises an active hydrogen-containing, cationic salt group-containing film-forming polymer.

36. The electrodepositable coating composition of claim 1, wherein the active hydrogen-containing, ionic salt group-containing film-forming polymer comprises an active hydrogen-containing, anionic salt group-containing film-forming polymer.

37-38. (canceled)

39. The electrodepositable coating composition of claim 1, wherein the edge control additive comprises (1) an addition polymer comprising a polymerization product of a polymeric dispersant and a second-stage ethylenically unsaturated monomer composition comprising a second-stage hydroxyl-functional (meth)acrylamide monomer and/or a second-stage hydroxyl-functional (meth)acrylate monomer; (2) a hydroxyl-functional addition polymer comprising constitutional units, at least 70% of which comprise formula VIII:
-[—C(R¹)₂—C(R¹)(OH)—]- (VIII),
wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group, and the % based upon the total constitutional units of the hydroxyl-functional addition polymer; (3) a cellulose derivative; (4) polyvinyl formamide; (5) a cationic epoxy microgel; (6) a polyamine-dialdehyde adduct, or any combination thereof.

40. The electrodepositable coating composition of claim 1, wherein the electrodepositable coating composition has a % smoothing of at least 30%, as measured by the SMOOTHING TEST METHOD.

41. The electrodepositable coating composition of claim 1, further comprising bis[2-(2-butoxyethoxy)ethoxy]methane.

42. A method of coating a substrate comprising electrophoretically applying a coating deposited from an electrodepositable coating composition of claim 1 to at least a portion of the substrate.

43-48. (canceled)

49. A coated substrate comprising a coating formed by electrodepositing the electrodepositable coating composition of claim 1 onto the substrate and at least partially curing the coating.

50-52. (canceled)
